(19) United States
(12) Patent Application Publication
(10) Pub. No.: US 2025/0320150 A1
(43) Pub. Date: Oct. 16, 2025

(54) HIGH FRACTURE TOUGHNESS GLASSES WITH HIGH CENTRAL TENSION

(71) Applicant: CORNING INCORPORATED, CORNING, NY (US)

(72) Inventors: Matthew John Dejneka, Corning, NY (US); Charlene Marie Smith, Corning, NY (US); Jonathan Earl Walter, Woodhull, NY (US)

(21) Appl. No.: 19/249,371

(22) Filed: Jun. 25, 2025

Related U.S. Application Data
(62) Division of application No. 17/102,898, filed on Nov. 24, 2020, now abandoned.
(60) Provisional application No. 62/941,375, filed on Nov. 27, 2019.

(51) Int. Cl. C03C 3/097; C03C 3/085; C03C 3/087; C03C 3/091; C03C 3/095; C03C 4/18; C03C 21/00

(52) U.S. Cl. CPC C03C 3/097; C03C 3/085; C03C 3/087; C03C 3/091; C03C 3/095; C03C 4/18; C03C 21/002

(57) ABSTRACT

A glass-based article of a composition comprising: from 48 mol. % to 75 mol. % SiO₂; from 8 mol. % to 40 mol. % Al₂O₃; from 9 mol. % to 40 mol. % Li₂O; from 0 mol. % to 3.5 mol. % Na₂O; from 9 mol. % to 28 mol. % R₂O, wherein R is an alkali metal and R₂O comprises at least Li₂O and Na₂O; from 0 mol. % to 10 mol. % Ta₂O₅; from 0 mol. % to 4 mol. % ZrO₂; from 0 mol. % to 4 mol. % TiO₂; from 0 mol. % to 3.5 mol. % R′O, R′ being a metal selected from Ca, Mg, Sr, Ba, Zn, and combinations thereof; and from 0 mol. % to 8 mol. % RE₂O₃, RE being a rare earth metal selected from Sc, Y, La, Ce, Pr, Nd, Pm, Sm, Eu, Gd, Tb, Dy, Ho, Er, Tm, Yb, Lu, and combinations thereof. The glass is ion exchangeable. R₂O+R′O—Al₂O₃—Ta₂O₅+1.5*RE₂O₃—ZrO₂—TiO₂ is in a range from −8 mol. % to 5 mol. %. ZrO₂+TiO₂+SnO₂ is in a range from greater than or equal to 0 mol % to less than or equal to 2 mole %. The composition is free of As₂O₃, Sb₂O₃, and PbO.

### BACKGROUND

### Cross-Reference to Related Applications

This application is a divisional application and claims the benefit of priority under 35 U.S.C. § 120 of U.S. application Ser. No. 17/102,898 filed on Nov. 24, 2020, which in turn, claims the benefit of priority under 35 U.S.C. § 119 of U.S. Provisional Application Ser. No. 62/941,375 filed on Nov. 27, 2019, the contents of each of which is relied upon and incorporated herein by reference in their entireties.

### FIELD

The present specification generally relates to glass-based articles exhibiting improved damage resistance and, more particularly, to glass and glass ceramic articles having high fracture toughness and high central tension and that may be strengthened by ion exchange.

### TECHNICAL BACKGROUND

Glass is used in a variety of products having a high likelihood of sustaining damage, such as in portable electronic devices, touch screens, scanners, sensors, LIDAR equipment, and architectural materials. Glass breakage is common in these applications.

Accordingly, a need exists for alternative compositions that are more resistant to breakage.

### SUMMARY

According to a first aspect A1, a glass-based article includes a first surface and a second surface opposing the first surface defining a thickness (t) and is formed from a composition. The composition comprises: from greater than or equal to 48 mole % to less than or equal to 75 mole % SiO₂; from greater than or equal to 8 mole % to less than or equal to 40 mole % Al₂O₃; from greater than or equal to 9 mole % to less than or equal to 40 mole % Li₂O; from greater than 0 mole % to less than or equal to 3.5 mole % Na₂O; from greater than or equal to 9 mole % to less than or equal to 28 mole % R₂O, wherein R is an alkali metal and the R₂O comprises at least Li₂O and Na₂O; from greater than or equal to 0 mole % to less than or equal to 10 mole % Ta₂O₅; from greater than or equal to 0 mole % to less than or equal to 4 mole % ZrO₂; from greater than or equal to 0 mole % to less than or equal to 4 mole % TiO₂; from greater than or equal to 0 mole % to less than or equal to 3 mole % ZnO; from greater than or equal to 0 mole % to less than or equal to 3.5 mole % R′O, where R′ is a metal selected from Ca, Mg, Sr, Ba, Zn, and combinations thereof; and from greater than or equal to 0 mole % to less than or equal to 8 mole % RE₂O₃, where RE is a rare earth metal selected from Sc, Y, La, Ce, Pr, Nd, Pm, Sm, Eu, Gd, Tb, Dy, Ho, Er, Tm, Yb, Lu, and combinations thereof. The glass is ion exchangeable for strengthening. R₂O+R′O—Al₂O₃—Ta₂O₅ +1.5*RE₂O₃—ZrO₂—TiO₂ is in a range from greater than or equal to −8 mole % to less than or equal to 5 mole %. ZrO₂+TiO₂+SnO₂ is in a range from greater than or equal to 0 mol % to less than or equal to 2 mole %. The composition is free of As₂O₃, Sb₂O₃, and PbO.

A second aspect A2 includes the glass-based article according to the first aspect A1, wherein the glass-based article is strengthened by ion exchange and the glass-based article comprises a compressive stress region extending from the first surface to a depth of compression, and a tensile stress region extending from the depth of compression toward the second surface, the tensile stress region having a maximum central tension greater than or equal to 175 MPa.

A third aspect A3 includes the glass-based article according to any of the foregoing aspects, wherein the tensile stress region has a maximum central tension from greater than or equal to 175 MPa to less than or equal to 600 MPa.

A fourth aspect A4 includes the glass-based article according to any of the foregoing aspects, further comprising a fracture toughness of greater than 0.7 MPa√m.

A fifth aspect A5 includes the glass-based article of any of the foregoing aspects, further comprising a critical strain energy release rate of greater than 7 J/m².

A sixth aspect A6 includes the glass-based article of any of the foregoing aspects further comprising a Young's modulus of greater than 70 GPa.

A seventh aspect A7 includes the glass-based article of any of the foregoing aspects, comprising from greater than 0 mole % to less than or equal to 10 mole % of the Ta₂O₅.

An eighth aspect A8 includes the glass-based article of any of the foregoing aspects, comprising from greater than 0 mole % to less than or equal to 8 mole % of the RE₂O₃.

A ninth aspect A9 includes the glass-based article of any of the foregoing aspects, wherein RE₂O₃ is selected from Y₂O₃, La₂O₃, and combinations thereof, and wherein the glass-based article comprises from greater than or equal to 0 mole % to less than or equal to 7 mole % of the Y₂O₃ and from greater than or equal to 0 mole % to less than or equal to 5 mole % of the La₂O₃.

A tenth aspect A10 includes the glass-based article of any of the foregoing aspects, comprising from greater than 0 mole % to less than or equal to 4 mole % of the TiO₂.

An eleventh aspect A11 includes the glass-based article of any of the foregoing aspects, comprising from greater than 0 mole % to less than or equal to 4 mole % of the ZrO₂.

A twelfth aspect A12 includes the glass-based article of any of the foregoing aspects, comprising from greater than 0 mole % to less than or equal to 3.5 mole % of the R′O.

A thirteenth aspect A13 includes the glass-based article of any of the foregoing aspects, comprising from greater than 0 mole % to less than or equal to 3 mole % MgO.

A fourteenth aspect A14 includes the glass-based article of any of the foregoing aspects, comprising from greater than 0 mole % to less than or equal to 3 mole % CaO.

A fifteenth aspect A15 includes the glass-based article of any of the foregoing aspects, comprising from greater than or equal to 50 mole % to less than or equal to 64 mole % of the SiO₂.

A sixteenth aspect A16 includes the glass-based article of any of the foregoing aspects, comprising from greater than or equal to 16 mole % to less than or equal to 24 mole % of the Al₂O₃.

A seventeenth aspect A17 includes the glass-based article of any of the foregoing aspects, comprising from greater than or equal to 12 mole % to less than or equal to 18 mole % of the R₂O.

An eighteenth aspect A18 includes the glass-based article of any of the foregoing aspects, wherein R₂O further comprises K₂O.

A nineteenth aspect A19 includes the glass-based article of any of the foregoing aspects, comprising from greater than 0 mole % to less than or equal to 3 mole % of the K₂O.

A twentieth aspect A20 includes the glass-based article of any of the foregoing aspects, wherein R₂O—Al₂O₃—Ta₂O₅ is in a range from greater than or equal to −12 mole % to less than or equal to 6 mole %.

A twenty-first aspect A21 includes the glass-based article of any of the foregoing aspects, wherein R₂O+R′O—Al₂O₃—Ta₂O₅ is in a range from greater than or equal to −7 mole % to less than or equal to 9 mole %.

A twenty-second aspect A22 includes the glass-based article of any of the foregoing aspects, wherein Li₂O/R₂O is in a range from greater than or equal to 0.5 to less than or equal to 1.

A twenty-third aspect A23 includes the glass-based article of any of the foregoing aspects, wherein Li₂O/(Al₂O₃+Ta₂O₅) is in a range from greater than or equal to 0.4 to less than or equal to 1.5.

A twenty-fourth aspect A24 includes the glass-based article of any of the foregoing aspects, further comprising from greater than or equal to 0 mole % to less than or equal to 7 mole % B₂O₃.

A twenty-fifth aspect A25 includes the glass-based article of any of the foregoing aspects, further comprising from greater than or equal to 0 mole % to less than or equal to 5 mole % P₂O₅.

A twenty-sixth aspect A26 includes the glass-based article of any of the foregoing aspects, further comprising: from greater than or equal to 0 mole % to less than or equal to 3 mole % MgO; from greater than or equal to 0 mole % to less than or equal to 3 mole % CaO; from greater than or equal to 0 mole % to less than or equal to 3 mole % SrO; and from greater than or equal to 0 mole % and less than or equal to 3 mole % BaO.

A twenty-seventh aspect A27 includes the glass-based article of any of the foregoing aspects, wherein the glass-based article is strengthened by ion exchange and the glass-based article comprises a stored strain energy greater than or equal to 20 J/m².

A twenty-eighth aspect A28 includes the glass-based article of any of the foregoing aspects, wherein the glass-based article is strengthened by ion exchange and the glass-based article comprises a compressive stress region extending from the first surface to a depth of compression, and a tensile stress region extending from the depth of compression toward the second surface, the tensile stress region having a maximum central tension greater than or equal to 175 MPa and the glass-based article comprising a critical strain energy release rate greater than or equal to 7 J/m².

A twenty-ninth aspect A29 includes the glass-based article of any of the foregoing aspects, wherein a value of an arithmetic product of the critical strain energy release rate and the maximum central tension is greater than or equal to 2000 MPa·J/m².

A thirtieth aspect A30 includes the glass-based article of any of the foregoing aspects, wherein the glass-based article is strengthened by ion exchange and the glass-based article comprises a compressive stress region extending from the first surface to a depth of compression, and a tensile stress region extending from the depth of compression toward the second surface, the tensile stress region having a maximum central tension greater than or equal to 175 MPa and the glass-based article comprising a fracture toughness of greater than 0.7 MPa√m.

A thirty-first aspect A31 includes the glass-based article of any of the foregoing aspects, wherein a value of an arithmetic product of the fracture toughness and the central tension is greater than or equal to 200 MPa²√m.

A thirty-second aspect A32 includes the glass-based article of any of the foregoing aspects, wherein the glass-based article is strengthened by ion exchange and the glass-based article comprises a compressive stress region extending from the first surface to a depth of compression, and a tensile stress region extending from the depth of compression toward the second surface, the tensile stress region having a maximum central tension greater than or equal to 175 MPa and the glass-based article comprising at least one strengthening ion having a diffusivity into the glass-based article at 430° C. with units micrometers²/hour, a value of an arithmetic product of the central tension and the diffusivity is greater than or equal to 50,000 MPa micrometers²/hour.

A thirty-third aspect A33 includes a glass-based article comprising a composition comprising SiO₂, Li₂O, Ta₂O₅, and Al₂O₃, the Al₂O₃ content being greater than or equal to 12 mole %. The glass-based article is strengthened by ion exchange and the glass-based article comprises a compressive stress region extending from the first surface to a depth of compression, and a tensile stress region extending from the depth of compression toward a second surface opposite the first surface, the tensile stress region having a maximum central tension greater than or equal to 160 MPa.

A thirty-fourth aspect A34 includes the glass-based article of the thirty-third aspect A33, wherein the Al₂O₃ content is greater than or equal to 14 mole % of the composition.

A thirty-fifth aspect A35 includes the glass-based article of the thirty-third aspect A33 or the thirty-fourth aspect A34, wherein the Al₂O₃ content is greater than or equal to 16 mole % of the composition.

Additional features and advantages of the glass articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A is cross-sectional view of an exemplary ion exchanged glass article in accordance with embodiments described herein;

FIG. 1B is a stress profile of a glass article through a cross-section as a function of depth from the surface in accordance with embodiments described herein;

FIG. 2 is a graph comparing drop performance of embodiments disclosed herein to drop performance of other glass-based articles;

FIG. 3 is a graph comparing maximum central tension attained in glass-based articles according to embodiments described herein having yttria (Y₂O₃) versus embodiments not including Y₂O₃;

FIG. 4 graphically depicts experimental fracture toughness and critical strain energy release rate values as a function of Y₂O₃ content;

FIG. 5 is a graph comparing drop performance of embodiments disclosed herein to drop performance of other glass-based articles;

FIG. 6 is a graph showing repeated drop to failure survival as a function of central tension for 0.8 mm thick glass-based articles in accordance with embodiments described herein;

FIG. 7 is a graph showing the effect of replacing Li₂O and Na₂O through ion exchange on K_{1C} and Young's modulus in accordance with embodiments described herein; and

FIG. 8 is a graph showing the stress profile through the thickness of a 1 mm-thick glass-based article in accordance with embodiments described herein.

### DETAILED DESCRIPTION

Reference will now be made in detail to various embodiments of glass-based articles having high fracture toughness and high central tension that may be strengthened by ion exchange. According to one embodiment, a glass-based article includes a first surface and a second surface opposing the first surface defining a thickness (t) and is formed from a composition. The composition comprises: from greater than or equal to 48 mole % to less than or equal to 75 mole % SiO₂; from greater than or equal to 8 mole % to less than or equal to 40 mole % Al₂O₃; from greater than or equal to 9 mole % to less than or equal to 40 mole % Li₂O; from greater than to 0 mole % to less than or equal to 3.5 mole % Na₂O; from greater than or equal to 9 mole % to less than or equal to 28 mole % R₂O, wherein R is an alkali metal and the R₂O comprises at least Li₂O and Na₂O; from greater than or equal to 0 mole % to less than or equal to 10 mole % Ta₂O₅; from greater than or equal to 0 mole % to less than or equal to 4 mole % ZrO₂; from greater than or equal to 0 mole % to less than or equal to 4 mole % TiO₂; from greater than or equal to 0 mole % to less than or equal to 3 mole %; from greater than or equal to 0 mole % to less than or equal to 3.5 mole % R′O, where R′ is an alkaline earth metal selected from Ca, Mg, Zn, and combinations thereof; and from greater than or equal to 0 mole % to less than or equal to 8 mole % RE₂O₃, where RE is a rare earth metal selected from Sc, Y, La, Ce, Pr, Nd, Pm, Sm, Eu, Gd, Tb, Dy, Ho, Er, Tm, Yb, Lu, and combinations thereof. The glass is ion exchangeable for strengthening. The sum of R₂O+R′O—Al₂O₃—Ta₂O₅ +1.5*RE₂O₃—ZrO₂—TiO₂ is in a range from greater than or equal to −8 to less than or equal to 5. ZrO₂ +TiO₂+SnO₂ is in a range from greater than or equal to 0 mol % to less than or equal to 2 mole %. The composition is free of As₂O₃, Sb₂O₃, and PbO. Various embodiments of glass-based articles and the properties thereof will be described herein with specific reference to the appended drawings.

As used herein, the terms “glass-based article” and “glass-based substrates” are used in their broadest sense to include any object made wholly or partly of glass and/or glass ceramic. Glass-based articles include laminates of glass and non-glass materials, laminates of glass and polymers, laminates of glass and crystalline materials, and glass-ceramics (including an amorphous phase and a crystalline phase).

In the embodiments of the compositions described herein, the concentrations of constituent components (e.g., SiO₂, Al₂O₃, and the like) are specified in mole percent (mol. %) on an oxide basis, unless otherwise specified.

The terms “free” and “substantially free,” when used to describe the concentration and/or absence of a particular constituent component in a composition, means that the constituent component is not intentionally added to the composition. However, the composition may contain traces of the constituent component as a contaminant or tramp in amounts of less than 0.05 mol. %.

The glass-based articles described herein may be chemically strengthened by, for example, ion exchange and may exhibit stress profiles that are distinguished from those exhibited by known strengthened glass articles. In this disclosure glass-based substrates are unstrengthened and glass-based articles refer to glass-based substrates that have been strengthened (by, for example, ion exchange). In this process, ions at or near the surface of the glass-based article are replaced by—or exchanged with—larger ions having the same valence or oxidation state at a temperature below the glass transition temperature. Without intending to be bound by any particular theory, it is believed that in those embodiments in which the glass-based article comprises an alkali aluminosilicate glass, ions in the surface layer of the glass and the larger ions are monovalent alkali metal cations, such as Li (when present in the glass-based article), Na⁺, K⁺, Rb⁺, and Cs⁺. Alternatively, monovalent cations in the surface layer may be replaced with monovalent cations other than alkali metal cations, such as Ag or the like. In such embodiments, the monovalent ions (or cations) exchanged into the glass-based substrate generate a stress in the resulting glass-based article.

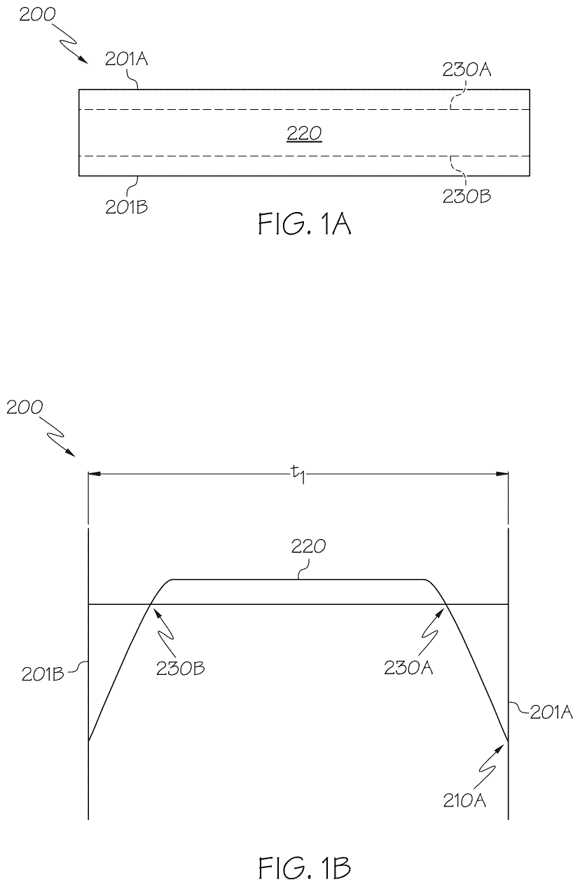

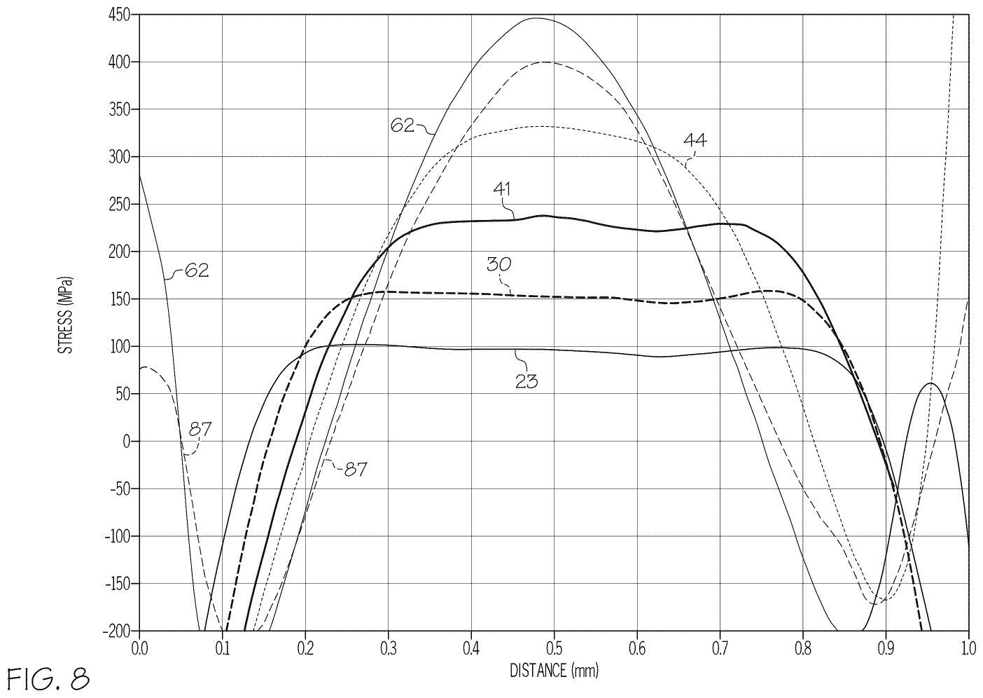

A cross-section view of an exemplary ion exchanged glass article 200 is shown in FIG. 1A and typical stress profile obtained by ion exchange is shown in FIG. 1B. The ion exchanged glass article 200 includes a first surface 201A, a second surface 201B, and a thickness t₁ between the first surface 201A and the second surface 201B. In some embodiments, the ion exchanged glass article 200 may exhibit a compressive stress, as that term is defined below, that decreases from the first surface 201A to a depth of compression 230A, as that term is defined below, until it reaches a region of central tension 220 having a maximum central tension. Accordingly, in some embodiments, the region of central tension 220 extends from the depth of compression 230A towards the second surface 201B of the glass article 200. Likewise, the ion exchanged glass article 200 exhibits a compressive stress 210B that decreases from the second surface 201B to a depth of compression 230B until it reaches a region of central tension 220 having a maximum central tension. Accordingly, the region of central tension 220 extends from the depth of compression 230B towards the first surface 201A such that the region of central tension 220 is disposed between the depth of compression 230B and the depth of compression 230A. The stress profile in the ion exchanged glass article 200 may have various configurations. For example and without limitation, the stress profile may be similar to an error function, such as the stress profile depicted in FIG. 1B. However, it should be understood that other shapes are contemplated and possible, including parabolic stress profiles (e.g., as depicted in FIG. 8) or the like.

Ion exchange processes are typically carried out by immersing a glass-based substrate in a molten salt bath (or two or more molten salt baths) containing the larger ions to be exchanged with the smaller ions in the glass-based substrate. It should be noted that aqueous salt baths may also be utilized. In addition, the composition of the bath(s) may include more than one type of larger ion (e.g., Na+ and K+) or a single larger ion. It will be appreciated by those skilled in the art that parameters for the ion exchange process, including, but not limited to, bath composition and temperature, immersion time, the number of immersions of the glass-based article in a salt bath (or baths), use of multiple salt baths, additional steps such as annealing, washing, and the like, are generally determined by the composition of the glass-based article (including the structure of the article and any crystalline phases present) and the desired depth of compression and compressive stress, as those terms are defined below, of the glass-based article that results from strengthening. By way of example, ion exchange of glass-based substrates may be achieved by immersion of the glass-based substrates in at least one molten bath containing a salt such as, but not limited to, nitrates, sulfates, and chlorides of the larger alkali metal ion. Typical nitrates include KNO₃, NaNO₃, LiNO₃, and combinations thereof. In one or more embodiments, NaSO₄ may be used, as well, with or without a nitrate. The temperature of the molten salt bath typically is in a range from about 370° C. up to about 480° C., while immersion times range from about 15 minutes up to about 100 hours depending on glass thickness, bath temperature and glass (or monovalent ion) diffusivity. However, temperatures and immersion times different from those described above may also be used.

In one or more embodiments, the glass-based substrates may be immersed in a molten salt bath of 100% NaNO₃ having a temperature from about 370° C. to about 480° C. In some embodiments, the glass-based substrate may be immersed in a molten mixed salt bath including from about 5% to about 90% KNO₃ and from about 10% to about 95% NaNO₃. In some embodiments, the glass-based substrate may be immersed in a molten mixed salt bath including Na₂SO₄ and NaNO₃ and have a wider temperature range (e.g., up to about 500° C.). In one or more embodiments, the glass-based article may be immersed in a second bath, after immersion in a first bath. Immersion in a second bath may include immersion in a molten salt bath including 100% KNO₃ for 15 minutes to 8 hours.

In one or more embodiments, the glass-based substrate may be immersed in a molten, mixed salt bath including NaNO₃ and KNO₃ (e.g., 49%/51%, 50%/50%, 51%/49%) having a temperature less than about 420° C. (e.g., about 400° C. or about 380° C.) for less than about 5 hours, or even about 4 hours or less.

Ion exchange conditions can be tailored to provide a “spike” or to increase the slope of the stress profile at or near the surface of the resulting glass-based article. This spike can be achieved by a single ion-exchange bath or multiple baths, with the bath(s) having a single composition or mixed composition, due to the unique properties of the glass compositions used in the glass-based articles described herein.

As used herein, “DOC” or “depth of compression” refers to the depth at which the stress within the glass-based article changes from compressive to tensile stress. At the DOC, the stress changes from a negative (compressive) stress to a positive (tensile) stress.

As used herein, the terms “chemical depth,” “chemical depth of layer,” and “depth of chemical layer” may be used interchangeably and refer to the depth at which an ion of the metal oxide or alkali metal oxide (e.g., the metal ion or alkali metal ion) diffuses into the glass-based article and the depth at which the concentration of the ion reaches a minimum value, as determined by Electron Probe Micro-Analysis (EPMA) or Glow Discharge-Optical Emission Spectroscopy (GD-OES). In particular, the depth of Na₂O diffusion or Na+ ion concentration or the depth of K₂O diffusion or K+ ion concentration may be determined using EPMA or GD-OES.

According to the convention normally used in the art, compression is expressed as a negative (<0) stress and tension is expressed as a positive (>0) stress, unless specifically noted otherwise. Throughout this description, however, when speaking in terms of compressive stress CS, such is given without regard to positive or negative values—i.e., as recited herein, CS=|CS|.

CS is measured with a surface stress meter (FSM) using commercially available instruments such as the FSM-6000, manufactured by Orihara Industrial Co., Ltd. (Japan). Surface stress measurements rely upon the measurement of the stress optical coefficient (SOC), which is related to the birefringence of the glass. SOC may be measured using the disc method according to ASTM standard C770-16 (2016), entitled “Standard Test Method for Measurement of Glass Stress-Optical Coefficient,” the contents of which are incorporated herein by reference in their entirety. The modification includes using a glass disc as the specimen with a thickness of 5 to 10 mm and a diameter of 12.7 mm, wherein the disc is isotropic and homogeneous and core drilled with both faces polished and parallel.

DOC and maximum central tension (or “maximum CT”) values are measured using either a refracted near-field (RNF) method or a scattered light polariscope (SCALP). Either may be used to measure the stress profile. When the RNF method is utilized, the maximum CT value provided by SCALP is utilized. In particular, the stress profile measured by RNF is force balanced and calibrated to the maximum CT value provided by a SCALP measurement. The RNF method is described in U.S. Pat. No. 8,854,623, entitled “Systems and methods for measuring a profile characteristic of a glass sample,” which is incorporated herein by reference in its entirety. In particular, the RNF method includes placing the glass-based article adjacent to a reference block, generating a polarization-switched light beam that is switched between orthogonal polarizations at a rate of between 1 Hz and 50 Hz, measuring an amount of power in the polarization-switched light beam and generating a polarization-switched reference signal, wherein the measured amounts of power in each of the orthogonal polarizations are within 50% of each other. The method further includes transmitting the polarization-switched light beam through the glass sample and reference block for different depths into the glass sample, then relaying the transmitted polarization-switched light beam to a signal photodetector using a relay optical system, with the signal photodetector generating a polarization-switched detector signal. The method also includes dividing the detector signal by the reference signal to form a normalized detector signal and determining the profile characteristic of the glass sample from the normalized detector signal. The RNF profile is then smoothed. As noted above, the FSM technique is used for the surface CS and slope of the stress profile in the CS region near the surface.

The fracture toughness K_{1C} value recited in this disclosure refers to a value as measured by chevron notched short bar (CNSB) method disclosed in Reddy, K. P. R. et al, “Fracture Toughness Measurement of Glass and Ceramic Materials Using Chevron-Notched Specimens,” J. Am. Ceram. Soc., 71 [6], C-310-C-313 (1988) except that Y*ₘ is calculated using equation 5 of Bubsey, R. T. et al., “Closed-Form Expressions for Crack-Mouth Displacement and Stress Intensity Factors for Chevron-Notched Short Bar and Short Rod Specimens Based on Experimental Compliance Measurements,” NASA Technical Memorandum 83796, pp. 1-30 (October 1992).

Density is determined by the buoyancy method according to ASTM C693-93 (2019).

Young's modulus E, Poisson's ratio, and shear modulus values recited in this disclosure refer to values measured by a resonant ultrasonic spectroscopy technique as set forth in ASTM C623-92 (2015), titled “Standard Test Method for Young's Modulus, Shear Modulus, and Poisson's Ratio for Glass and Glass-Ceramics.”

As used herein, the term “specific modulus” means the value of the Young's modulus divided by the density.

As used herein, the term “Poisson's ratio” means the ratio of the proportional decrease in a lateral measurement to the proportional increase in length in a sample of a glass-based article, as described herein, which is elastically stretched.

The stored strain energy Σ₀ may be calculated according to the following equation (I):

$${\sum }_{0} = \frac{1 - v}{{E}_{m o d}} {\int }_{- {z}^{*}}^{+ {z}^{*}} {σ}^{2} d z \qquad ( I )$$

where v is Poisson's ratio, E_{mod} is Young's modulus (in MPa), σ is stress (in MPa), z*=0.5t′, z being the depth and t′ being the thickness (in micrometers) of the tensile region only (i.e., the thickness of the region between the depth of compression 230A and the depth of compression 230B in FIG. 1B).

Critical strain energy release rate G_{1C} was calculated according to the following equation (II):

$${G}_{1 C} = \frac{{K}_{1 C}^{2}}{E} \qquad ( II )$$

where K_{1C} is the fracture toughness and E is the Young's modulus. G_{1C} is conventionally reported in units of J/m².

Coefficients of thermal expansion (CTE) are expressed in terms of 10⁻⁷/° C. and represent the average value measured over a temperature range from about 20° C. to about 300° C., unless otherwise specified.

The terms “strain point” and “Tₛₜᵣₐᵢₙ” as used herein, refer to the temperature at which the viscosity of the glass composition is 3×10^{14.7} poise.

The term “annealing point,” as used herein, refers to the temperature at which the viscosity of the glass composition is 1×10^{13.2} poise.

The term “softening point,” as used herein, refers to the temperature at which the viscosity of the glass composition is 1×10^{7.6} poise.

Strain and annealing points are measured according to the beam bending viscosity method which measures the viscosity of inorganic glass from 10¹² to 10¹⁴ poise as a function of temperature in accordance with ASTM C598-93 (2019), titled “Standard Test Method for Annealing Point and Strain Point of Glass by Beam Bending,” which is incorporated herein by reference in its entirety.

The softening point was measured according to the parallel plate viscosity method which measures the viscosity of inorganic glass from 10⁷ to 10⁹ poise as a function of temperature, similar to the ASTM C1351M-96 (2017), titled “Standard Test Method for Measurement of Viscosity of Glass Between 10⁴ Pa·s and 10⁸ Pa·s by Viscous Compression of a Solid Right Cylinder,” which is incorporated herein by reference in its entirety.

As used herein, the term “liquidus viscosity” refers to the viscosity of a molten glass at the liquidus temperature, wherein the term “liquidus temperature” refers to the temperature at which crystals first appear as a molten glass cools down from the melting temperature (or the temperature at which the very last crystals melt away as temperature is increased from room temperature). In general, the glass-based articles (or the compositions used to form such articles) described herein have a liquidus viscosity of less than about 100 kilopoise (kP). In some embodiments, the glass-based articles (or the compositions used to form such articles) exhibit a liquidus viscosity of less than about 80 kP, less than about 60 kP, less than about 40 kP, less than about 30 kP, less than about 20 kP, or even less than about 10 kP (e.g., in the range from about 0.5 kP to about 10 kP). The liquidus viscosity is determined by the following method. First the liquidus temperature of the glass is measured in accordance with ASTM C829-81 (2015), titled “Standard Practice for Measurement of Liquidus Temperature of Glass by the Gradient Furnace Method”. Next the viscosity of the glass at the liquidus temperature is measured in accordance with ASTM C965-96 (2017), titled “Standard Practice for Measuring Viscosity of Glass Above the Softening Point,” which is incorporated herein by reference in its entirety.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components, plain meaning derived from grammatical organization or punctuation, and the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

Glass articles that survive repeated drops on damaging surfaces are well suited for applications requiring rugged components, such as for touch screens of electronic devices. Some glass substrates or glass articles made with superior resistance to breakage are formed so as to avoid a high number of fragments formed upon breakage. For example, the glass articles may be formed so as to exhibit a fragmentation density of greater than about 5 fragments/cm² of the glass article when subjected to a point impact by an object or a drop onto a solid surface with sufficient force to break the glass article into multiple small pieces. Stored strain energy (SSE) may be an indication of a glass substrate or glass article having a desirable fragmentation pattern For example, glass substrates or glass articles with a stored strain energy greater than about 20 J/m² or even greater than about 24 J/m² may exhibit a fragmentation density of greater than about 5 fragments/cm².

Nonetheless, highly fragmentable glasses may now be used for some applications, such as touch screen mounted on device displays, that have a high likelihood of breakage, because many touchscreens are now directly laminated to the display without an air gap. As such, ejection of particles is less likely due to the lamination. Thus, as more fully described below, highly fragmentable glasses may provide even better drop performance and a more desirable break pattern with fewer ejected particles than non-frangible glasses.

Disclosed herein are glass-based articles comprising glass compositions that mitigate the aforementioned problems. Specifically, the glass compositions enable stress profiles and relatively high central tensions, stored strain energies, fracture toughnesses, and critical strain energy release rates such that the glass-based articles made from the compositions provide enhanced drop performance relative to previously known articles.

In one or more embodiments, SiO₂ is the largest constituent of the glass composition and, as such, is the primary constituent of the resulting glass network. That is, SiO₂ is the primary glass forming oxide. SiO₂ enhances the viscosity (strain, anneal, and softening points, as well as the viscosity at the liquidus temperature) of the glass, which may in turn enhance forming and may also lower the CTE. Accordingly, a high SiO₂ concentration is generally desired. However, if the content of SiO₂ is too high, the formability of the glass may be diminished as higher concentrations of SiO₂ increase the difficulty of melting, softening, and molding the glass which, in turn, adversely impacts the formability of the glass. If the SiO₂ content is too high or too low, the liquidus temperature may be increased, which may also reduce formability.

In embodiments, the compositions may include SiO₂ in an amount greater than or equal to 48 mol. %. The amount of SiO₂ may be less than or equal to 77 mol. %. Accordingly, in embodiments of the compositions, the compositions may comprise SiO₂ in an amount greater than or equal to 48 mol. % and less than or equal to 77 mol. %. In embodiments, the lower bound of the amount of SiO₂ in the composition may be greater than or equal to 48 mol. %, greater than or equal to 49 mol. %, greater than or equal to 50 mol. %, greater than or equal to 51 mol. %, greater than or equal to 52 mol. %, greater than or equal to 53 mol. %, greater than or equal to 54 mol. %, greater than or equal to 55 mol. %, greater than or equal to 56 mol. %, greater than or equal to 57 mol. %, greater than or equal to 58 mol. %, greater than or equal to 59 mol. %, or even greater than or equal to 60 mol. %. In embodiments, the upper bound of the amount of SiO₂ in the composition may be less than or equal to 77 mol. %, less than or equal to 76 mol. %, less than or equal to 75 mol. %, less than or equal to 74 mol. %, less than or equal to 73 mol. %, less than or equal to 72 mol. %, less than or equal to 71 mol. %, less than or equal to 70 mol. %, less than or equal to 69 mol. %, less than or equal to 68 mol. %, less than or equal to 67 mol. %, less than or equal to 66 mol. %, less than or equal to 65 mol. %, less than or equal to 64 mol. %, less than or equal to 63 mol. %, less than or equal to 62 mol. %, or even less than or equal to 61 mol. %. It should be understood that the amount of SiO₂ in the compositions may be within a range formed from any one of the lower bounds for SiO₂ and any one of the upper bounds of SiO₂ described herein.

For example and without limitation, in embodiments, the compositions may include greater than or equal to 48 mol. % and less than or equal to 77 mol. % SiO₂. In embodiments, the composition may include greater than or equal to 49 mol. % and less than or equal to 77 mol. % SiO₂. In embodiments, the composition may include greater than or equal to 50 mol. % and less than or equal to 77 mol. % SiO₂. In embodiments, the composition may include greater than or equal to 51 mol. % and less than or equal to 77 mol. % SiO₂. In embodiments, the composition may include greater than or equal to 52 mol. % and less than or equal to 77 mol. % SiO₂. In embodiments, the composition may include greater than or equal to 53 mol. % and less than or equal to 77 mol. % SiO₂. In embodiments, the compositions may include greater than or equal to 48 mol. % and less than or equal to 75 mol. % SiO₂. In embodiments, the composition may include greater than or equal to 49 mol. % and less than or equal to 75 mol. % SiO₂. In embodiments, the composition may include greater than or equal to 50 mol. % and less than or equal to 75 mol. % SiO₂. In embodiments, the composition may include greater than or equal to 51 mol. % and less than or equal to 75 mol. % SiO₂. In embodiments, the composition may include greater than or equal to 52 mol. % and less than or equal to 75 mol. % SiO₂. In embodiments, the composition may include greater than or equal to 53 mol. % and less than or equal to 75 mol. % SiO₂. In embodiments, the composition may include greater than or equal to 50 mol. % and less than or equal to 64 mol. % SiO₂. In embodiments, the composition may include greater than or equal to 48 mol. % and less than or equal to 64 mol. % SiO₂. In embodiments, the composition may include greater than or equal to 49 mol. % and less than or equal to 63 mol. % SiO₂. In embodiments, the composition may include greater than or equal to 50 mol. % and less than or equal to 62 mol. % SiO₂. In embodiments, the composition may include greater than or equal to 51 mol. % and less than or equal to 61 mol. % SiO₂. In embodiments, the composition may include greater than or equal to 58 mol. % and less than or equal to 65 mol. % SiO₂.

In one or more embodiments, the compositions include Al₂O₃. Al₂O₃ may act as both a conditional network former and a modifier. While not intending to be bound by any particular theory, it is believed that Al₂O₃ binds the alkali oxides in the glass network, increasing the viscosity of the glass. Al₂O₃ may affect alkali diffusivity, Young's modulus, and fracture toughness of the resultant glass. The ion exchange rate and maximum ion exchange stress may be maximized when the Al₂O₃ content is close to the total alkali oxide content. It is also believed that Al₂O₃ may contribute to a stable article with low CTE and improved rigidity. However, excessive additions of Al₂O₃ to the composition may also increase the softening point of the glass and raise the liquidus temperature, which may adversely impact the formability of the composition.

In embodiments, the compositions may include Al₂O₃ in an amount greater than or equal to 5 mol. %. The amount of Al₂O₃ may be less than or equal to 28 mol. %. In embodiments, the compositions may include Al₂O₃ in an amount greater than or equal to 8 mol. %. The amount of Al₂O₃ may be less than or equal to 40 mol. %. If the Al₂O₃ content is too low, ion exchange stress, viscosity, and fracture toughness may all be too low. However, if the Al₂O₃ content is too high, the liquidus temperature may be too high and the glass may crystallize. Accordingly, in embodiments of the compositions, the compositions may comprise Al₂O₃ in an amount greater than or equal to 5 mol. % and less than or equal to 28 mol. %. In embodiments, the compositions may comprise Al₂O₃ in an amount greater than or equal to 8 mol. % and less than or equal to 40 mol. %. In embodiments, the lower bound of the amount of Al₂O₃ in the composition may be greater than or equal to 5 mol. %, greater than or equal to 6 mol. %, greater than or equal to 7 mol. %, greater than or equal to 8 mol. %, greater than or equal to 9 mol. %, greater than or equal to 10 mol. %, greater than or equal to 11 mol. %, greater than or equal to 12 mol. %, greater than or equal to 13 mol. %, greater than or equal to 14 mol. %, greater than or equal to 15 mol. %, greater than or equal to 16 mol. %, greater than or equal to 17 mol. %, greater than or equal to 18 mol. %, greater than or equal to 19 mol. %, or even greater than or equal to 20 mol. %. In embodiments, the upper bound of the amount of Al₂O₃ in the composition may be less than or equal to 40 mol. %, less than or equal to 35 mol. %, less than or equal to 30 mol. %, less than or equal to 28 mol. %, less than or equal to 27 mol. %, less than or equal to 26 mol. %, less than or equal to 25 mol. %, less than or equal to 24 mol. %, less than or equal to 23 mol. %, less than or equal to 22 mol. %, less than or equal to 21 mol. %, less than or equal to 19 mol. %, less than or equal to 18 mol. %, less than or equal to 17 mol. %, or even less than or equal to 16 mol. %. It should be understood that the amount of Al₂O₃ in the compositions may be within a range formed from any one of the lower bounds for Al₂O₃ and any one of the upper bounds of Al₂O₃ described herein.

For example and without limitation, the compositions may include Al₂O₃ in an amount greater than or equal to 5 mol. % and less than or equal to 28 mol. %. In embodiments, the amount of Al₂O₃ in the composition is greater than or equal to 5 mol. % and less than or equal to 27 mol. %. In embodiments, the amount of Al₂O₃ in the composition is greater than or equal to 5 mol. % and less than or equal to 26 mol. %. In embodiments, the amount of Al₂O₃ in the composition is greater than or equal to 5 mol. % and less than or equal to 25 mol. %. In embodiments, the amount of Al₂O₃ in the composition is greater than or equal to 6 mol. % and less than or equal to 28 mol. %. In embodiments, the amount of Al₂O₃ in the composition is greater than or equal to 7 mol. % and less than or equal to 28 mol. %. In embodiments, the amount of Al₂O₃ in the composition is greater than or equal to 8 mol. % and less than or equal to 28 mol. %. In embodiments, the amount of Al₂O₃ in the composition is greater than or equal to 9 mol. % and less than or equal to 28 mol. %. In embodiments, the amount of Al₂O₃ in the composition is greater than or equal to 10 mol. % and less than or equal to 28 mol. %. In embodiments, the amount of Al₂O₃ in the composition is greater than or equal to 10 mol. % and less than or equal to 27 mol. %. In embodiments, the amount of Al₂O₃ in the composition is greater than or equal to 16 mol. % and less than or equal to 24 mol. %. In embodiments, the compositions may include Al₂O₃ in an amount greater than or equal to 8 mol. % and less than or equal to 40 mol. %. In embodiments, the amount of Al₂O₃ in the composition is greater than or equal to 8 mol. % and less than or equal to 35 mol. %. In embodiments, the amount of Al₂O₃ in the composition is greater than or equal to 8 mol. % and less than or equal to 30 mol. %. In embodiments, the amount of Al₂O₃ in the composition is greater than or equal to 8 mol. % and less than or equal to 25 mol. %. In embodiments, the amount of Al₂O₃ in the composition is greater than or equal to 9 mol. % and less than or equal to 40 mol. %. In embodiments, the amount of Al₂O₃ in the composition is greater than or equal to 10 mol. % and less than or equal to 40 mol. %. In embodiments, the amount of Al₂O₃ in the composition is greater than or equal to 11 mol. % and less than or equal to 40 mol. %. In embodiments, the amount of Al₂O₃ in the composition is greater than or equal to 12 mol. % and less than or equal to 40 mol. %. In embodiments, the amount of Al₂O₃ in the composition is greater than or equal to 13 mol. % and less than or equal to 40 mol. %.

The compositions also include one or more alkali oxides. The sum of all alkali oxides (in mol. %) is expressed herein as R₂O. Specifically, R₂O is the sum of Li₂O (mol. %), Na₂O (mol. %), K₂O (mol. %), Rb₂O (mol. %), and Cs₂O (mol. %) present in the composition. Without intending to be bound by any particular theory, it is believed that the alkali oxides aid in decreasing the softening point, thereby offsetting the increase in the softening point of the composition due the amount of SiO₂ in the composition. The decrease in the softening point may be further enhanced by including combinations of alkali oxides (e.g., two or more alkali oxides) in the composition, a phenomenon referred to as the “mixed alkali effect.” Additionally, the presence of R₂O may enable chemical strengthening by ion exchange. Because the maximum CT is dependent on the amount of alkali that can be ion exchanged into the glass, in some embodiments, the compositions may have at least 10 mol. % R₂O.

In embodiments, the amount of alkali oxide (i.e., the amount of R₂O) in the compositions may be greater than or equal to 5 mol. % and less than or equal to 28 mol. %. If the R₂O content is too low, there are too few ions to exchange and the resultant stress after ion exchange is too low. If, however, the R₂O content is too high, the glass may become unstable, may devitrify, and may exhibit poor chemical durability. In embodiments, the lower bound of the amount of R₂O in the composition may be greater than or equal to 5 mol. %, greater than or equal to 6 mol. %, greater than or equal to 7 mol. %, greater than or equal to 8 mol. %, greater than or equal to 9 mol. %, greater than or equal to 10 mol. %, greater than or equal to 11 mol. %, greater than or equal to 12 mol. %, greater than or equal to 13 mol. %, greater than or equal to 14 mol. %, greater than or equal to 15 mol. %, or even greater than or equal to 16 mol. %. In embodiments, the upper bound of the amount of R₂O in the composition may be less than or equal to 28 mol. %, less than or equal to 27 mol. %, less than or equal to 26 mol. %, less than or equal to 25 mol. %, less than or equal to 24 mol. %, less than or equal to 23 mol. %, less than or equal to 22 mol. %, less than or equal to 21 mol. %, less than or equal to 20 mol. %, less than or equal to 19 mol. %, less than or equal to 18 mol. %, or even less than or equal to 17 mol. %. It should be understood that the amount of R₂O in the compositions may be within a range formed from any one of the lower bounds for R₂O and any one of the upper bounds of R₂O described herein.

For example and without limitation, the compositions may include R₂O in an amount greater than or equal to 5 mol. % and less than or equal to 28 mol. %. In embodiments, the amount of R₂O in the composition is greater than or equal to 5 mol. % and less than or equal to 27 mol. %. In embodiments, the amount of R₂O in the composition is greater than or equal to 5 mol. % and less than or equal to 26 mol. %. In embodiments, the amount of R₂O in the composition is greater than or equal to 5 mol. % and less than or equal to 25 mol. %. In embodiments, the amount of R₂O in the composition is greater than or equal to 6 mol. % and less than or equal to 28 mol. %. In embodiments, the amount of R₂O in the composition is greater than or equal to 7 mol. % and less than or equal to 28 mol. %. In embodiments, the amount of R₂O in the composition is greater than or equal to 7 mol. % and less than or equal to 25 mol. %. In embodiments, the amount of R₂O in the composition is greater than or equal to 8 mol. % and less than or equal to 28 mol. %. In embodiments, the amount of R₂O in the composition is greater than or equal to 9 mol. % and less than or equal to 28 mol. %. In embodiments, the amount of R₂O in the composition is greater than or equal to 10 mol. % and less than or equal to 28 mol. %. In embodiments, the amount of R₂O in the composition is greater than or equal to 11 mol. % and less than or equal to 28 mol. %. In embodiments, the amount of R₂O in the composition is greater than or equal to 12 mol. % and less than or equal to 28 mol. %. In embodiments, the amount of R₂O in the composition is greater than or equal to 13 mol. % and less than or equal to 28 mol. %. In embodiments, the amount of R₂O in the composition is greater than or equal to 12 mol. % and less than or equal to 18 mol. %.

In embodiments, R₂O includes at least Li₂O. Without intending to be bound by any particular theory, it is believed that Li₂O contributes to enhanced stiffness, fracture toughness, critical strain release rate, and Young's modulus of the glass-based article. Additionally, Li has a high diffusivity through the glass matrix, which enables ion exchange times of less than 24 hours for samples thinner than 1 mm when Na is ion exchanged for Li in the glass.

In embodiments of the compositions, Li₂O may be present in the composition in an amount greater than or equal to 5 mol. %. The amount of Li₂O in the composition may be less than or equal to 28 mol. %. In embodiments, Li₂O may be present in the composition in an amount greater than or equal to 9 mol. %. The amount of Li₂O in the composition may be less than or equal to 40 mol. %. If the Li₂O is too low, too few ions are available to ion exchange and the resultant stress after ion exchange is low. If, however, the Li₂O content is too high, the glass may be unstable, may exhibit a liquidus viscosity that is too low, and may have poor chemical durability. Accordingly, the amount of Li₂O in the composition may be greater than or equal to 5 mol. % and less than or equal to 28 mol. %. In embodiments, the amount of Li₂O in the composition may be greater than or equal to 9 mol. % and less than or equal to 40 mol. %.

In embodiments, the lower bound of the amount of Li₂O in the composition may be greater than or equal to 5 mol. %, greater than or equal to 6 mol. %, greater than or equal to 7 mol. %, greater than or equal 8 mol. %, greater than or equal 9 mol. %, greater than or equal 10 mol. %, greater than or equal 11 mol. %, greater than or equal 12 mol. %, greater than or equal 13 mol. %, greater than or equal 14 mol. %, or greater than or equal 15 mol. %, greater than or equal 16 mol. %, or even greater than or equal to 17 mol. %. In embodiments, the upper bound of the amount of Li₂O in the composition may be less than or equal to 40 mol. %, less than or equal to 35 mol. %, less than or equal to 30 mol. %, less than or equal to 28 mol. %, less than or equal to 27 mol. %, less than or equal to 26 mol. %, less than or equal to 25 mol. %, less than or equal to 24 mol. %, less than or equal to 23 mol. %, less than or equal to 22 mol. %, less than or equal to 21 mol. %, less than or equal to 20 mol. %, less than or equal to 19 mol. %, or even less than or equal to 18 mol. %. It should be understood that the amount of Li₂O in the compositions may be within a range formed from any one of the lower bounds for Li₂O and any one of the upper bounds of Li₂O described herein.

For example and without limitation, the compositions may include Li₂O in an amount greater than or equal to 5 mol. % and less than or equal to 28 mol. %. In embodiments, the amount of Li₂O in the composition is greater than or equal to 5 mol. % and less than or equal to 27 mol. %. In embodiments, the amount of Li₂O in the composition is greater than or equal to 5 mol. % and less than or equal to 26 mol. %. In embodiments, the amount of Li₂O in the composition is greater than or equal to 5 mol. % and less than or equal to 25 mol. %. In embodiments, the amount of Li₂O in the composition is greater than or equal to 5 mol. % and less than or equal to 24 mol. %. In embodiments, the amount of Li₂O in the composition is greater than or equal to 6 mol. % and less than or equal to 28 mol. %. In embodiments, the amount of Li₂O in the composition is greater than or equal to 6 mol. % and less than or equal to 27 mol. %. In embodiments, the amount of Li₂O in the composition is greater than or equal to 6 mol. % and less than or equal to 26 mol. %. In embodiments, the amount of Li₂O in the composition is greater than or equal to 7 mol. % and less than or equal to 26 mol. %. In embodiments, the amount of Li₂O in the composition is greater than or equal to 8 mol. % and less than or equal to 25 mol. %. In embodiments, the amount of Li₂O in the composition is greater than or equal to 9 mol. % and less than or equal to 24 mol. %. In embodiments, the amount of Li₂O in the composition is greater than or equal to 10 mol. % and less than or equal to 23 mol. %. In embodiments, the amount of Li₂O in the composition is greater than or equal to 11 mol. % and less than or equal to 22 mol. %. In embodiments, the amount of Li₂O in the composition is greater than or equal to 12 mol. % and less than or equal to 21 mol. %. In embodiments, the amount of Li₂O in the composition is greater than or equal to 13 mol. % and less than or equal to 20 mol. %. In embodiments, the amount of Li₂O in the composition is greater than or equal to 14 mol. % and less than or equal to 19 mol. %. In embodiments, the amount of Li₂O in the composition is greater than or equal to 15 mol. % and less than or equal to 18 mol. %. In embodiments, the amount of Li₂O in the composition is greater than or equal to 12 mol. % and less than or equal to 17 mol. %. In embodiments, the compositions may include Li₂O in an amount greater than or equal to 9 mol. % and less than or equal to 40 mol. %. In embodiments, the amount of Li₂O in the composition is greater than or equal to 9 mol. % and less than or equal to 35 mol. %. In embodiments, the amount of Li₂O in the composition is greater than or equal to 9 mol. % and less than or equal to 30 mol. %. In embodiments, the amount of Li₂O in the composition is greater than or equal to 10 mol. % and less than or equal to 40 mol. %. In embodiments, the amount of Li₂O in the composition is greater than or equal to 10 mol. % and less than or equal to 35 mol. %. In embodiments, the amount of Li₂O in the composition is greater than or equal to 10 mol. % and less than or equal to 30 mol. %. In embodiments, the amount of Li₂O in the composition is greater than or equal to 11 mol. % and less than or equal to 40 mol. %. In embodiments, the amount of Li₂O in the composition is greater than or equal to 12 mol. % and less than or equal to 35 mol. %. In embodiments, the amount of Li₂O in the composition is greater than or equal to 13 mol. % and less than or equal to 30 mol. %.

To perform ion exchange, at least one relatively small alkali oxide ion (e.g., Li or Na) is exchanged with larger alkali ions (e.g., K⁺) from an ion exchange medium. In general, the three most common types of ion exchange are Na-for-Li, K-for-Li, and K-for-Na. The first type, Na-for-Li, produces articles having a large depth of layer but a small compressive stress. The second type, K-for-Li, produces articles having a small depth of layer but a large compressive stress. The third type, K-for-Na, produces articles with intermediate depth of layer and compressive stress.

In embodiments of the compositions, the alkali oxide (R₂₀) includes Na₂O. As noted herein, additions of alkali oxides such as Na₂O decrease the softening point, thereby offsetting the increase in the softening point of the composition due to SiO₂ in the composition. Small amounts of Na₂O and K₂O may also help lower the liquidus temperature of the glass. However, if the amount of Na₂O is too high, the coefficient of thermal expansion of the composition becomes too high, which is undesirable. If the Na₂O or K₂O content is too high, the maximum achievable stress may be too low because the stress varies with the number of small ions in the glass that can be exchanged with larger ions external to the glass.

In embodiments, the compositions may be substantially free of Na₂O. In embodiments, the compositions may be free of Na₂O. In embodiments of the compositions that include Na₂O, the Na₂O may be present in the composition in an amount greater than 0 mol. % to improve the formability of the composition and increase the rate of ion exchange. The amount of Na₂O in the composition may be less than or equal to 7 mol. % so that the coefficient of thermal expansion is not undesirably high. Accordingly, the amount of Na₂O in embodiments of the compositions that include Na₂O is greater than 0 mol. % and less than or equal to 7 mol. %. In such embodiments, the lower bound of the amount of Na₂O in the composition may be greater than 0 mol. %, greater than or equal to 0.5 mol. %, greater than or equal to 1 mol. %, greater than or equal to 1.5 mol. %, greater than or equal to 2 mol. %, greater than or equal to 2.5 mol. %, greater than or equal to 3 mol. %, or even greater than or equal to 3.5 mol. %. In embodiments, the upper bound of the amount of Na₂O in the composition may be less than or equal to 7 mol. %, less than or equal to 6.5 mol. %, less than or equal to 6 mol. %, less than or equal to 5.5 mol. %, less than or equal to 5 mol. %, less than or equal to 4.5 mol. %, less than or equal to 4 mol. %, or even less than or equal to 3.5 mol. %. It should be understood that the amount of Na₂O in the compositions may be within a range formed from any one of the lower bounds for Na₂O and any one of the upper bounds of Na₂O described herein. In embodiments, the amount of Na₂O in the composition is greater than or equal to 0.5 mol. % and less than or equal to 3.5 mol. %.

For example and without limitation, the compositions that include Na₂O may include Na₂O in an amount greater than 0 mol. % and less than or equal to 7 mol. %. In embodiments, the amount of Na₂O in the composition is greater than 0 mol. % and less than or equal to 6.5 mol. %. In embodiments, the amount of Na₂O in the composition is greater than 0 mol. % and less than or equal to 6 mol. %. In embodiments, the amount of Na₂O in the composition is greater than 0 mol. % and less than or equal to 5.5 mol. %. In embodiments, the amount of Na₂O in the composition is greater than or equal to 0.5 mol. % and less than or equal to 7 mol. %. In embodiments, the amount of Na₂O in the composition is greater than or equal to 0.5 mol. % and less than or equal to 6.5 mol. %. In embodiments, the amount of Na₂O in the composition is greater than or equal to 0.5 mol. % and less than or equal to 6 mol. %. In embodiments, the amount of Na₂O in the composition is greater than or equal to 0.5 mol. % and less than or equal to 5.5 mol. %. In embodiments, the amount of Na₂O in the composition is greater than 0 mol. % and less than or equal to 3.5 mol. %. In embodiments, the amount of Na₂O in the composition is greater than 0.5 mol. % and less than or equal to 3.5 mol. %. In embodiments, the amount of Na₂O in the composition is greater than or equal to 1 mol. % and less than or equal to 3.5 mol. %. In embodiments, the amount of Na₂O in the composition is greater than or equal to 1.5 mol. % and less than or equal to 3.5 mol. %.

The alkali oxide in the compositions may optionally include K₂O. Like Na₂O, additions of K₂O decrease the softening point of the composition, thereby offsetting the increase in the softening point of the composition due to SiO₂ in the composition. However, if the amount of K₂O is too high, the ion exchange stress will be low and the coefficient of thermal expansion of the composition becomes too high, which is undesirable. Accordingly, it is desirable to limit the amount of K₂O present in the composition.

In embodiments, the compositions may be substantially free of K₂O. In embodiments, the compositions may be free of K₂O. In embodiments where the alkali oxide includes K₂O, the K₂O may be present in the composition in an amount greater than 0 mol. %, such as greater than or equal to 0.5 or even greater than or equal to 1 mol. %, to aid in improving the formability of the composition. When present, the amount of K₂O is less than or equal to 3 mol. % or even less than or equal to 2 mol. % so that the coefficient of thermal expansion is not undesirably high. Accordingly, the amount of K₂O in embodiments of the composition that include K₂O may be greater than 0 mol. % and less than or equal to 3 mol. % or even greater than or equal to 0 mol. % and less than or equal to 2 mol. %. In such embodiments, the lower bound of the amount of K₂O in the composition may be greater than 0 mol. %, greater than or equal to 0.25 mol. %, greater than or equal to 0.5 mol. %, greater than or equal to 0.75 mol. %, or even greater than or equal to 1 mol. %. In embodiments, the upper bound of the amount of K₂O in the composition may be less than or equal to 3 mol. %, less than or equal to 2.5 mol. %, less than or equal to 2 mol. %, less than or equal to 1.75 mol. %, less than or equal to 1.5 mol. %, less than or equal to 1.25 mol. %, or even less than or equal to 1 mol. %. It should be understood that the amount of K₂O in the compositions may be within a range formed from any one of the lower bounds for K₂O and any one of the upper bounds of K₂O described herein.

For example and without limitation, the compositions having K₂O may include K₂O in an amount greater than 0 mol. % to less than or equal to 2 mol. %. In embodiments, the amount of K₂O in the composition is greater than or equal to 0.25 mol. % and less than or equal to 1.75 mol. %. In embodiments, the amount of K₂O in the composition is greater than or equal to 0.5 mol. % and less than or equal to 1.5 mol. %. In embodiments, the amount of K₂O in the composition is greater than or equal to 0.75 mol. % and less than or equal to 1.25 mol. %. In embodiments, the amount of K₂O in the composition is about 1 mol. %. In embodiments, the amount of K₂O in the composition is greater than or equal to 0.25 mol. % and less than or equal to 1.5 mol. %. In embodiments, the amount of K₂O in the composition is greater than or equal to 0.25 mol. % and less than or equal to 1.25 mol. %. In embodiments, the amount of K₂O in the composition is greater than or equal to 0.25 mol. % and less than or equal to 1 mol. %. In embodiments, the amount of K₂O in the composition is greater than or equal to 0.5 mol. % and less than or equal to 2 mol. %. In embodiments, the amount of K₂O in the composition is greater than or equal to 0.5 mol. % and less than or equal to 1.75 mol. %. In embodiments, the amount of K₂O in the composition is greater than or equal to 0.5 mol. % and less than or equal to 1.5 mol. %. In embodiments, the amount of K₂O in the composition is greater than or equal to 0.5 mol. % and less than or equal to 1.25 mol. %. In embodiments, the amount of K₂O in the composition is greater than or equal to 0.5 mol. % and less than or equal to 1 mol. %. In embodiments, the amount of K₂O in the composition is greater than or equal to 0 mol. % and less than or equal to 1 mol. %. In embodiments, the amount of K₂O in the composition is greater than 0 mol. % to less than or equal to 3 mol. %. In embodiments, the amount of K₂O in the composition is greater than or equal to 0.25 mol. % and less than or equal to 2.5 mol. %. In embodiments, the amount of K₂O in the composition is greater than or equal to 0.5 mol. % and less than or equal to 2 mol. %. In embodiments, the amount of K₂O in the composition is greater than or equal to 0.75 mol. % and less than or equal to 1.5 mol. %. In embodiments, the amount of K₂O in the composition is about 1 mol. %. In embodiments, the amount of K₂O in the composition is greater than or equal to 0.25 mol. % and less than or equal to 2 mol. %. In embodiments, the amount of K₂O in the composition is greater than or equal to 0.25 mol. % and less than or equal to 1.5 mol. %. In embodiments, the amount of K₂O in the composition is greater than or equal to 0.25 mol. % and less than or equal to 1 mol. %. In embodiments, the amount of K₂O in the composition is greater than or equal to 0.5 mol. % and less than or equal to 3 mol. %. In embodiments, the amount of K₂O in the composition is greater than or equal to 0.5 mol. % and less than or equal to 2.5 mol. %. In embodiments, the amount of K₂O in the composition is greater than or equal to 0.5 mol. % and less than or equal to 2 mol. %. In embodiments, the amount of K₂O in the composition is greater than or equal to 0.5 mol. % and less than or equal to 1.5 mol. %.

Additions of Ta₂O₅ to the compositions may lower the liquidus temperature and increase the fracture toughness, Young's modulus, density, refractive index, iox exchange rate, and ion exchange stress. In embodiments, the compositions may be substantially free of Ta₂O₅. In embodiments, the compositions may be free of Ta₂O₅. In embodiments of the composition which include Ta₂O₅, the lower bound of the amount of Ta₂O₅ present in the composition may be greater than 0 mol. %, greater than or equal to 0.5 mol. %, greater than or equal to 1 mol. %, greater than or equal to 1.5 mol. %, greater than or equal to 2 mol. %, greater than or equal to 2.5 mol. %, greater than or equal to 3 mol. %, greater than or equal to 3.5 mol. %, greater than or equal to 4 mol. %, greater than or equal to 4.5 mol. %, or even greater than or equal to 5 mol. %. In embodiments, the upper bound of the amount of Ta₂O₅ in the composition may be less than or equal to 10 mol. %, less than or equal to 9.5 mol. %, less than or equal to 9 mol. %, less than or equal to 8.5 mol. %, less than or equal to 8 mol. %, less than or equal to 7.5 mol. %, less than or equal to 7 mol. %, less than or equal to 6.5 mol. %, less than or equal to 6 mol. %, or even less than or equal to 5.5 mol. %. It should be understood that the amount of Ta₂O₅ in the compositions may be within a range formed from any one of the lower bounds for Ta₂O₅ and any one of the upper bounds of Ta₂O₅ described herein.

For example and without limitation, the compositions may include Ta₂O₅ in an amount greater than 0 mol. % and less than or equal to 10 mol. %. If the Ta₂O₅ content is too high, the liquidus temperature may increase and the glass may become unstable and crystallize. Ta₂O₅ may also increase the cost of the compositions. In embodiments, the composition may include greater than 0 mol. % and less than or equal to 9.5 mol. % Ta₂O₅. In embodiments, the composition may include greater than 0 mol. % and less than or equal to 9 mol. % Ta₂O₅. In embodiments, the composition may include greater than 0 mol. % and less than or equal to 8.5 mol. % Ta₂O₅. In embodiments, the composition may include greater than 0 mol. % and less than or equal to 8 mol. % Ta₂O₅. In embodiments, the composition may include greater than 0 mol. % and less than or equal to 7.5 mol. % Ta₂O₅. In embodiments, the composition may include greater than 0 mol. % and less than or equal to 7 mol. % Ta₂O₅. In embodiments, the composition may include greater than 0 mol. % and less than or equal to 6.5 mol. % Ta₂O₅. In embodiments, the composition may include greater than 0 mol. % and less than or equal to 6 mol. % Ta₂O₅. In embodiments, the composition may include greater than 0 mol. % and less than or equal to 5.5 mol. % Ta₂O₅. In embodiments, the composition may include greater than or equal to 0.5 mol. % and less than or equal to 10 mol. % Ta₂O₅. In embodiments, the composition may include greater than or equal to 1 mol. % and less than or equal to 10 mol. % Ta₂O₅. In embodiments, the composition may include greater than or equal to 1.5 mol. % and less than or equal to 10 mol. % Ta₂O₅. In embodiments, the composition may include greater than or equal to 2 mol. % and less than or equal to 10 mol. % Ta₂O₅. In embodiments, the composition may include greater than or equal to 2.5 mol. % and less than or equal to 10 mol. % Ta₂O₅. In embodiments, the composition may include greater than or equal to 3 mol. % and less than or equal to 10 mol. % Ta₂O₅. In embodiments, the composition may include greater than or equal to 3.5 mol. % and less than or equal to 10 mol. % Ta₂O₅. In embodiments, the composition may include greater than or equal to 4 mol. % and less than or equal to 10 mol. % Ta₂O₅. In embodiments, the composition may include greater than 4.5 mol. % and less than or equal to 10 mol. % Ta₂O₅. In embodiments, the composition may include greater than 5 mol. % and less than or equal to 10 mol. % Ta₂O₅.

The compositions may further comprise one or more additional metal oxides to further improve various properties of the glass-based articles described herein. Specifically, it has been found that additions of at least one of TiO₂ and ZrO₂ may further increase the Young's modulus, fracture toughness and ion exchange stress. However, once the TiO₂+ZrO₂ content exceeds 6 mol. % the liquidus temperature may increase and the glass may become unstable and susceptible to crystallization. It has also been found that additions of at least one of TiO₂ and ZrO₂ beneficially decrease the average coefficient of thermal expansion of the composition. Without wishing to be bound by theory, it is believed that the addition of at least one of TiO₂ and ZrO₂ improves the properties of the glass by enhancing the functionality of Al₂O₃ in the composition. With respect to chemical durability, for instance, it is believed that additions of Al₂O₃ to the composition reduce the amount of non-bridging oxygen in the composition which, in turn, improves the chemical durability of the glass. However, it has been found that if the amount of Al₂O₃ in the composition is too high, the resistance of the composition to acid attack is diminished. It has now been found that including at least one of TiO₂ and ZrO₂ in addition to Al₂O₃, further reduces the amount of non-bridging oxygen in the composition which, in turn, further improves the chemical durability of the glass beyond that achievable by additions of Al₂O₃ alone.

Additions of ZrO₂ to the compositions may improve Young's modulus, fracture toughness, and ion exchange stress. In embodiments, the compositions may be substantially free of ZrO₂. In embodiments, the compositions may be free of ZrO₂. In embodiments of the composition which include ZrO₂, the lower bound of the amount of ZrO₂ present in the composition may be greater than 0 mol. %, greater than or equal to 0.5 mol. %, greater than or equal to 1 mol. %, greater than or equal to 1.5 mol. %, greater than or equal to 2 mol. %, greater than or equal to 2.5 mol. %, or even greater than or equal to 3 mol. %. In embodiments, the upper bound of the amount of ZrO₂ in the composition may be less than or equal to 6 mol. %, less than or equal to 5.5 mol. %, less than or equal to 5 mol. %, less than or equal to 4.5 mol. %, less than or equal to 4 mol. %, or even less than or equal to 3.5 mol. %. It should be understood that the amount of ZrO₂ in the compositions may be within a range formed from any one of the lower bounds for ZrO₂ and any one of the upper bounds of ZrO₂ described herein.

For example and without limitation, the compositions may include ZrO₂ in an amount greater than 0 mol. % and less than or equal to 6 mol. %. In embodiments, the composition may include greater than 0 mol. % and less than or equal to 5.5 mol. % ZrO₂. In embodiments, the composition may include greater than 0 mol. % and less than or equal to 5 mol. % ZrO₂. In embodiments, the composition may include greater than 0 mol. % and less than or equal to 4.5 mol. % ZrO₂. In embodiments, the composition may include greater than 0 mol. % and less than or equal to 4 mol. % ZrO₂. In embodiments, the composition may include greater than 0 mol. % and less than or equal to 3.5 mol. % ZrO₂. In embodiments, the composition may include greater than or equal to 0.5 mol. % and less than or equal to 6 mol. % ZrO₂. In embodiments, the composition may include greater than or equal to 1 mol. % and less than or equal to 6 mol. % ZrO₂. In embodiments, the composition may include greater than or equal to 1.5 mol. % and less than or equal to 6 mol. % ZrO₂. In embodiments, the composition may include greater than or equal to 2 mol. % and less than or equal to 6 mol. % ZrO₂. In embodiments, the composition may include greater than or equal to 2.5 mol. % and less than or equal to 6 mol. % ZrO₂. In embodiments, the composition may include greater than or equal to 3 mol. % and less than or equal to 6 mol. % ZrO₂.

In embodiments, the compositions may optionally include TiO₂. Without intending to be bound by any particular theory, it is believed that additions of TiO₂ to the composition improve Young's modulus, fracture toughness, and ion exchange stress.

In embodiments, the compositions may be substantially free of TiO₂. In embodiments, the compositions may be free of TiO₂. In embodiments of the composition which include TiO₂, the lower bound of the amount of TiO₂ present in the composition may be greater than 0 mol. %, greater than or equal to 0.5 mol. %, greater than or equal to 1 mol. %, greater than or equal to 1.5 mol. %, greater than or equal to 2 mol. %, greater than or equal to 2.5 mol. %, or even greater than or equal to 3 mol. %. In embodiments, the upper bound of the amount of TiO₂ in the composition may be less than or equal to 6 mol. %, less than or equal to 5.5 mol. %, less than or equal to 5 mol. %, less than or equal to 4.5 mol. %, less than or equal to 4 mol. %, or even less than or equal to 3.5 mol. %. It should be understood that the amount of TiO₂ in the compositions may be within a range formed from any one of the lower bounds for TiO₂ and any one of the upper bounds of TiO₂ described herein.

For example and without limitation, the compositions may include TiO₂ in an amount greater than 0 mol. % and less than or equal to 6 mol. %. In embodiments, the composition may include greater than 0 mol. % and less than or equal to 5.5 mol. % TiO₂. In embodiments, the composition may include greater than 0 mol. % and less than or equal to 5 mol. % TiO₂. In embodiments, the composition may include greater than 0 mol. % and less than or equal to 4.5 mol. % TiO₂. In embodiments, the composition may include greater than 0 mol. % and less than or equal to 4 mol. % TiO₂. In embodiments, the composition may include greater than 0 mol. % and less than or equal to 3.5 mol. % TiO₂. In embodiments, the composition may include greater than or equal to 0.5 mol. % and less than or equal to 6 mol. % TiO₂. In embodiments, the composition may include greater than or equal to 1 mol. % and less than or equal to 6 mol. % TiO₂. In embodiments, the composition may include greater than or equal to 1.5 mol. % and less than or equal to 6 mol. % TiO₂. In embodiments, the composition may include greater than or equal to 2 mol. % and less than or equal to 6 mol. % TiO₂. In embodiments, the composition may include greater than or equal to 2.5 mol. % and less than or equal to 6 mol. % TiO₂. In embodiments, the composition may include greater than or equal to 3 mol. % and less than or equal to 6 mol. % TiO₂.

The compositions may also include one or more alkaline earth oxides or ZnO. The sum of all alkaline earth oxides and ZnO (in mol. %) is expressed herein as R′O. Specifically, R′O is the sum of MgO (mol. %), CaO (mol. %), SrO (mol. %), BaO (mol. %), and ZnO (mol. %) present in the composition. Without intending to be bound by any particular theory, it is believed that the alkaline earth oxides may be introduced in the glass to enhance various properties. For example, the addition of certain alkaline earth oxides may increase the ion exchange stress but may decrease the alkali diffusivity. R′O may also help to decrease the liquidus temperature at low concentrations. R′O may also aid in decreasing the softening point and molding temperature of the composition, thereby offsetting the increase in the softening point and molding temperature of the composition due to SiO₂ in the composition. Additions of certain alkaline earth oxides may also aid in reducing the tendency of the glass to crystalize. In general, additions of alkaline earth oxide do not increase the average coefficient of thermal expansion of the composition over the temperature range from 20° C. to 300° C. as much as alternative modifiers (e.g., alkali oxides). In addition, it has been found that relatively smaller alkaline earth oxides do not increase the average coefficient of thermal expansion of the composition over the temperature range from 20° C. to 300° C. as much as larger alkaline earth oxides. For example, MgO increases the average coefficient of thermal expansion of the composition less than BaO increases the average coefficient of thermal expansion of the composition.

In embodiments, the compositions may be substantially free of alkaline earth oxides. In embodiments, the compositions may be free of alkaline earth oxides. In embodiments of the compositions including alkaline earth oxides, the alkaline earth oxides may be present in an amount greater than 0 mol. %, such as greater than or equal to 0.5 mol. %, and less than or equal to 8 mol. %. Without intending to be bound by any particular theory, it is believed that alkaline earth oxides and ZnO decrease alkali diffusivity and slow ion exchange. Thus, the content of alkaline earth oxides and ZnO can be minimized to prevent excessive ion exchange times for glasses with thicknesses greater than 0.5 mm. In embodiments including alkaline earth oxides, the lower bound of the amount of alkaline earth oxide in the compositions may be greater than 0 mol. %, greater than or equal to 0.5 mol. %, greater than or equal to 1 mol. %, greater than or equal to 1.5 mol. %, greater or equal to 2 mol. %, greater than or equal to 2.5 mol. %, greater than or equal to 3 mol. %, greater than or equal to 3.5 mol. %, and even greater than or equal to 4 mol. %. In such embodiments, the upper bound of the amount of alkaline earth oxide in the composition may be less than or equal to 8 mol. %, less than or equal to 7.5 mol. %, less than or equal to 7 mol. %, less than or equal to 6.5 mol. %, less than or equal to 6 mol. %, less than or equal to 5.5 mol. %, less than or equal to 5 mol. %, less than or equal to 4.5 mol. %, less than or equal to 4 mol. %, or even less than or equal to 3.5 mol. %. It should be understood that the amount of alkaline earth oxide in the compositions may be within a range formed from any one of the lower bounds for alkaline earth oxide and any one of the upper bounds of alkaline earth oxide described herein.

For example and without limitation, the compositions may include alkaline earth oxide in an amount greater than 0 mol. % and less than or equal to 8 mol. %. In embodiments, the composition may include greater than 0 mol. % and less than or equal to 7.5 mol. % alkaline earth oxide. In embodiments, the composition may include greater than 0 mol. % and less than or equal to 7 mol. % alkaline earth oxide. In embodiments, the composition may include greater than 0 mol. % and less than or equal to 6.5 mol. % alkaline earth oxide. In embodiments, the composition may include greater than 0 mol. % and less than or equal to 6 mol. % alkaline earth oxide. In embodiments, the composition may include greater than 0 mol. % and less than or equal to 5.5 mol. % alkaline earth oxide. In embodiments, the composition may include greater than 0 mol. % and less than or equal to 5 mol. % alkaline earth oxide. In embodiments, the composition may include greater than 0 mol. % and less than or equal to 4.5 mol. % alkaline earth oxide. In embodiments, the composition may include greater than 0 mol. % and less than or equal to 3.5 mol. % alkaline earth oxide. In embodiments, the composition may include greater than or equal to 0.5 mol. % and less than or equal to 8 mol. % alkaline earth oxide. In embodiments, the composition may include greater than or equal to 1.0 mol. % and less than or equal to 8 mol. % alkaline earth oxide. In embodiments, the composition may include greater than or equal to 1.5 mol. % and less than or equal to 8 mol. % alkaline earth oxide. In embodiments, the composition may include greater than or equal to 2 mol. % and less than or equal to 8 mol. % alkaline earth oxide. In embodiments, the composition may include greater than or equal to 2.5 mol. % and less than or equal to 8 mol. % alkaline earth oxide. In embodiments, the composition may include greater than or equal to 3 mol. % and less than or equal to 8 mol. % alkaline earth oxide. In embodiments, the composition may include greater than or equal to 3.5 mol. % and less than or equal to 8 mol. % alkaline earth oxide. In embodiments, the composition may include greater than or equal to 4 mol. % and less than or equal to 8 mol. % alkaline earth oxide. In embodiments, the composition may include greater than or equal to 0.5 mol. % and less than or equal to 3.5 mol. % alkaline earth oxide. In embodiments, the composition may include greater than or equal to 0.5 mol. % and less than or equal to 3 mol. % alkaline earth oxide. In embodiments, the composition may include greater than or equal to 0.5 mol. % and less than or equal to 2.5 mol. % alkaline earth oxide. In embodiments, the composition may include greater than or equal to 0.5 mol. % and less than or equal to 2 mol. % alkaline earth oxide. In embodiments, the composition may include greater than or equal to 0.5 mol. % and less than or equal to 1.5 mol. % alkaline earth oxide. In embodiments, the composition may include greater than or equal to 1 mol. % and less than or equal to 3.5 mol. % alkaline earth oxide. In embodiments, the composition may include greater than or equal to 1 mol. % and less than or equal to 3 mol. % alkaline earth oxide. In embodiments, the composition may include greater than or equal to 1 mol. % and less than or equal to 2.5 mol. % alkaline earth oxide. In embodiments, the composition may include greater than or equal to 1 mol. % and less than or equal to 2 mol. % alkaline earth oxide. In embodiments, the composition may include greater than or equal to 1 mol. % and less than or equal to 1.5 mol. % alkaline earth oxide.

In embodiments of the compositions described herein, the alkaline earth oxide in the composition may optionally include MgO. Without intending to be bound by any particular theory, it is believed that in addition to improving the formability and the meltability of the composition, MgO may also increase the viscosity of the glass and reduce the tendency of the glass to crystalize. Too much MgO tends to cause crystallization in the glass, decreasing the liquidus viscosity and decreasing formability.

In embodiments, the compositions may be substantially free of MgO. In embodiments, the compositions may be free of MgO. In embodiments where the composition includes MgO, the MgO may be present in an amount greater than 0 mol. %, such as greater than or equal to 0.5 mol. %, and less than or equal to 5 mol. %. In embodiments including MgO, the lower bound of the amount of MgO in the compositions may be greater than or equal to 0.25 mol. %, greater than or equal to 0.5 mol. %, greater than or equal to 0.75 mol. %, greater or equal to 1 mol. %, greater than or equal to 1.25 mol. %, greater than or equal to 1.5 mol. %, greater than or equal to 1.75 mol. %, greater or equal to 2.0 mol. %, greater or equal to 2.25 mol. %, or even greater than or equal to 2.5 mol. %. In such embodiments, the upper bound of the amount of MgO in the composition may be less than or equal to 5 mol. %, less than or equal to 4.75 mol. %, less than or equal to 4.5 mol. %, less than or equal to 4.25 mol. %, less than or equal to 4 mol. %, less than or equal to 3.75 mol. %, less than or equal to 3.5 mol. %, less than or equal to 3.25 mol. %, less than or equal to 3 mol. %, or even less than or equal to 2.75 mol. %. It should be understood that the amount of MgO in the compositions may be within a range formed from any one of the lower bounds for MgO and any one of the upper bounds of MgO described herein.

For example and without limitation, the compositions may include MgO in an amount greater than 0 mol. % and less than or equal to 5 mol. % MgO. In embodiments, the composition may include greater than 0 mol. % and less than or equal to 4.75 mol. % MgO. In embodiments, the composition may include greater than 0 mol. % and less than or equal to 4.5 mol. % MgO. In embodiments, the composition may include greater than 0 mol. % and less than or equal to 4.25 mol. % MgO. In embodiments, the composition may include greater than 0 mol. % and less than or equal to 4 mol. % MgO. In embodiments, the composition may include greater than 0 mol. % and less than or equal to 3.75 mol. % MgO. In embodiments, the composition may include greater than 0 mol. % and less than or equal to 3.5 mol. % MgO. In embodiments, the composition may include greater than 0 mol. % and less than or equal to 3.25 mol. % MgO. In embodiments, the composition may include greater than 0 mol. % and less than or equal to 3 mol. % MgO. In embodiments, the composition may include greater than 0 mol. % and less than or equal to 2.75 mol. % MgO. In embodiments, the composition may include greater than or equal to 0.25 mol. % and less than or equal to 5 mol. % MgO. In embodiments, the composition may include greater than or equal to 0.5 mol. % and less than or equal to 5 mol. % MgO. In embodiments, the composition may include greater than or equal to 0.75 mol. % and less than or equal to 5 mol. % MgO. In embodiments, the composition may include greater than or equal to 1 mol. % and less than or equal to 5 mol. % MgO. In embodiments, the composition may include greater than or equal to 1.25 mol. % and less than or equal to 5 mol. % MgO. In embodiments, the composition may include greater than or equal to 1.5 mol. % and less than or equal to 5 mol. % MgO. In embodiments, the composition may include greater than or equal to 1.75 mol. % and less than or equal to 5 mol. % MgO. In embodiments, the composition may include greater than or equal to 2 mol. % and less than or equal to 5 mol. % MgO. In embodiments, the composition may include greater than or equal to 2.25 mol. % and less than or equal to 5 mol. % MgO. In embodiments, the composition may include greater than or equal to 2.5 mol. % and less than or equal to 5 mol. % MgO. In embodiments, the composition may include greater than or equal to 0.5 mol. % and less than or equal to 2.5 mol. % MgO.

In embodiments of the compositions described herein, the alkaline earth oxide in the composition may optionally include CaO. Without intending to be bound by any particular theory, it is believed that in addition to improving the formability and the meltability of the composition, CaO may also lower the liquidus temperature in small amounts while improving chemical durability and lowering the CTE. If the CaO content is too high (or if the MgO+CaO content is too high) then the liquidus temperature can increase and degrade the liquidus viscosity.

In embodiments, the compositions may be substantially free of CaO. In embodiments, the compositions may be free of CaO. In embodiments where the composition includes CaO, the CaO may be present in an amount greater than 0 mol. %, such as greater than or equal to 0.5 mol. %, and less than or equal to 5 mol. %. In embodiments including CaO, the lower bound of the amount of CaO in the compositions may be greater than or equal to 0.25 mol. %, greater than or equal to 0.5 mol. %, greater than or equal to 0.75 mol. %, greater or equal to 1 mol. %, greater than or equal to 1.25 mol. %, greater than or equal to 1.5 mol. %, greater than or equal to 1.75 mol. %, greater or equal to 2.0 mol. %, greater or equal to 2.25 mol. %, or even greater than or equal to 2.5 mol. %. In such embodiments, the upper bound of the amount of CaO in the composition may be less than or equal to 5 mol. %, less than or equal to 4.75 mol. %, less than or equal to 4.5 mol. %, less than or equal to 4.25 mol. %, less than or equal to 4 mol. %, less than or equal to 3.75 mol. %, less than or equal to 3.5 mol. %, less than or equal to 3.25 mol. %, less than or equal to 3 mol. %, or even less than or equal to 2.75 mol. %. It should be understood that the amount of CaO in the compositions may be within a range formed from any one of the lower bounds for CaO and any one of the upper bounds of CaO described herein.

For example and without limitation, the compositions may include CaO in an amount greater than 0 mol. % and less than or equal to 5 mol. % CaO. In embodiments, the composition may include greater than 0 mol. % and less than or equal to 4.75 mol. % CaO. In embodiments, the composition may include greater than 0 mol. % and less than or equal to 4.5 mol. % CaO. In embodiments, the composition may include greater than 0 mol. % and less than or equal to 4.25 mol. % CaO. In embodiments, the composition may include greater than 0 mol. % and less than or equal to 4 mol. % CaO. In embodiments, the composition may include greater than 0 mol. % and less than or equal to 3.75 mol. % CaO. In embodiments, the composition may include greater than 0 mol. % and less than or equal to 3.5 mol. % CaO. In embodiments, the composition may include greater than 0 mol. % and less than or equal to 3.25 mol. % CaO. In embodiments, the composition may include greater than 0 mol. % and less than or equal to 3 mol. % CaO. In embodiments, the composition may include greater than 0 mol. % and less than or equal to 2.75 mol. % CaO. In embodiments, the composition may include greater than or equal to 0.25 mol. % and less than or equal to 5 mol. % CaO. In embodiments, the composition may include greater than or equal to 0.5 mol. % and less than or equal to 5 mol. % CaO. In embodiments, the composition may include greater than or equal to 0.75 mol. % and less than or equal to 5 mol. % CaO. In embodiments, the composition may include greater than or equal to 1 mol. % and less than or equal to 5 mol. % CaO. In embodiments, the composition may include greater than or equal to 1.25 mol. % and less than or equal to 5 mol. % CaO. In embodiments, the composition may include greater than or equal to 1.5 mol. % and less than or equal to 5 mol. % CaO. In embodiments, the composition may include greater than or equal to 1.75 mol. % and less than or equal to 5 mol. % CaO. In embodiments, the composition may include greater than or equal to 2 mol. % and less than or equal to 5 mol. % CaO. In embodiments, the composition may include greater than or equal to 2.25 mol. % and less than or equal to 5 mol. % CaO. In embodiments, the composition may include greater than or equal to 2.5 mol. % and less than or equal to 5 mol. % CaO. In embodiments, the composition may include greater than or equal to 0.5 mol. % and less than or equal to 2.5 mol. % CaO.

In the embodiments described herein, the alkaline earth oxide in the compositions may optionally include SrO. Without intending to be bound by any particular theory, it is believed that in addition to improving the formability and the meltability of the composition, SrO may also reduce the tendency of the glass to crystalize. Too much SrO changes the liquidus viscosity and may increase the CTE of the glass.

In embodiments, the compositions may be substantially free of SrO. In embodiments, the compositions may be free of SrO. In embodiments where the composition includes SrO, the SrO may be present in an amount greater than 0 mol. %, such as greater than or equal to 0.5 mol. %, and less than or equal to 5 mol. %. In embodiments including SrO, the lower bound of the amount of SrO in the compositions may be greater than or equal to 0.25 mol. %, greater than or equal to 0.5 mol. %, greater than or equal to 0.75 mol. %, greater or equal to 1 mol. %, greater than or equal to 1.25 mol. %, greater than or equal to 1.5 mol. %, greater than or equal to 1.75 mol. %, greater or equal to 2.0 mol. %, greater or equal to 2.25 mol. %, or even greater than or equal to 2.5 mol. %. In such embodiments, the upper bound of the amount of SrO in the composition may be less than or equal to 5 mol. %, less than or equal to 4.75 mol. %, less than or equal to 4.5 mol. %, less than or equal to 4.25 mol. %, less than or equal to 4 mol. %, less than or equal to 3.75 mol. %, less than or equal to 3.5 mol. %, less than or equal to 3.25 mol. %, less than or equal to 3 mol. %, or even less than or equal to 2.75 mol. %. It should be understood that the amount of SrO in the compositions may be within a range formed from any one of the lower bounds for SrO and any one of the upper bounds of SrO described herein.

For example and without limitation, the compositions may include SrO in an amount greater than 0 mol. % and less than or equal to 5 mol. % SrO. In embodiments, the composition may include greater than 0 mol. % and less than or equal to 4.75 mol. % SrO. In embodiments, the composition may include greater than 0 mol. % and less than or equal to 4.5 mol. % SrO. In embodiments, the composition may include greater than 0 mol. % and less than or equal to 4.25 mol. % SrO. In embodiments, the composition may include greater than 0 mol. % and less than or equal to 4 mol. % SrO. In embodiments, the composition may include greater than 0 mol. % and less than or equal to 3.75 mol. % SrO. In embodiments, the composition may include greater than 0 mol. % and less than or equal to 3.5 mol. % SrO. In embodiments, the composition may include greater than 0 mol. % and less than or equal to 3.25 mol. % SrO. In embodiments, the composition may include greater than 0 mol. % and less than or equal to 3 mol. % SrO. In embodiments, the composition may include greater than 0 mol. % and less than or equal to 2.75 mol. % SrO. In embodiments, the composition may include greater than or equal to 0.25 mol. % and less than or equal to 5 mol. % SrO. In embodiments, the composition may include greater than or equal to 0.5 mol. % and less than or equal to 5 mol. % SrO. In embodiments, the composition may include greater than or equal to 0.75 mol. % and less than or equal to 5 mol. % SrO. In embodiments, the composition may include greater than or equal to 1 mol. % and less than or equal to 5 mol. % SrO. In embodiments, the composition may include greater than or equal to 1.25 mol. % and less than or equal to 5 mol. % SrO. In embodiments, the composition may include greater than or equal to 1.5 mol. % and less than or equal to 5 mol. % SrO. In embodiments, the composition may include greater than or equal to 1.75 mol. % and less than or equal to 5 mol. % SrO. In embodiments, the composition may include greater than or equal to 2 mol. % and less than or equal to 5 mol. % SrO. In embodiments, the composition may include greater than or equal to 2.25 mol. % and less than or equal to 5 mol. % SrO. In embodiments, the composition may include greater than or equal to 2.5 mol. % and less than or equal to 5 mol. % SrO. In embodiments, the composition may include greater than or equal to 0.5 mol. % and less than or equal to 2.5 mol. % SrO.

In embodiments, the compositions may be substantially free of BaO. In embodiments, the compositions may be free of BaO. In embodiments where the composition includes BaO, the BaO may be present in an amount greater than 0 mol. %, such as greater than or equal to 0.5 mol. %, and less than or equal to 3 mol. %. In embodiments including BaO, the lower bound of the amount of BaO in the compositions may be greater than or equal to 0.25 mol. %, greater than or equal to 0.5 mol. %, greater than or equal to 0.75 mol. %, or even greater or equal to 1 mol. %. In such embodiments, the upper bound of the amount of BaO in the composition may be less than or equal to 3 mol. %, less than or equal to 2.75 mol. %, less than or equal to 2.5 mol. %, less than or equal to 2.25 mol. %, less than or equal to 2 mol. %, less than or equal to 1.75 mol. %, or even less than or equal to 1.5 mol. It should be understood that the amount of BaO in the compositions may be within a range formed from any one of the lower bounds for BaO and any one of the upper bounds of BaO described herein.

For example and without limitation, the compositions may include BaO in an amount greater than 0 mol. % and less than or equal to 3 mol. % BaO. In embodiments, the composition may include greater than 0 mol. % and less than or equal to 2.75 mol. % BaO. In embodiments, the composition may include greater than 0 mol. % and less than or equal to 2.5 mol. % BaO. In embodiments, the composition may include greater than 0 mol. % and less than or equal to 2.25 mol. % BaO. In embodiments, the composition may include greater than 0 mol. % and less than or equal to 2 mol. % BaO. In embodiments, the composition may include greater than 0 mol. % and less than or equal to 1.75 mol. % BaO. In embodiments, the composition may include greater than 0 mol. % and less than or equal to 1.5 mol. % BaO. In embodiments, the composition may include greater than or equal to 0.25 mol. % and less than or equal to 3 mol. % BaO. In embodiments, the composition may include greater than or equal to 0.25 mol. % and less than or equal to 2.75 mol. % BaO. In embodiments, the composition may include greater than or equal to 0.25 mol. % and less than or equal to 2.5 mol. % BaO. In embodiments, the composition may include greater than or equal to 0.25 mol. % and less than or equal to 2.25 mol. % BaO. In embodiments, the composition may include greater than or equal to 0.25 mol. % and less than or equal to 2 mol. % BaO. In embodiments, the composition may include greater than or equal to 0.25 mol. % and less than or equal to 1.75 mol. % BaO. In embodiments, the composition may include greater than or equal to 0.25 mol. % and less than or equal to 1.5 mol. % BaO. In embodiments, the composition may include greater than or equal to 0.5 mol. % and less than or equal to 3 mol. % BaO. In embodiments, the composition may include greater than or equal to 0.5 mol. % and less than or equal to 2.75 mol. % BaO. In embodiments, the composition may include greater than or equal to 0.5 mol. % and less than or equal to 2.5 mol. % BaO. In embodiments, the composition may include greater than or equal to 0.5 mol. % and less than or equal to 2.25 mol. % BaO. In embodiments, the composition may include greater than or equal to 0.5 mol. % and less than or equal to 2 mol. % BaO. In embodiments, the composition may include greater than or equal to 0.5 mol. % and less than or equal to 1.75 mol. % BaO. In embodiments, the composition may include greater than or equal to 0.5 mol. % and less than or equal to 1.5 mol. % BaO. In embodiments, the composition may include greater than or equal to 0.75 mol. % and less than or equal to 3 mol. % BaO. In embodiments, the composition may include greater than or equal to 0.75 mol. % and less than or equal to 2.75 mol. % BaO. In embodiments, the composition may include greater than or equal to 0.75 mol. % and less than or equal to 2.5 mol. % BaO. In embodiments, the composition may include greater than or equal to 0.75 mol. % and less than or equal to 2.25 mol. % BaO. In embodiments, the composition may include greater than or equal to 0.75 mol. % and less than or equal to 2 mol. % BaO. In embodiments, the composition may include greater than or equal to 0.75 mol. % and less than or equal to 1.75 mol. % BaO. In embodiments, the composition may include greater than or equal to 0.75 mol. % and less than or equal to 1.5 mol. % BaO. In embodiments, the composition may include greater than or equal to 1 mol. % and less than or equal to 3 mol. % BaO. In embodiments, the composition may include greater than or equal to 1 mol. % and less than or equal to 2.75 mol. % BaO. In embodiments, the composition may include greater than or equal to 1 mol. % and less than or equal to 2.5 mol. % BaO. In embodiments, the composition may include greater than or equal to 1 mol. % and less than or equal to 2.25 mol. % BaO. In embodiments, the composition may include greater than or equal to 1 mol. % and less than or equal to 2 mol. % BaO. In embodiments, the composition may include greater than or equal to 1 mol. % and less than or equal to 1.75 mol. % BaO. In embodiments, the composition may include greater than or equal to 1 mol. % and less than or equal to 1.5 mol. % BaO.

The compositions may further include ZnO as a modifier of the composition. Without intending to be bound by any particular theory, it is believed that additions of ZnO to the composition decrease the softening point and molding temperature of the composition, thereby offsetting the increase in the softening point and molding temperature of the composition due to SiO₂ in the composition. ZnO may also increase the stress after ion exchange, but decrease the diffusivity of alkali ions and slow ion exchange. Significantly, additions of ZnO do not increase the average coefficient of thermal expansion of the composition over the temperature range from 20° C. to 300° C. as much as some other modifiers (e.g., alkali oxides and/or the alkaline earth oxides CaO and SrO). As such, the benefit of using additions of ZnO to reduce the softening point and molding temperature can be maximized without a significant increase in the average coefficient of thermal expansion of the composition. In this regard, ZnO has a similar effect on the composition as MgO (e.g., it reduces the softening point and molding temperature of the composition without significantly increasing the average coefficient of thermal expansion). However, additions of ZnO to achieve these characteristics are favored over additions of MgO because ZnO has a more pronounced effect on the softening point and ZnO does not promote nucleation and crystallization in the glass as much as MgO.

In embodiments, the compositions may be substantially free of ZnO. In embodiments, the compositions may be free of ZnO. If the concentration of ZnO is too high the liquidus temperature may increase and the rate of ion exchange may decrease. In embodiments where the composition includes ZnO, the ZnO may be present in an amount greater than 0 mol. %, such as greater than or equal to 0.5 mol. %, and less than or equal to 4 mol. %. In embodiments including ZnO, the lower bound of the amount of ZnO in the compositions may be greater than or equal to 0.25 mol. %, greater than or equal to 0.5 mol. %, greater than or equal to 0.75 mol. %, greater or equal to 1 mol. %, greater than or equal to 1.25 mol. %, greater than or equal to 1.5 mol. %, greater than or equal to 1.75 mol. %, greater or equal to 2.0 mol. %, greater or equal to 2.25 mol. %, or even greater than or equal to 2.5 mol. %. In such embodiments, the upper bound of the amount of ZnO in the composition may be less than or equal to 4 mol. %, less than or equal to 3.75 mol. %, less than or equal to 3.5 mol. %, less than or equal to 3.25 mol. %, less than or equal to 3 mol. %, or even less than or equal to 2.75 mol. %. It should be understood that the amount of ZnO in the compositions may be within a range formed from any one of the lower bounds for ZnO and any one of the upper bounds of ZnO described herein.

For example and without limitation, the compositions may include ZnO in an amount greater than or equal to 0.5 mol. % and less than or equal to 4 mol. % ZnO. In embodiments, the composition may include greater than or equal to 0.5 mol. % and less than or equal to 3.75 mol. % ZnO. In embodiments, the composition may include greater than or equal to 0.5 mol. % and less than or equal to 3.5 mol. % ZnO. In embodiments, the composition may include greater than or equal to 0.5 mol. % and less than or equal to 3.25 mol. % ZnO. In embodiments, the composition may include greater than or equal to 0.5 mol. % and less than or equal to 3 mol. % ZnO. In embodiments, the composition may include greater than or equal to 0.5 mol. % and less than or equal to 2.75 mol. % ZnO. In embodiments, the composition may include greater than or equal to 0.75 mol. % and less than or equal to 4 mol. % ZnO. In embodiments, the composition may include greater than or equal to 1.0 mol. % and less than or equal to 4 mol. % ZnO. In embodiments, the composition may include greater than or equal to 1.25 mol. % and less than or equal to 4 mol. % ZnO. In embodiments, the composition may include greater than or equal to 1.5 mol. % and less than or equal to 4 mol. % ZnO. In embodiments, the composition may include greater than or equal to 1.75 mol. % and less than or equal to 4 mol. % ZnO. In embodiments, the composition may include greater than or equal to 2 mol. % and less than or equal to 4 mol. % ZnO. In embodiments, the composition may include greater than or equal to 2.25 mol. % and less than or equal to 4 mol. % ZnO. In embodiments, the composition may include greater than or equal to 2.5 mol. % and less than or equal to 4 mol. % ZnO. In embodiments, the composition may include greater than or equal to 0.5 mol. % and less than or equal to 2.5 mol. % ZnO.

The compositions may further include rare earth metal oxides (RE₂O₃). The rare earth metal may be selected from Sc, Y, La, Ce, Pr, Nd, Pm, Sm, Eu, Gd, Tb, Dy, Ho, Er, Tm, Yb, Lu, and combinations thereof. RE₂O₃ may increase the Young's modulus and stress after ion exchange, as well as increase the fracture toughness and density. However, RE₂O₃ may decrease alkali ion diffusivity and increase the liquidus temperature at high concentrations.

In embodiments, the compositions may be substantially free of RE₂O₃. In embodiments, the compositions may be free of RE₂O₃. In embodiments of the compositions that include RE₂O₃, the RE₂O₃ may be present in the composition in an amount greater than 0 mol. %. In such embodiments, the RE₂O₃ may be present in the composition in an amount less than or equal to 8 mol. %. Accordingly, in the embodiments in which RE₂O₃ is present, the compositions generally comprise RE₂O₃ in an amount greater than 0 mol. %, greater than or equal to 0.5 mol. %, greater than or equal to 1 mol. %, greater than or equal to 1.5 mol. %, greater than or equal to 2 mol. %, greater than or equal to 2.5 mol. %, greater than or equal to 3 mol. %, greater than or equal to 3.5 mol. %, or even greater than or equal to 4 mol. %. In embodiments, the upper bound of the amount of RE₂O₃ may be less than or equal to 8 mol. %, less than or equal to 7.5 mol. %, less than or equal to 7 mol. %, less than or equal to 6.5 mol. %, less than or equal to 6 mol. %, less than or equal to 5.5 mol. %, less than or equal to 5 mol. %, or even less than or equal to 4.5 mol. %. It should be understood that the amount of RE₂O₃ in the compositions may be within a range formed from any one of the lower bounds for RE₂O₃ and any one of the upper bounds of RE₂O₃ described herein.

For example and without limitation, the compositions having RE₂O₃ may include RE₂O₃ in an amount greater than 0 mol. % to less than or equal to 8 mol. %. In embodiments, the amount of RE₂O₃ in the composition is greater than 0 mol. % and less than or equal to 8 mol. %. In embodiments, the amount of RE₂O₃ in the composition is greater than 0 mol. % and less than or equal to 7.5 mol. %. In embodiments, the amount of RE₂O₃ in the composition is greater than or equal to 0.5 mol. % and less than or equal to 7 mol. %. In embodiments, the amount of RE₂O₃ in the composition is greater than 0 mol. % and less than or equal to 6.5 mol. %. In embodiments, the amount of RE₂O₃ in the composition is greater than 0 mol. % and less than or equal to 6 mol. %. In embodiments, the amount of RE₂O₃ in the composition is greater than 0 mol. % and less than or equal to 5.5 mol. %. In embodiments, the amount of RE₂O₃ in the composition is greater than 0 mol. % and less than or equal to 5 mol. %. In embodiments, the amount of RE₂O₃ in the composition is greater than 0 mol. % and less than or equal to 4.5 mol. %. In embodiments, the amount of RE₂O₃ in the composition is greater than or equal to 0.5 mol. % and less than or equal to 8 mol. %. In embodiments, the amount of RE₂O₃ in the composition is greater than or equal to 1 mol. % and less than or equal to 8 mol. %. In embodiments, the amount of RE₂O₃ in the composition is greater than or equal to 1.5 mol. % and less than or equal to 8 mol. %. In embodiments, the amount of RE₂O₃ in the composition is greater than or equal to 2 mol. % and less than or equal to 8 mol. %. In embodiments, the amount of RE₂O₃ in the composition is greater than or equal to 2.5 mol. % and less than or equal to 8 mol. %. In embodiments, the amount of RE₂O₃ in the composition is greater than or equal to 3 mol. % and less than or equal to 8 mol. %. In embodiments, the amount of RE₂O₃ in the composition is greater than or equal to 3.5 mol. % and less than or equal to 8 mol. %. In embodiments, the amount of RE₂O₃ in the composition is greater than or equal to 4 mol. % and less than or equal to 8 mol. %.

An exemplary RE₂O₃ is Y₂O₃. In embodiments, the compositions may be substantially free of Y₂O₃. In embodiments, the compositions may be free of Y₂O₃. In embodiments of the compositions that include Y₂O₃, the Y₂O₃ may be present in the composition in an amount greater than 0 mol. %. Y₂O₃ is the lightest of the RE₂O₃ oxides (except Sc₂O₃, which may be prohibitively expensive) and thus may increase the specific modulus more than any other of the RE₂O₃ oxides. Y₂O₃ may increase ion exchange stress and fracture toughness. It also does not typically impart any color to the glass, unlike the oxides of Ce, Pr, Nd, Pm, Sm, Eu, Tb, Dy, Ho, Er, and Tm. Y₂O₃ may also decrease the diffusivity of alkali ions and thus slow ion exchange rates. It may also raise the liquidus temperature at high concentrations and increases batch cost. In such embodiments, the Y₂O₃ may be present in the composition in an amount less than or equal to 7 mol. %. Accordingly, in the embodiments in which Y₂O₃ is present, the compositions generally comprise Y₂O₃ in an amount greater than 0 mol. %, greater than or equal to 0.5 mol. %, greater than or equal to 1 mol. %, greater than or equal to 1.5 mol. %, greater than or equal to 2 mol. %, greater than or equal to 2.5 mol. %, greater than or equal to 3 mol. %, or even greater than or equal to 3.5 mol. %. In embodiments, the upper bound of the amount of Y₂O₃ may be less than or equal to 7 mol. %, less than or equal to 6.5 mol. %, less than or equal to 6 mol. %, less than or equal to 5.5 mol. %, less than or equal to 5 mol. %, less than or equal to 4.5 mol. %, or even less than or equal to 4 mol. %. It should be understood that the amount of Y₂O₃ in the compositions may be within a range formed from any one of the lower bounds for Y₂O₃ and any one of the upper bounds of Y₂O₃ described herein.

For example and without limitation, the compositions having Y₂O₃ may include Y₂O₃ in an amount greater than 0 mol. % to less than or equal to 7 mol. %. In embodiments, the amount of Y₂O₃ in the composition is greater than 0 mol. % and less than or equal to 6.5 mol. %. In embodiments, the amount of Y₂O₃ in the composition is greater than 0 mol. % and less than or equal to 6 mol. %. In embodiments, the amount of Y₂O₃ in the composition is greater than 0 mol. % and less than or equal to 5.5 mol. %. In embodiments, the amount of Y₂O₃ in the composition is greater than 0 mol. % and less than or equal to 5 mol. %. In embodiments, the amount of Y₂O₃ in the composition is greater than 0 mol. % and less than or equal to 4.5 mol. %. In embodiments, the amount of Y₂O₃ in the composition is greater than 0 mol. % and less than or equal to 4 mol. %. In embodiments, the amount of Y₂O₃ in the composition is greater than or equal to 0.5 mol. % and less than or equal to 7 mol. %. In embodiments, the amount of Y₂O₃ in the composition is greater than or equal to 1 mol. % and less than or equal to 7 mol. %. In embodiments, the amount of Y₂O₃ in the composition is greater than or equal to 1.5 mol. % and less than or equal to 7 mol. %. In embodiments, the amount of Y₂O₃ in the composition is greater than or equal to 2 mol. % and less than or equal to 7 mol. %. In embodiments, the amount of Y₂O₃ in the composition is greater than or equal to 2.5 mol. % and less than or equal to 7 mol. %. In embodiments, the amount of Y₂O₃ in the composition is greater than or equal to 3 mol. % and less than or equal to 7 mol. %. In embodiments, the amount of Y₂O₃ in the composition is greater than or equal to 3.5 mol. % and less than or equal to 7 mol. %. In embodiments, the amount of Y₂O₃ in the composition is greater than or equal to 0.5 mol. % and less than or equal to 7 mol. %.

An exemplary RE₂O₃ is La₂O₃. In embodiments, the compositions may be substantially free of La₂O₃. In embodiments, the compositions may be free of La₂O₃. In embodiments of the compositions that include La₂O₃, the La₂O₃ may be present in the composition in an amount greater than 0 mol. %. In such embodiments, the La₂O₃ may be present in the composition in an amount less than or equal to 5 mol. %. La₂O₃ may increase ion exchange stress and fracture toughness, and it may help to suppress crystallization in small concentrations. It also does not typically impart any color to the glass, unlike the oxides of Ce, Pr, Nd, Pm, Sm, Eu, Tb, Dy, Ho, Er, and Tm. La₂O₃ may also decrease the diffusivity of alkali ions and thus slow ion exchange rates. It may also raise the liquidus temperature at high concentrations and increase batch cost. Accordingly, in the embodiments in which La₂O₃ is present, the compositions generally comprise La₂O₃ in an amount greater than 0 mol. %, greater than or equal to 0.25 mol. %, greater than or equal to 0.5 mol. %, greater than or equal to 0.75 mol. %, greater than or equal to 1 mol. %, greater than or equal to 1.25 mol. %, greater than or equal to 1.5 mol. %, greater than or equal to 1.75 mol. %, greater than or equal to 2 mol. %, greater than or equal to 2.25 mol. %, or even greater than or equal to 2.5 mol. %. In embodiments, the upper bound of the amount of La₂O₃ may be less than or equal to 5 mol. %, less than or equal to 4.75 mol. %, less than or equal to 4.5 mol. %, less than or equal to 4.25 mol. %, less than or equal to 4 mol. %, less than or equal to 3.75 mol. %, less than or equal to 3.5 mol. %, less than or equal to 3.25 mol. %, less than or equal to 3 mol. %, or even less than or equal to 2.75 mol. %. It should be understood that the amount of La₂O₃ in the compositions may be within a range formed from any one of the lower bounds for La₂O₃ and any one of the upper bounds of La₂O₃ described herein.

For example and without limitation, the compositions having La₂O₃ may include La₂O₃ in an amount greater than 0 mol. % to less than or equal to 5 mol. %. In embodiments, the amount of La₂O₃ in the composition is greater than 0 mol. % and less than or equal to 4.75 mol. %. In embodiments, the amount of La₂O₃ in the composition is greater than 0 mol. % and less than or equal to 4.5 mol. %. In embodiments, the amount of La₂O₃ in the composition is greater than 0 mol. % and less than or equal to 4.25 mol. %. In embodiments, the amount of La₂O₃ in the composition is greater than 0 mol. % and less than or equal to 4 mol. %. In embodiments, the amount of La₂O₃ in the composition is greater than 0 mol. % and less than or equal to 3.75 mol. %. In embodiments, the amount of La₂O₃ in the composition is greater than 0 mol. % and less than or equal to 3.5 mol. %. In embodiments, the amount of La₂O₃ in the composition is greater than 0 mol. % and less than or equal to 3.25 mol. %. In embodiments, the amount of La₂O₃ in the composition is greater than 0 mol. % and less than or equal to 3 mol. %. In embodiments, the amount of La₂O₃ in the composition is greater than 0 mol. % and less than or equal to 2.75 mol. %. In embodiments, the amount of La₂O₃ in the composition is greater than or equal to 0.25 mol. % and less than or equal to 5 mol. %. In embodiments, the amount of La₂O₃ in the composition is greater than or equal to 0.5 mol. % and less than or equal to 5 mol. %. In embodiments, the amount of La₂O₃ in the composition is greater than or equal to 0.75 mol. % and less than or equal to 5 mol. %. In embodiments, the amount of La₂O₃ in the composition is greater than or equal to 1 mol. % and less than or equal to 5 mol. %. In embodiments, the amount of La₂O₃ in the composition is greater than or equal to 1.25 mol. % and less than or equal to 5 mol. %. In embodiments, the amount of La₂O₃ in the composition is greater than or equal to 1.5 mol. % and less than or equal to 5 mol. %. In embodiments, the amount of La₂O₃ in the composition is greater than or equal to 1.75 mol. % and less than or equal to 5 mol. %. In embodiments, the amount of La₂O₃ in the composition is greater than or equal to 2 mol. % and less than or equal to 5 mol. %. In embodiments, the amount of La₂O₃ in the composition is greater than or equal to 2.25 mol. % and less than or equal to 5 mol. %. In embodiments, the amount of La₂O₃ in the composition is greater than or equal to 2.5 mol. % and less than or equal to 5 mol. %. In embodiments, the amount of La₂O₃ in the composition is greater than or equal to 0.5 mol. % and less than or equal to 2.5 mol. %.

Boron oxide (B₂O₃) is a glass former which may be added to the compositions to reduce the viscosity of the glass at a given temperature thereby improving the formability of the glass. Said differently, additions of B₂O₃ to the glass decrease the strain, anneal, softening, and molding temperatures of the composition, thereby improving the formability of the glass. As such, additions of B₂O₃ may be used to offset the decrease in formability of compositions having relatively higher amounts of SiO₂. B₂O₃ also helps to lower the liquidus temperature and suppress crystallization. However, it has been found that if the amount of B₂O₃ in the composition is too high, the diffusivity of alkali ions in the glass is low, the rate of ion exchange is decreased, and the stress achieved after ion exchange is decreased.

In embodiments, the compositions may be free of B₂O₃. In other embodiments, the compositions may be substantially free of B₂O₃. In other embodiments, the compositions may include B₂O₃ in a concentration greater than 0 mol. % to enhance the formability of the compositions, when present. The concentration of B₂O₃ may be less than or equal to 7 mol. % such that reasonable ion exchange times and satisfactory stress can be achieved after ion exchange. Accordingly, in the embodiments in which B₂O₃ is present, the compositions generally comprise B₂O₃ in an amount greater than 0 mol. % and less than or equal to 7 mol. %. In such embodiments, the lower bound of the amount of B₂O₃ in the composition may be greater than 0 mol. %, greater than or equal to 0.5 mol. %, greater than or equal to 1 mol. %, greater than or equal to 1.5 mol. %, greater than or equal to 2 mol. %, greater than or equal to 2.5 mol. %, greater than or equal to 3 mol. %, greater than or equal to 3.5 mol. %, or even greater than or equal to 4 mol. %. In embodiments, the upper bound of the amount of B₂O₃ in the compositions may be less than or equal to 7 mol. %, less than or equal to 6.5 mol. %, less than or equal to 6 mol. %, less than or equal to 5.5 mol. %, less than or equal to 5 mol. %, or even less than or equal to 4.5 mol. %. It should be understood that the amount of B₂O₃ in the compositions may be within a range formed from any one of the lower bounds for B₂O₃ and any one of the upper bounds of B₂O₃ described herein.

For example and without limitation, the compositions may include B₂O₃ in an amount greater than 0 mol. % and less than or equal to 7 mol. %. In embodiments, the amount of B₂O₃ in the composition is greater than or equal to 0.5 mol. % and less than or equal to 7 mol. %. In embodiments, the amount of B₂O₃ in the composition is greater than or equal to 1 mol. % and less than or equal to 7 mol. %. In embodiments, the amount of B₂O₃ in the composition is greater than or equal to 1.5 mol. % and less than or equal to 7 mol. %. In embodiments, the amount of B₂O₃ in the composition is greater than or equal to 2 mol. % and less than or equal to 7 mol. %. In embodiments, the amount of B₂O₃ in the composition is greater than or equal to 2.5 mol. % and less than or equal to 7 mol. %. In embodiments, the amount of B₂O₃ in the composition is greater than or equal to 3 mol. % and less than or equal to 7 mol. %. In embodiments, the amount of B₂O₃ in the composition is greater than or equal to 3.5 mol. % and less than or equal to 7 mol. %. In embodiments, the amount of B₂O₃ in the composition is greater than or equal to 4 mol. % and less than or equal to 7 mol. %. In embodiments, the amount of B₂O₃ in the composition is greater than 0 mol. % and less than or equal to 6.5 mol. %. In embodiments, the amount of B₂O₃ in the composition is greater than 0 mol. % and less than or equal to 6 mol. %. In embodiments, the amount of B₂O₃ in the composition is greater than 0 mol. % and less than or equal to 5.5 mol. %. In embodiments, the amount of B₂O₃ in the composition is greater than 0 mol. % and less than or equal to 5 mol. %. In embodiments, the amount of B₂O₃ in the composition is greater than 0 mol. % and less than or equal to 4.5 mol. %. In embodiments, the amount of B₂O₃ in the composition is greater than or equal to 1.5 mol. % and less than or equal to 5 mol. %.

The compositions may also include P₂O₅. Without intending to be bound by any particular theory, it is believed that P₂O₅ improves damage resistance and increases the rate of ion exchange. P₂O₅ may also lower the liquidus temperature, which improves the liquidus viscosity. In some embodiments, the addition of phosphorous to the glass creates a structure in which SiO₂ is replaced by tetrahedrally coordinated aluminum and phosphorus (AlPO₄) as a glass former.

In embodiments, the compositions may be free of P₂O₅. In other embodiments, the compositions may be substantially free of P₂O₅. In other embodiments, the compositions may include P₂O₅ in a concentration of greater than 0 mol. %. The compositions may include P₂O₅ in a concentration less than or equal to 5 mol. %, because if the P₂O₅ content is too high, the fracture toughness and stress achieved with ion exchange may be decreased. Accordingly, in the embodiments in which P₂O₅ is present, the compositions generally comprise P₂O₅ in an amount greater than 0 mol. % and less than or equal to 5 mol. %. In such embodiments, the lower bound of the amount of P₂O₅ in the composition may be greater than 0 mol. %, greater than or equal to 0.25 mol. %, greater than or equal to 0.5 mol. %, greater than or equal to 0.75 mol. %, greater than or equal to 1 mol. %, greater than or equal to 1.25 mol. %, greater than or equal to 1.5 mol. %, greater than or equal to 1.75 mol. %, or even greater than or equal to 2 mol. %. In embodiments, the upper bound of the amount of P₂O₅ in the compositions may be less than or equal to 4.75 mol. %, less than or equal to 4.5 mol. %, less than or equal to 4.25 mol. %, less than or equal to 4 mol. %, less than or equal to 3.75 mol. %, less than or equal to 3.5 mol. %, less than or equal to 3.25 mol. %, less than or equal to 3 mol. %, less than or equal to 2.75 mol. %, less than or equal to 2.5 mol. %, or even less than or equal to 2.25 mol. %. It should be understood that the amount of P₂O₅ in the compositions may be within a range formed from any one of the lower bounds for P₂O₅ and any one of the upper bounds of P₂O₅ described herein.

For example and without limitation, the compositions including P₂O₅ may include P₂O₅ in an amount greater than 0 mol. % and less than or equal to 5 mol. %. In embodiments, the amount of P₂O₅ in the composition is greater than or equal to 0.25 mol. % and less than or equal to 5 mol. %. In embodiments, the amount of P₂O₅ in the composition is greater than or equal to 0.5 mol. % and less than or equal to 5 mol. %. In embodiments, the amount of P₂O₅ in the composition is greater than or equal to 0.75 mol. % and less than or equal to 5 mol. %. In embodiments, the amount of P₂O₅ in the composition is greater than or equal to 1 mol. % and less than or equal to 5 mol. %. In embodiments, the amount of P₂O₅ in the composition is greater than or equal to 1.25 mol. % and less than or equal to 5 mol. %. In embodiments, the amount of P₂O₅ in the composition is greater than or equal to 1.5 mol. % and less than or equal to 5 mol. %. In embodiments, the amount of P₂O₅ in the composition is greater than or equal to 1.75 mol. % and less than or equal to 5 mol. %. In embodiments, the amount of P₂O₅ in the composition is greater than or equal to 2 mol. % and less than or equal to 5 mol. %. In embodiments, the amount of P₂O₅ in the composition is greater than 0 mol. % and less than or equal to 4.75 mol. %. In embodiments, the amount of P₂O₅ in the composition is greater than 0 mol. % and less than or equal to 4.5 mol. %. In embodiments, the amount of P₂O₅ in the composition is greater than 0 mol. % and less than or equal to 4.25 mol. %. In embodiments, the amount of P₂O₅ in the composition is greater than 0 mol. % and less than or equal to 4 mol. %. In embodiments, the amount of P₂O₅ in the composition is greater than 0 mol. % and less than or equal to 3.75 mol. %. In embodiments, the amount of P₂O₅ in the composition is greater than 0 mol. % and less than or equal to 3.5 mol. %. In embodiments, the amount of P₂O₅ in the composition is greater than 0 mol. % and less than or equal to 3.25 mol. %. In embodiments, the amount of P₂O₅ in the composition is greater than 0 mol. % and less than or equal to 3 mol. %. In embodiments, the amount of P₂O₅ in the composition is greater than 0 mol. % and less than or equal to 2.75 mol. %. In embodiments, the amount of P₂O₅ in the composition is greater than 0 mol. % and less than or equal to 2.5 mol. %. In embodiments, the amount of P₂O₅ in the composition is greater than 0 mol. % and less than or equal to 2.25 mol. %. In embodiments, the amount of P₂O₅ in the composition is greater than 1 mol. % and less than or equal to 3.5 mol. %.

In the embodiments, the compositions may be substantially free or free of other constituent components including, without limitation, Fe₂O₃, SnO₂, As₂O₃, Sb₂O₃, and PbO. In embodiments, the compositions may include small quantities of other constituent components including, without limitation, Fe₂O₃ and SnO₂. For example, the compositions including SnO₂ may include greater than 0 mol. % to 0.2 mol. % SnO₂. In the same or different embodiments, the compositions including Fe₂O₃ may include greater than 0 mol. % to 0.1 mol. % Fe₂O₃. Fe₂O₃ and SnO₂ can act as fining agents and help remove bubbles during melting and fining of the composition. Thus it may be beneficial to have one or more multivalent fining agents such as Fe₂O₃, SnO₂, CeO₂, or MnO₂ in the glass. In embodiments, SnO₂ may be used as a fining agent, and it may not impart any color to the glass. In embodiments, the composition may include greater than or equal to 0.05 mol. % and less than or equal to 0.15 mol. % SnO₂.

In embodiments, the composition may include various compositional relationships. For example, the concentrations of R₂O, R′O, Al₂O₃, Ta₂O₅, RE₂O₃, ZrO₂, and TiO₂ may be related as shown in relationship (III):

$$- 8 mol . \% \leq {R}_{2} O + {R}^{′} O - {Al}_{2} {O}_{3} - {T {a}_{2} O}_{5} + 1.5 * R {E}_{2} {O}_{3} - {ZrO}_{2} - {TiO}_{2} \leq 8 mol . \% \qquad ( III )$$

Without intending to be bound by any particular theory, it is believed that while R₂O, R′O and RE₂O₃ can create non-bridging oxygens in the glass network, Al₂O₃, Ta₂O₅, ZrO₂, and to a certain extent TiO₂, can act as intermediates and convert these non bridging oxygens back into bridging oxygens and increase the ion exchange rate and stress levels in the glass, as well as increase the elastic modulus and fracture toughness. If the quantity gets too high, however, then the glass may suffer from low ion exchange stress and fracture toughness. If the quantity gets too low, then the liquidus temperature of the glass can get too high and the glass stability may suffer. Therefore it is desirable to keep the quantity of relationship (VI) to within about 8 mol. % of 0. For instance, R₂O+R′O—Al₂O₃—Ta₂O₅ +1.5*RE₂O₃—ZrO₂—TiO₂ may range from greater than or equal to −7 mol. % to less than or equal to 7 mol. %. In embodiments, R₂O+R′O—Al₂O₃—Ta₂O₅ +1.5*RE₂O₃—ZrO₂—TiO₂ may range from greater than or equal to −6 mol. % to less than or equal to 6 mol. %. In embodiments, R₂O+R′O—Al₂O₃—Ta₂O₅ +1.5*RE₂O₃—ZrO₂—TiO₂ may range from greater than or equal to −5 mol. % to less than or equal to 5 mol. %. In embodiments, R₂O+R′O—Al₂O₃—Ta₂O₅ +1.5*RE₂O₃—ZrO₂—TiO₂ may range from greater than or equal to −4 mol. % to less than or equal to 4 mol. %. In embodiments, R₂O+R′O—Al₂O₃—Ta₂O₅ +1.5*RE₂O₃—ZrO₂—TiO₂ may range from greater than or equal to −3 mol. % to less than or equal to 3 mol. %. In embodiments, R₂O+R′O—Al₂O₃—Ta₂O₅ +1.5*RE₂O₃—ZrO₂—TiO₂ may range from greater than or equal to −2 mol. % to less than or equal to 2 mol. %. In embodiments, R₂O+R′O—Al₂O₃—Ta₂O₅ +1.5*RE₂O₃—ZrO₂—TiO₂ may range from greater than or equal to −1 mol. % to less than or equal to 1 mol. %. In embodiments, R₂O+R′O—Al₂O₃—Ta₂O₅ +1.5*RE₂O₃—ZrO₂—TiO₂ may range from greater than or equal to −8 mol. % to less than or equal to 5 mol. %. In embodiments, R₂O+R′O—Al₂O₃—Ta₂O₅ +1.5*RE₂O₃—ZrO₂—TiO₂ may range from greater than or equal to −7 mol. % to less than or equal to 5 mol. %. In embodiments, R₂O+R′O—Al₂O₃—Ta₂O₅ +1.5*RE₂O₃—ZrO₂—TiO₂ may range from greater than or equal to −6 mol. % to less than or equal to 5 mol. %. In embodiments, R₂O+R′O—Al₂O₃—Ta₂O₅ +1.5*RE₂O₃—ZrO₂—TiO₂ may be about 0 mol. %. R₂O+R′O—Al₂O₃—Ta₂O₅ +1.5*RE₂O₃—ZrO₂—TiO₂ may be within a range formed from any one of the lower bounds for the relationship and any one of the upper bounds for the relationship described herein.

In embodiments, the concentrations of R₂O, Al₂O₃, and Ta₂O₅ may be related as shown in relationship (IV):

$$- 12 mol . \% \leq {R}_{2} O - {Al}_{2} {O}_{3} - {T {a}_{2} O}_{5} \leq 6 mol . \% \qquad ( IV )$$

For instance, R₂O—Al₂O₃—Ta₂O₅ may range from greater than or equal to −11 mol. % to less than or equal to 5 mol. %. In embodiments, R₂O—Al₂O₃—Ta₂O₅ may range from greater than or equal to −10 mol. % to less than or equal to 4 mol. %. In embodiments, R₂O—Al₂O₃—Ta₂O₅ may range from greater than or equal to −9 mol. % to less than or equal to 3 mol. %. In embodiments, R₂O—Al₂O₃—Ta₂O₅ may range from greater than or equal to −8 mol. % to less than or equal to 2 mol. %. In embodiments, R₂O—Al₂O₃—Ta₂O₅ may range from greater than or equal to −7 mol. % to less than or equal to 1 mol. %. In embodiments, R₂O—Al₂O₃—Ta₂O₅ may range from greater than or equal to −6 mol. % to less than or equal to 0 mol. %. In embodiments, R₂O—Al₂O₃—Ta₂O₅ may range from greater than or equal to −5 mol. % to less than or equal to −1 mol. %. In embodiments, R₂O—Al₂O₃—Ta₂O₅ may range from greater than or equal to −4 mol. % to less than or equal to −2 mol. %. In embodiments, R₂O—Al₂O₃—Ta₂O₅ may be about-3 mol. %. It should be understood that R₂O—Al₂O₃—Ta₂O₅ may be within a range formed from any one of the lower bounds for the relationship and any one of the upper bounds for the relationship described herein. Without intending to be bound by any particular theory, it is believed that Al₂O₃ and Ta₂O₅ can coordinate with the alkali oxides to provide a glass structure that has both high fracture toughness and high alkali diffusivity for fast ion exchange and high stress after ion exchange.

In embodiments, the concentrations of R₂O, R′O, Al₂O₃, and Ta₂O₅ may be related as shown in relationship (V):

$$- 7 mol . \% \leq {R}_{2} O + {R}^{′} O - {Al}_{2} {O}_{3} - T {a}_{2} {O}_{5} \leq 9 mol . \% \qquad ( V )$$

For instance, R₂O+R′O—Al₂O₃—Ta₂O₅ may range from greater than or equal to −6 mol. % to less than or equal to 8 mol. %. In embodiments, R₂O+R′O—Al₂O₃—Ta₂O₅ may range from greater than or equal to −5 mol. % to less than or equal to 7 mol. %. In embodiments, R₂O+R′O—Al₂O₃—Ta₂O₅ may range from greater than or equal to −4 mol. % to less than or equal to 6 mol. %. In embodiments, R₂O+R′O—Al₂O₃—Ta₂O₅ may range from greater than or equal to −3 mol. % to less than or equal to 5 mol. %. In embodiments, R₂O+R′O—Al₂O₃—Ta₂O₅ may range from greater than or equal to −2 mol. % to less than or equal to 4 mol. %. In embodiments, R₂O+R′O—Al₂O₃—Ta₂O₅ may range from greater than or equal to −1 mol. % to less than or equal to 3 mol. %. In embodiments, R₂O+R′O—Al₂O₃—Ta₂O₅ may range from greater than or equal to 0 mol. % to less than or equal to 2 mol. %. In embodiments, R₂O+R′O Al₂O₃—Ta₂O₅ may be about 1 mol. %. It should be understood that R₂O+R′O—Al₂O₃—Ta₂O₅ may be within a range formed from any one of the lower bounds for the relationship and any one of the upper bounds for the relationship described herein. Without intending to be bound by any particular theory, it is believed that balancing the excess modifiers by keeping the quantity R₂O+R′O—Al₂O₃—Ta₂O₅ close to about 0 may improve ion exchange rate, ion exchange stress, and also may increase modulus and critical energy release rate.

In embodiments, the total amount of ZrO₂, TiO₂, and SnO₂ (i.e., ZrO₂ (mol. %)+TiO₂ (mol. %)+SnO₂ (mo. %)) may be in the range from greater than or equal to 0 mol. % to less than or equal to 2 mol. %, from greater than or equal to 0 mol % to less than or equal to 1.75 mol. %, from greater than or equal to 0 mol. % to less than or equal to 1.5 mol. %, greater than or equal to 0 mol. % to less than or equal to 1.25 mol. %, from greater than or equal to 0.25 mol. % to less than or equal to 2 mol. %, from greater than or equal to 0.25 mol % to less than or equal to 1.75 mol. %, from greater than or equal to 0.25 mol. % to less than or equal to 1.5 mol. %, greater than or equal to 0.25 mol. % to less than or equal to 1.25 mol. %, from greater than or equal to 0.5 mol. % to less than or equal to 2 mol. %, from greater than or equal to 0.5 mol % to less than or equal to 1.75 mol. %, from greater than or equal to 0.5 mol. % to less than or equal to 1.5 mol. %, greater than or equal to 0.5 mol. % to less than or equal to 1.25 mol. %, from greater than or equal to 0.75 mol. % to less than or equal to 2 mol. %, from greater than or equal to 0.75 mol % to less than or equal to 1.75 mol. %, from greater than or equal to 0.75 mol. % to less than or equal to 1.5 mol. %, greater than or equal to 0.75 mol. % to less than or equal to 1.25 mol. %, from greater than or equal to 1 mol. % to less than or equal to 2 mol. %, from greater than or equal to 1 mol % to less than or equal to 1.75 mol. %, from greater than or equal to 1 mol. % to less than or equal to 1.5 mol. %, or even greater than or equal to 1 mol. % to less than or equal to 1.25 mol. %. It should be understood that the the total amount of ZrO₂, TiO₂, and SnO₂ (i.e., ZrO₂ (mol. %)+TiO₂ (mol. %)+SnO₂ (mo. %)) may be within a range formed from any one of the lower bounds for the amount and any one of the upper bounds for the amount described herein.

In embodiments, the ratio of the amount of Li₂O (in mol. %) to the total amount of R₂O (in mol. %) may be in the range from greater than or equal to 0.5 to less than or equal to 1, from greater than or equal to 0.55 to less than or equal to 1, from greater than or equal to 0.6 to less than or equal to 1, from greater than or equal to 0.65 to less than or equal to 1, from greater than or equal to 0.7 to less than or equal to 1, from greater than or equal to 0.75 to less than or equal to 1, from greater than or equal to 0.8 to less than or equal to 1, from greater than or equal to 0.85 to less than or equal to 1, from greater than or equal to 0.9 to less than or equal to 1, or even from greater than or equal to 0.95 to less than or equal to 1. It should be understood that the relationship of the ratio of the amount of Li₂O (in mol. %) to the total amount of R₂₀ (in mol. %) may be within a range formed from any one of the lower bounds for the relationship and any one of the upper bounds for the relationship described herein. Without intending to be bound by any particular theory, it is believed that a high ratio of Li₂O to total R₂O may increase the elastic modulus and achievable ion exchange stress.

In embodiments, the concentrations of Li₂O, Al₂O₃, and Ta₂O₅ may be related as shown in relationship (VI):

$$0.4 \leq \frac{L {i}_{2} O}{( A {l}_{2} {O}_{3} + T {a}_{2} {O}_{5} )} \leq 1.5 \qquad ( VI )$$

For instance, the ratio of relationship (IX) may range from greater than or equal to 0.45 to less than or equal to 1.45, from greater than or equal to 0.5 to less than or equal to 1.4, from greater than or equal to 0.55 to less than or equal to 1.35, from greater than or equal to 0.6 to less than or equal to 1.3, from greater than or equal to 0.65 to less than or equal to 1.25, from greater than or equal to 0.7 to less than or equal to 1.2, from greater than or equal to 0.75 to less than or equal to 1.15, from greater than or equal to 0.8 to less than or equal to 1.1, from greater than or equal to 0.85 to less than or equal to 1.05, from greater than or equal to 0.9 to less than or equal to 1, or even equal to about 0.95. It should be understood that the ratio of relationship (IX) may be within a range formed from any one of the lower bounds for the relationship and any one of the upper bounds for the relationship described herein. Without intending to be bound by any particular theory, it is believed that Li₂O may be the primary ion for chemical strengthening in the described glasses. The highest stress and highest Na for Li diffusivity occurs when there is minimal Na₂O in the glass and when the Li₂O content is nearly fully compensated by Al₂O₃ or Ta₂O₅, where the ratio of Li₂O to (Al₂O₃+Ta₂O₅) will be close to 1. Thus it may be advantageous to have the ratio of Li₂O to (Al₂O₃+Ta₂O₅) greater than 0.4 and less than 1.5 or even greater than 0.75 and less than 1.25. When the ratio is less than 0.4 or greater than 1.5, it is believed that the ion exchange stress and rate will both suffer.

The compositions may be formed by mixing a batch of glass raw materials (e.g., powders of SiO₂, Al₂O₃, alkali carbonates, nitrates, or sulfates, alkaline earth carbonates, nitrates, sulfates, or oxides, and the like) such that the batch of glass raw materials has the desired composition. Common minerals such as spodumene and nepheline syenite may also be convenient sources of alkalis, alumina, and silica. Fining agents such as CeO₂, Fe₂O₃, and/or SnO₂ may also be added to aid in fining (bubble removal). Nitrates may also be added to fully oxidize the fining agents for optimal efficacy. Thereafter, the batch of glass raw materials may be heated to form a molten composition which is subsequently cooled and solidified to form a glass comprising the composition. During cooling (i.e., when the composition is plastically deformable) the glass comprising the composition may be shaped using standard forming techniques to shape the composition into a desired final form, providing a glass-based article comprising the composition. Alternatively, the glass article may be shaped into a stock form, such as a sheet, tube, or the like, and subsequently reheated and formed into the desired final form, such as by molding or the like.

From the above compositions, glass substrates according to embodiments may be formed by any suitable method, for example slot forming, float forming, rolling processes, down-draw processes, fusion forming processes, or updraw processes. The glass composition and the substrates produced therefrom may be characterized by the manner in which it may be formed. For instance, the glass composition may be characterized as float-formable (i.e., capable of being formed by a float process), down-drawable and, in particular, fusion-formable or slot-drawable (i.e., formed by a down draw process such as a fusion draw process or a slot draw process).

Some embodiments of the glass substrates described herein may be formed by a down-draw process. Down-draw processes produce glass substrates having a uniform thickness that possess relatively pristine surfaces. Because the average flexural strength of the glass substrate is controlled by the amount and size of surface flaws, a pristine surface that has had minimal contact has a higher initial strength. In addition, down drawn glass substrates have a very flat, smooth surface that can be used in its final application without costly grinding and polishing.

Some embodiments of the glass substrates described herein may be fusion-formable (i.e., formable using a fusion draw process). The fusion process uses a drawing tank that has a channel for accepting molten glass raw material. The channel has weirs that are open at the top along the length of the channel on both sides of the channel. When the channel fills with molten material, the molten glass overflows the weirs. Due to gravity, the molten glass flows down the outside surfaces of the drawing tank as two flowing glass films. These outside surfaces of the drawing tank extend down and inwardly so that they join at an edge below the drawing tank. The two flowing glass films join at this edge to fuse and form a single flowing glass substrate. The fusion draw method offers the advantage that, because the two glass films flowing over the channel fuse together, neither of the outside surfaces of the resulting glass substrate comes in contact with any part of the apparatus. Thus, the surface properties of the fusion drawn glass substrate are not affected by such contact.

Some embodiments of the glass substrates described herein may be formed by a slot draw process. The slot draw process is distinct from the fusion draw method. In slot draw processes, the molten raw material glass is provided to a drawing tank. The bottom of the drawing tank has an open slot with a nozzle that extends the length of the slot. The molten glass flows through the slot/nozzle and is drawn downward as a continuous glass substrate and into an annealing region.

Drawing processes for forming glass substrates, such as, for example, glass sheets, are desirable because they allow a thin glass substrate to be formed with few defects. It was previously thought that glass compositions were required to have relatively high liquidus viscosities—such as a liquidus viscosity greater than 1000 kP, greater than 1100 kP, or greater than 1200 kP—to be formed by a drawing process, such as, for example, fusion drawing or slot drawing. However, developments in drawing processes may allow glasses with lower liquidus viscosities to be used in drawing processes.

The glass-based articles described herein have relatively high fracture toughness and critical strain energy release rates, and can be ion exchanged to achieve parabolic stress profiles with relatively high central tension, such that the glass-based articles made from the compositions have enhanced drop performance relative to previously known articles.

In embodiments, the glass-based article described herein may have a fracture toughness K_{1C} of greater than or equal to 0.72 MPa√m. For example, the fracture toughness may be greater than or equal to 0.75 MPa√m, greater than or equal to 0.8 MPa√m, or even greater than or equal to 0.85 MPa√m. A high fracture toughness may beneficial to prevent the propagation of cracks and also increase the stored strain energy limit. High Al₂O₃, Ta₂O₅, and RE₂O₃ contents all contribute to increased fracture toughness while P₂O₅ lowers it, as described above.

In embodiments, the glass-based article described herein may have a critical strain energy release rate G_{1C} of greater than 7 J/m². For example, the critical strain energy release rate may be greater than or equal to 7.5 J/m², greater than or equal to 8 J/m², or even greater than or equal to 8.5 J/m². The critical strain energy release rate is the energy it takes to create new crack surfaces, so the higher that energy the more impact energy the glass can withstand before generating cracks. A higher critical strain energy release rate also means that more impact energy is dissipated per unit length of crack generated. Thus the higher the critical strain energy release rate, the better the drop performance for the same stress profile.

In embodiments, the glass-based article described herein may have a Young's modulus E of greater than 70 GPa. For example, the Young's modulus may be greater than or equal to 75 GPa, greater than or equal to 80 GPa, or even greater than or equal to 85 GPa. The higher the elastic modulus, the greater the stress generated by ion exchange and the stronger the compressive layer.

When strengthened by ion exchange, the glass-based articles described herein may have a compressive stress region extending from a first surface to a depth of compression. The glass based article may have a tensile stress region extending from the depth of compression on one side to the depth of compression on the other side. The tensile stress region may have a maximum CT greater than or equal to 175 MPa. In embodiments, this maximum CT may range from greater than or equal to 175 MPa to less than or equal to 600 MPa, from greater than or equal to 200 MPa to less than or equal to 575 MPa, from greater than or equal to 225 MPa to less than or equal to 550 MPa, from greater than or equal to 250 MPa to less than or equal to 525 MPa, from greater than or equal to 275 MPa to less than or equal to 500 MPa, from greater than or equal to 300 MPa to less than or equal to 475 MPa, from greater than or equal to 325 MPa to less than or equal to 450 MPa, from greater than or equal to 350 MPa to less than or equal to 425 MPa, from greater than or equal to 250 MPa to less than or equal to 325 MPa, or even from greater than or equal to 375 MPa to less than or equal to 400 MPa. It should be understood that the maximum CT may be within a range formed from any one of the lower bounds for the maximum CT and any one of the upper bounds for the maximum CT described herein.

When strengthened by ion exchange, the glass-based articles described herein may have a stored strain energy of greater than 20 J/m². For example, the stored strain energy may be greater than or equal to 30 J/m², greater than or equal to 40 J/m², greater than or equal to 50 J/m², greater than or equal to 60 J/m², greater than or equal to 70 J/m², greater than or equal to 80 J/m², greater than or equal to 90 J/m², greater than or equal to 100 J/m², greater than or equal to 200 J/m², greater than or equal to 300 J/m², greater than or equal to 400 J/m², or even greater than or equal to 500 J/m².

When strengthened by ion exchange, the tensile stress region may have a maximum CT greater than or equal to 175 MPa and the glass-based article may comprise a critical strain energy release rate G_{1C} greater than or equal to 7 J/m². For example, the maximum CT may range from greater than or equal to 175 MPa to less than or equal to 600 MPa, from greater than or equal to 200 MPa to less than or equal to 575 MPa, from greater than or equal to 225 MPa to less than or equal to 550 MPa, from greater than or equal to 250 MPa to less than or equal to 525 MPa, from greater than or equal to 275 MPa to less than or equal to 500 MPa, from greater than or equal to 300 MPa to less than or equal to 475 MPa, from greater than or equal to 325 MPa to less than or equal to 450 MPa, from greater than or equal to 350 MPa to less than or equal to 425 MPa, or even from greater than or equal to 375 MPa to less than or equal to 400 MPa. Also, the critical strain energy release rate may be greater than or equal to 7.5 J/m² or even greater than or equal to 8 J/m².

In the same or different embodiments, an arithmetic product of the critical strain energy release rate and the maximum CT (G_{1C}×CT) may be greater than or equal to 1450 MPa·J/m², greater than or equal to 2000 MPa·J/m², greater than or equal to 2500 MPa·J/m², greater than or equal to 3000 MPa·J/m², greater than or equal to 3500 MPa·J/m², greater than or equal to 4000 MPa·J/m², or even greater than or equal to 4100 MPa·J/m².

When strengthened by ion exchange, the tensile stress region may have a maximum CT greater than or equal to 175 MPa and the glass-based article may comprise a fracture toughness K_{1C} greater than or equal to 0.7 MPa√m. For example, the maximum CT may range from greater than or equal to 175 MPa to less than or equal to 600 MPa, from greater than or equal to 200 MPa to less than or equal to 575 MPa, from greater than or equal to 225 MPa to less than or equal to 550 MPa, from greater than or equal to 250 MPa to less than or equal to 525 MPa, from greater than or equal to 275 MPa to less than or equal to 500 MPa, from greater than or equal to 300 MPa to less than or equal to 475 MPa, from greater than or equal to 325 MPa to less than or equal to 450 MPa, from greater than or equal to 350 MPa to less than or equal to 425 MPa, or even from greater than or equal to 375 MPa to less than or equal to 400 MPa. Also, the fracture toughness may be greater than or equal to 0.75 MPa√m or even greater than or equal to 0.8 MPa√m.

In the same or different embodiments, an arithmetic product of the fracture toughness and the maximum CT (K_{1C}×CT) may be greater than or equal to 150 MPa²√m, greater than or equal to 200 MPa²√m, greater than or equal to 250 MPa²√m, greater than or equal to 300 MPa²√m, greater than or equal to 350 MPa²√m, greater than or equal to 400 MPa²√m, or even greater than or equal to 450 MPa²√m. In general, the glass-based article will exhibit better fracture resistance and drop performance as the K_{1C}×CT increases.

In embodiments, the glass-based article is strengthened by ion exchange and the glass-based article comprises a compressive stress region extending from the first surface to a depth of compression and a region of balancing tension in the middle. The tensile stress region may have a maximum CT greater than or equal to 175 MPa and the glass-based article may comprise at least one ion strengthening ion having a mutual diffusivity D into the glass-based article at a temperature of 390° C. of between 300 μm²/hour and 1500 μm²/hour or even between 100 μm²/hour and 3000 μm²/hour. The tensile stress region may have a maximum CT greater than or equal to 175 MPa, and the glass-based article may comprise at least one strengthening ion having a mutual diffusivity D into the glass-based article at a temperature of 430° C. of between 800 μm²/hour and 3500 μm²/hour or even between 100 μm²/hour and 3000 μm²/hour. For example, the diffusivity D may range from greater than or equal to 300 μm²/hour to less than or equal to 3500 μm²/hour, from greater than or equal to 400 μm²/hour to less than or equal to 3000 μm²/hour, from greater than or equal to 500 μm²/hour to less than or equal to 2500 μm²/hour, from greater than or equal to 600 μm²/hour to less than or equal to 2000 μm²/hour, from greater than or equal to 700 μm²/hour to less than or equal to 1800 μm²/hour, from greater than or equal to 800 μm²/hour to less than or equal to 1600 μm²/hour, from greater than or equal to 900 μm²/hour to less than or equal to 1600 μm²/hour, from greater than or equal to 1000 μm²/hour to less than or equal to 2000 μm²/hour, from greater than or equal to 500 μm²/hour to less than or equal to 1500 μm²/hour, from greater than or equal to 100 μm²/hour to less than or equal to 5000 μm²/hour, from greater than or equal to 100 μm²/hour to less than or equal to 4000 μm²/hour, from greater than or equal to 100 μm²/hour to less than or equal to 3000 μm²/hour, from greater than or equal to 100 μm²/hour to less than or equal to 2000 μm²/hour, from greater than or equal to 100 μm²/hour to less than or equal to 1500 μm²/hour, from greater than or equal to 200 μm²/hour to less than or equal to 5000 μm²/hour, from greater than or equal to 200 μm²/hour to less than or equal to 4000 μm²/hour, from greater than or equal to 200 μm²/hour to less than or equal to 3000 μm²/hour, from greater than or equal to 200 μm²/hour to less than or equal to 2000 μm²/hour, from greater than or equal to 200 μm²/hour to less than or equal to 1500 μm²/hour, from greater than or equal to 500 μm²/hour to less than or equal to 5000 μm²/hour, from greater than or equal to 500 μm²/hour to less than or equal to 4000 μm²/hour, from greater than or equal to 500 μm²/hour to less than or equal to 3000 μm²/hour, from greater than or equal to 500 μm²/hour to less than or equal to 2000 μm²/hour, from greater than or equal to 500 μm²/hour to less than or equal to 1500 μm²/hour, from greater than or equal to 1000 μm²/hour to less than or equal to 5000 μm²/hour, from greater than or equal to 1000 μm²/hour to less than or equal to 4000 μm²/hour, from greater than or equal to 1000 μm²/hour to less than or equal to 3000 μm²/hour, from greater than or equal to 1000 μm²/hour to less than or equal to 2000 μm²/hour, or even from greater than or equal to 1000 μm²/hour to less than or equal to 1500 μm²/hour. It should be understood that the diffusivity may be within a range formed from any one of the lower bounds for diffusivity and any one of the upper bounds for the diffusivity described herein.

In the same or different embodiments, the arithmetic product of the maximum CT and the diffusivity may be greater than or equal to 50,000 MPa μm²/hour, or greater than or equal to 60,000 MPa μm²/hour, or greater than or equal to 70,000 MPa μm²/hour, or greater than or equal to 80,000 MPa μm²/hour, or greater than or equal to 90,000 MPa μm²/hour, or greater than or equal to 100,000 MPa μm²/hour, or greater than or equal to 200,000 MPa μm²/hour, or greater than or equal to 400,000 MPa μm²/hour, or greater than or equal to 600,000 MPa μm²/hour, or greater than or equal to 800,000 MPa μm²/hour, or greater than or equal to 1,000,000 MPa μm²/hour, or greater than or equal to 1,200,000 MPa μm²/hour, or even greater than or equal to 1,400,000 MPa μm²/hour. Without intending to be bound by any particular theory, it is believed that a high diffusivity may be desirable for faster ion exchange and greater throughput. However, the high diffusivity could potentially be associated with lower CT. Thus, it is believed that the arithmetic product of the maximum CT and the diffusivity provides an indication of merit for cost and performance.

In embodiments, the glass-based article may comprise a composition comprising SiO₂, Li₂O, Ta₂O₅, and Al₂O₃. The Al₂O₃ content may be greater than or equal to 16 mol. %. The glass-based article may be strengthened by ion exchange and the glass-based article may comprise a compressive stress region extending from a first surface of the glass-based article to a depth of compression, and a tensile stress region extending from the depth of compression toward a second surface opposite the first surface. This tensile stress region may have a maximum central tension greater than or equal to 160 MPa. For example, the Al₂O₃ content may be greater than or equal to 18 mol. % or even greater than or equal to 20 mol. %.

### Examples

The embodiments described herein will be further clarified by the following examples.

The compositions were formed by mixing a batch of glass raw materials (e.g., powders of SiO₂, Al₂O₃, alkali carbonates, nitrates, or sulfates, alkaline earth carbonates, nitrates, sulfates, or oxides, and the like, as provided in Tables 1A-1U) such that the batch of glass raw materials has the desired composition. Thereafter, the batch of glass raw materials were heated to form a molten composition and then poured into a bucket of water to create cullet. This cullet was then remelted at a slightly higher temperature to remove bubbles. This double melting procedure improves the quality and homogeneity of the resulting glass for laboratory scale melting. The molten glass was then poured onto a steel table and allowed to set before it was placed in an annealer at approximately the anneal point of the glass to remove stress. The glass was then cooled to room temperature and cut and polished into samples for measurement.

TABLE 1A

| Sample/mol % | 1 | 2 | 3 | 4 | 5 | 6 | 7 |
|---|---|---|---|---|---|---|---|
| SiO₂ | 58.811 | 67.679 | 60.260 | 60.410 | 62.196 | 63.894 | 68.640 |
| Al₂O₃ | 19.113 | 9.445 | 17.106 | 19.295 | 16.417 | 16.760 | 17.076 |
| B₂O₃ | 6.022 | 3.979 | 6.829 | 3.996 | 5.094 | 3.053 | |
| P₂O₅ | | 0.003 | 0.027 | | | | |
| Li₂O | 15.921 | 13.682 | 8.280 | 11.748 | 7.999 | 7.991 | 9.904 |
| Na₂O | 0.017 | 0.088 | 2.365 | 1.386 | 0.990 | 1.010 | 1.054 |
| K₂O | | 0.027 | 0.032 | 0.036 | 0.003 | 0.004 | 0.026 |
| MgO | 0.016 | 0.027 | 1.005 | 0.035 | 2.521 | 1.001 | 0.028 |
| CaO | 0.011 | 0.049 | 0.046 | 0.027 | 0.514 | 1.019 | 0.025 |
| SrO | | | | | 0.018 | 0.008 | |
| SnO₂ | 0.074 | 0.074 | 0.071 | 0.072 | 0.102 | 0.106 | 0.067 |
| ZrO₂ | | 0.001 | | | | | |
| TiO₂ | | 0.006 | 0.007 | | 0.504 | 0.509 | 0.009 |
| Fe₂O₃ | | 0.016 | 0.020 | 0.021 | 0.006 | 0.006 | 0.016 |
| ZnO | | | | | | 1.010 | |
| Ta₂O₅ | | 4.912 | | | | | |
| Y₂O₃ | | | 3.945 | 2.967 | 3.622 | 1.836 | 3.147 |
| La₂O₃ | | | | 0.001 | | 1.785 | |
| R₂O | 15.937 | 13.797 | 10.677 | 13.170 | 8.991 | 9.005 | 10.984 |
| RO | 0.027 | 0.077 | 1.051 | 0.062 | 3.053 | 2.027 | 0.052 |
| R₂O + R′O − | −3.149 | −0.490 | 0.532 | −1.612 | 0.556 | −0.805 | −1.329 |
| Al₂O₃ − | | | | | | | |
| Ta₂O₅ + | | | | | | | |
| 1.5*RE₂O₃ − | | | | | | | |
| ZrO₂ − TiO₂ | | | | | | | |
| R₂O − Al₂O₃ - | −3.176 | −0.560 | −6.428 | −6.125 | −7.426 | −7.755 | −6.092 |
| Ta₂O₅ | | | | | | | |
| R₂O + R′O − | −3.149 | −0.484 | −5.378 | −6.062 | −4.373 | −5.728 | −6.040 |
| Al₂O₃ − Ta₂O₅ | | | | | | | |
| Li₂O/R₂O | 0.999 | 0.992 | 0.775 | 0.892 | 0.890 | 0.887 | 0.902 |
| Li₂O/(Al₂O₃ + | 0.833 | 0.953 | 0.484 | 0.609 | 0.487 | 0.477 | 0.580 |
| Ta₂O₅) | | | | | | | |

TABLE 1B

| Sample/mol % | 8 | 9 | 10 | 11 | 12 | 13 | 14 |
|---|---|---|---|---|---|---|---|
| SiO₂ | 55.127 | 65.378 | 69.769 | 67.304 | 67.430 | 62.137 | 67.480 |
| Al₂O₃ | 22.344 | 17.318 | 16.433 | 17.740 | 17.250 | 16.478 | 17.763 |
| B₂O₃ | 6.096 | 1.996 | | | | 5.089 | |
| P₂O₅ | | | | | | | |
| Li₂O | 16.320 | 9.537 | 9.600 | 9.446 | 9.564 | 8.009 | 10.221 |
| Na₂O | | 2.308 | 1.003 | 2.060 | 2.307 | 0.975 | 1.085 |
| K₂O | | 0.026 | 0.025 | 0.027 | 0.026 | 0.004 | 0.026 |
| MgO | 0.023 | 0.028 | 0.024 | 0.026 | 0.028 | 2.530 | 0.028 |
| CaO | 0.010 | 0.024 | 0.023 | 0.024 | 0.024 | 0.516 | 0.025 |
| SrO | | | | | | 0.008 | |
| SnO₂ | 0.075 | 0.073 | 0.063 | 0.069 | 0.069 | 0.108 | 0.070 |
| ZrO₂ | | | | | | | |
| TiO₂ | | 0.008 | 0.008 | 0.009 | 0.009 | 0.510 | 0.008 |
| Fe₂O₃ | | 0.016 | 0.016 | 0.017 | 0.017 | 0.006 | 0.017 |
| ZnO | | | | | | 0.001 | |
| Ta₂O₅ | | | | | | | |
| Y₂O₃ | | 3.279 | 3.029 | 3.271 | 3.269 | 1.841 | 3.271 |
| La₂O₃ | | | | | | 1.780 | |
| R₂O | 16.320 | 11.871 | 10.628 | 11.532 | 11.896 | 8.988 | 11.332 |
| RO | 0.033 | 0.052 | 0.048 | 0.050 | 0.052 | 3.054 | 0.053 |
| R₂O + R′O − | −5.991 | −0.485 | −1.223 | −1.260 | −0.408 | 0.487 | −1.480 |
| Al₂O₃ − Ta₂O₅ + | | | | | | | |
| 1.5*RE₂O₃ − | | | | | | | |
| ZrO₂ − TiO₂ | | | | | | | |
| R₂O − Al₂O₃ − | −6.024 | −5.447 | −5.806 | −6.208 | −5.354 | −7.489 | −6.430 |
| Ta₂O₅ | | | | | | | |
| R₂O + R′O − | −5.991 | −5.395 | −5.758 | −6.158 | −5.302 | −4.436 | −6.378 |
| Al₂O₃ − Ta₂O₅ | | | | | | | |
| Li₂O/R₂O | 1.000 | 0.803 | 0.903 | 0.819 | 0.804 | 0.891 | 0.902 |
| Li₂O/(Al₂O₃ + | 0.730 | 0.551 | 0.584 | 0.532 | 0.554 | 0.486 | 0.575 |
| Ta₂O₅) | | | | | | | |

TABLE 1C

| Sample/mol % | 15 | 16 | 17 | 18 | 19 | 20 | 21 |
|---|---|---|---|---|---|---|---|
| SiO₂ | 61.987 | 62.298 | 60.710 | 64.320 | 60.039 | 62.075 | 64.220 |
| Al₂O₃ | 19.915 | 19.332 | 19.301 | 19.357 | 19.799 | 20.251 | 19.403 |
| B₂O₃ | | 1.969 | 2.434 | | 3.864 | | |
| P₂O₅ | | | | | 0.025 | | |
| Li₂O | 12.035 | 11.844 | 11.535 | 11.764 | 15.871 | 13.992 | 11.811 |
| Na₂O | 1.876 | 1.389 | 1.674 | 1.387 | 0.171 | 1.871 | 1.369 |
| K₂O | 0.038 | 0.036 | 0.057 | 0.036 | 0.039 | 0.039 | 0.035 |
| MgO | 3.966 | 0.038 | 0.039 | 0.031 | 0.029 | 0.030 | 0.032 |
| CaO | 0.071 | 0.026 | 0.037 | 0.029 | 0.050 | 0.049 | 0.030 |
| SrO | | | | | | | |
| SnO₂ | 0.080 | 0.072 | 0.071 | 0.072 | 0.079 | 0.075 | 0.077 |
| ZrO₂ | | | | | | | |
| TiO₂ | | | | | | | |
| Fe₂O₃ | 0.025 | 0.021 | 0.030 | 0.021 | 0.024 | 0.023 | 0.022 |
| ZnO | | | | | | | |
| Ta₂O₅ | | | | | | | |
| Y₂O₃ | 0.001 | 2.966 | 4.102 | 2.974 | | 1.587 | 2.008 |
| La₂O₃ | | 0.001 | | 0.001 | | | 0.984 |
| R₂O | 13.949 | 13.269 | 13.267 | 13.186 | 16.081 | 15.901 | 13.216 |
| RO | 4.037 | 0.064 | 0.077 | 0.060 | 0.079 | 0.079 | 0.062 |
| R₂O + R′O − | −1.928 | −1.548 | 0.195 | −1.647 | −3.638 | −1.889 | −1.638 |
| Al₂O₃ − Ta₂O₅ + | | | | | | | |
| 1.5*RE₂O₃ − | | | | | | | |
| ZrO₂ − TiO₂ | | | | | | | |
| R₂O − Al₂O₃ − | −5.966 | −6.062 | −6.034 | −6.170 | −3.717 | −4.349 | −6.188 |
| Ta₂O₅ | | | | | | | |
| R₂O + R′O − | −1.929 | −5.998 | −5.958 | −6.110 | −3.638 | −4.270 | −6.126 |
| Al₂O₃ − Ta₂O₅ | | | | | | | |
| Li₂O/R₂O | 0.863 | 0.893 | 0.869 | 0.892 | 0.987 | 0.880 | 0.894 |
| Li₂O/(Al₂O₃ + | 0.604 | 0.613 | 0.598 | 0.608 | 0.802 | 0.691 | 0.609 |
| Ta₂O₅) | | | | | | | |

TABLE 1D

| Sample/mol % | 22 | 23 | 24 | 25 | 26 | 27 | 28 |
|---|---|---|---|---|---|---|---|
| SiO₂ | 62.207 | 66.498 | 67.985 | 62.259 | 63.276 | 62.016 | 65.005 |
| Al₂O₃ | 20.615 | 18.838 | 8.530 | 19.915 | 18.482 | 19.883 | 19.149 |
| B₂O₃ | | | | | 1.925 | | |
| P₂O₅ | | | 0.007 | | | | |
| Li₂O | 11.969 | 8.562 | 15.657 | 15.471 | 11.250 | 14.026 | 11.383 |
| Na₂O | 1.848 | 0.092 | 0.106 | 0.147 | 0.724 | 1.875 | 0.134 |
| K₂O | 0.040 | 0.042 | 0.038 | 0.047 | 0.058 | 0.039 | 0.041 |
| MgO | 0.031 | 0.032 | 0.036 | 2.000 | 0.030 | 1.993 | 0.030 |
| CaO | 0.049 | 0.034 | 0.060 | 0.045 | 0.040 | 0.058 | 0.035 |
| SrO | | | | | | | |
| SnO₂ | 0.070 | 0.069 | 0.074 | 0.078 | 0.067 | 0.077 | 0.069 |
| ZrO₂ | | | 0.995 | | | | |
| TiO₂ | | 0.005 | 0.007 | 0.004 | | | |
| Fe₂O₃ | 0.023 | 0.023 | 0.021 | 0.027 | 0.028 | 0.024 | 0.022 |
| ZnO | | | | | | | |
| Ta₂O₅ | | | 6.473 | | | | |
| Y₂O₃ | 3.138 | 5.788 | | | 4.111 | 0.001 | 4.122 |
| La₂O₃ | | | | | | | |
| R₂O | 13.856 | 8.696 | 15.800 | 15.665 | 12.032 | 15.940 | 11.558 |
| RO | 0.081 | 0.065 | 0.096 | 2.045 | 0.070 | 2.052 | 0.065 |
| R₂O + R′O − | −1.972 | −1.400 | −0.109 | −2.209 | −0.214 | −1.891 | −1.344 |
| Al₂O₃ − Ta₂O₅ + | | | | | | | |
| 1.5*RE₂O₃ − | | | | | | | |
| ZrO₂ − TiO₂ | | | | | | | |
| R₂O − Al₂O₃ − | −6.759 | −10.142 | 0.797 | −4.250 | −6.450 | −3.944 | −7.591 |
| Ta₂O₅ | | | | | | | |
| R₂O + R′O − | −6.679 | −10.077 | 0.893 | −2.205 | −6.380 | −1.892 | −7.526 |
| Al₂O₃ − Ta₂O₅ | | | | | | | |
| Li₂O/R₂O | 0.864 | 0.985 | 0.991 | 0.988 | 0.935 | 0.880 | 0.985 |
| Li₂O/(Al₂O₃ + | 0.581 | 0.455 | 1.044 | 0.777 | 0.609 | 0.705 | 0.594 |
| Ta₂O₅) | | | | | | | |

TABLE 1E

| Sample/mol % | 29 | 30 | 31 | 32 | 33 | 34 | 35 |
|---|---|---|---|---|---|---|---|
| SiO₂ | 64.873 | 65.670 | 64.170 | 62.747 | 63.393 | 64.737 | 62.114 |
| Al₂O₃ | 12.941 | 19.068 | 19.451 | 19.158 | 20.823 | 17.942 | 20.443 |
| B₂O₃ | 5.952 | | | | | | |
| P₂O₅ | | | | | 0.029 | | |
| Li₂O | 16.128 | 10.281 | 11.811 | 12.038 | 15.377 | 11.087 | 12.990 |
| Na₂O | 0.001 | 0.101 | 1.367 | 1.700 | 0.144 | 1.559 | 1.862 |
| K₂O | 0.001 | 0.043 | 0.036 | 0.059 | 0.043 | 0.044 | 0.040 |
| MgO | 0.012 | 0.034 | 0.025 | 0.030 | 0.030 | 2.089 | 0.029 |
| CaO | 0.011 | 0.034 | 0.031 | 0.040 | 0.051 | 0.060 | 0.050 |
| SrO | | | | | | | |
| SnO₂ | 0.076 | 0.068 | 0.078 | 0.069 | 0.078 | 0.097 | 0.071 |
| ZrO₂ | | | | | | | |
| TiO₂ | | 0.005 | | | | | |
| Fe₂O₃ | | 0.022 | 0.022 | 0.029 | 0.024 | 0.026 | 0.023 |
| ZnO | | | | | | | |
| Ta₂O₅ | | | | | | | |
| Y₂O₃ | | 4.655 | 1.022 | 4.115 | | 2.351 | 2.368 |
| La₂O₃ | | | 1.979 | | | | |
| R₂O | 16.130 | 10.425 | 13.214 | 13.797 | 15.565 | 12.690 | 14.893 |
| RO | 0.023 | 0.068 | 0.056 | 0.070 | 0.081 | 2.148 | 0.079 |
| R₂O + R′O − | 3.212 | −1.597 | −1.680 | 0.882 | −5.177 | 0.423 | −1.919 |
| Al₂O₃ − Ta₂O₅ + | | | | | | | |
| 1.5*RE₂O₃ − | | | | | | | |
| ZrO₂ − TiO₂ | | | | | | | |
| R₂O−Al₂O₃ − | 3.188 | −8.643 | −6.237 | −5.360 | −5.258 | −5.252 | −5.550 |
| Ta₂O₅ | | | | | | | |
| R₂O + R′O − | 3.212 | −8.575 | −6.182 | −5.290 | −5.177 | −3.104 | −5.471 |
| Al₂O₃ − Ta₂O₅ | | | | | | | |
| Li₂O/R₂O | 1.000 | 0.986 | 0.894 | 0.872 | 0.988 | 0.874 | 0.872 |
| Li₂O/(Al₂O₃ + | 1.246 | 0.539 | 0.607 | 0.628 | 0.738 | 0.618 | 0.635 |
| Ta₂O₅) | | | | | | | |

TABLE 1F

| Sample/mol % | 36 | 37 | 38 | 39 | 40 | 41 | 42 |
|---|---|---|---|---|---|---|---|
| SiO₂ | 62.309 | 67.172 | 59.972 | 62.144 | 66.226 | 64.902 | 67.716 |
| Al₂O₃ | 17.952 | 17.866 | 19.784 | 19.928 | 16.015 | 19.307 | 10.551 |
| B₂O₃ | 2.024 | | | | 2.004 | | |
| P₂O₅ | 1.948 | | 0.025 | | 0.026 | | 0.006 |
| Li₂O | 15.372 | 11.359 | 15.845 | 15.595 | 15.336 | 11.940 | 15.575 |
| Na₂O | 0.177 | 0.128 | 0.163 | 2.107 | 0.176 | 0.111 | 0.109 |
| K₂O | 0.040 | 0.036 | 0.040 | 0.048 | 0.039 | 0.041 | 0.038 |
| MgO | 0.024 | 0.023 | 3.989 | 0.029 | 0.022 | 0.032 | 0.031 |
| CaO | 0.048 | 0.034 | 0.073 | 0.032 | 0.047 | 0.034 | 0.056 |
| SrO | | | | | | | |
| SnO₂ | 0.076 | 0.065 | 0.077 | 0.079 | 0.077 | 0.072 | 0.074 |
| ZrO₂ | | | | | | | 0.001 |
| TiO₂ | | | | 0.005 | | 0.005 | 0.005 |
| Fe₂O₃ | 0.024 | 0.021 | 0.025 | 0.026 | 0.024 | 0.023 | 0.021 |
| ZnO | | | | | | | |
| Ta₂O₅ | | | | | | | 5.806 |
| Y₂O₃ | | 3.275 | | | | 3.520 | |
| La₂O₃ | | | | | | | |
| R₂O | 15.589 | 11.524 | 16.047 | 17.750 | 15.552 | 12.091 | 15.722 |
| RO | 0.072 | 0.056 | 4.063 | 0.061 | 0.069 | 0.066 | 0.086 |
| R₂O + R′O − | −2.291 | −1.373 | 0.326 | −2.122 | −0.394 | −1.875 | −0.555 |
| Al₂O₃ − Ta₂O₅ + | | | | | | | |
| 1.5*RE₂O₃ − | | | | | | | |
| ZrO₂ − TiO₂ | | | | | | | |
| R₂O − Al₂O₃ − | −2.363 | −6.342 | −3.737 | −2.178 | −0.463 | −7.216 | −0.635 |
| Ta₂O₅ | | | | | | | |
| R₂O + R′O − | −2.291 | −6.286 | 0.326 | −2.117 | −0.394 | −7.150 | −0.549 |
| Al₂O₃ − Ta₂O₅ | | | | | | | |
| Li₂O/R₂O | 0.986 | 0.986 | 0.987 | 0.879 | 0.986 | 0.988 | 0.991 |
| Li₂O/(Al₂O₃ + | 0.856 | 0.636 | 0.801 | 0.783 | 0.958 | 0.618 | 0.952 |
| Ta₂O₅) | | | | | | | |

TABLE 1G

| Sample/mol % | 43 | 44 | 45 | 46 | 47 | 48 | 49 |
|---|---|---|---|---|---|---|---|
| SiO₂ | 64.149 | 63.875 | 61.952 | 56.390 | 73.673 | 63.929 | 63.779 |
| Al₂O₃ | 17.929 | 19.491 | 15.735 | 21.766 | 8.867 | 19.786 | 20.330 |
| B₂O₃ | | | 6.021 | | | | |
| P₂O₅ | 1.989 | | | 0.031 | 0.002 | 0.025 | 0.028 |
| Li₂O | 13.816 | 13.944 | 16.184 | 17.506 | 12.741 | 13.910 | 15.481 |
| Na₂O | 1.882 | 0.114 | 0.001 | 0.178 | 0.089 | 2.114 | 0.151 |
| K₂O | 0.048 | 0.042 | 0.001 | 0.047 | 0.022 | 0.040 | 0.040 |
| MgO | 0.039 | 0.030 | 0.014 | 3.840 | 0.023 | 0.029 | 0.032 |
| CaO | 0.028 | 0.032 | 0.010 | 0.066 | 0.042 | 0.048 | 0.049 |
| SrO | | | | | | | |
| SnO₂ | 0.081 | 0.073 | 0.077 | 0.103 | 0.074 | 0.079 | 0.080 |
| ZrO₂ | | | | | 0.004 | | |
| TiO₂ | 0.006 | 0.005 | | 0.006 | 0.007 | | |
| Fe₂O₃ | 0.027 | 0.022 | | 0.028 | 0.014 | 0.023 | 0.024 |
| ZnO | | | | 0.002 | | | |
| Ta₂O₅ | | | | | 4.429 | | |
| Y₂O₃ | | 2.357 | | | | | |
| La₂O₃ | | | | | | | |
| R₂O | 15.746 | 14.100 | 16.185 | 17.731 | 12.852 | 16.064 | 15.672 |
| RO | 0.067 | 0.062 | 0.024 | 3.906 | 0.065 | 0.077 | 0.081 |
| R₂O + R′O − | −2.121 | −1.798 | 0.474 | −0.134 | −0.390 | −3.644 | −4.577 |
| Al₂O₃ − Ta₂O₅ + | | | | | | | |
| 1.5*RE₂O₃ − | | | | | | | |
| ZrO₂ − TiO₂ | | | | | | | |
| R₂O − Al₂O₃ − | −2.182 | −5.391 | 0.450 | −4.034 | −0.444 | −3.722 | −4.658 |
| Ta₂O₅ | | | | | | | |
| R₂O + R′O − | −2.115 | −5.329 | 0.474 | −0.128 | −0.379 | −3.644 | −4.577 |
| Al₂O₃ − Ta₂O₅ | | | | | | | |
| Li₂O/R₂O | 0.877 | 0.989 | 1.000 | 0.987 | 0.991 | 0.866 | 0.988 |
| Li₂O/(Al₂O₃ + | 0.771 | 0.715 | 1.028 | 0.804 | 0.958 | 0.703 | 0.761 |
| Ta₂O₅) | | | | | | | |

TABLE 1H

| Sample/mol % | 50 | 51 | 52 | 53 | 54 | 55 | 56 |
|---|---|---|---|---|---|---|---|
| SiO₂ | 67.722 | 61.195 | 62.555 | 64.263 | 64.628 | 64.149 | 60.325 |
| Al₂O₃ | 11.522 | 18.545 | 15.206 | 16.019 | 19.267 | 19.509 | 21.884 |
| B₂O₃ | | 3.914 | 6.120 | 4.011 | | | |
| P₂O₅ | 0.008 | | | 0.026 | | | 0.028 |
| Li₂O | 15.570 | 11.261 | 15.992 | 15.281 | 10.255 | 11.823 | 17.384 |
| Na₂O | 0.121 | 0.722 | 0.022 | 0.182 | 2.087 | 1.353 | 0.152 |
| K₂O | 0.038 | 0.057 | | 0.039 | 0.042 | 0.036 | 0.039 |
| MgO | 0.031 | 0.027 | 0.012 | 0.025 | 0.032 | 0.018 | 0.030 |
| CaO | 0.056 | 0.040 | 0.011 | 0.047 | 0.032 | 0.032 | 0.051 |
| SrO | | | | | | | |
| SnO₂ | 0.076 | 0.069 | 0.074 | 0.076 | 0.070 | 0.082 | 0.077 |
| ZrO₂ | | | | | | | |
| TiO₂ | 0.006 | | | | | | |
| Fe₂O₃ | 0.020 | 0.028 | | 0.024 | 0.022 | 0.022 | 0.024 |
| ZnO | | | | | | | |
| Ta₂O₅ | 4.818 | | | | | | |
| Y₂O₃ | | 4.133 | | | 3.547 | 0.010 | |
| La₂O₃ | | | | | | | 2.956 |
| R₂O | 15.729 | 12.039 | 16.014 | 15.502 | 12.384 | 13.212 | 17.574 |
| RO | 0.088 | 0.067 | 0.024 | 0.072 | 0.064 | 0.050 | 0.081 |
| R₂O + R′O − | −0.530 | −0.240 | 0.831 | −0.445 | −1.499 | −1.796 | −4.229 |
| Al₂O₃ − Ta₂O₅ + | | | | | | | |
| 1.5*RE₂O₃ − | | | | | | | |
| ZrO₂ − TiO₂ | | | | | | | |
| R₂O − Al₂O₃ − | −0.612 | −6.506 | 0.807 | −0.517 | −6.883 | −6.296 | −4.310 |
| Ta₂O₅ | | | | | | | |
| R₂O + R′O − | −0.524 | −6.440 | 0.831 | −0.445 | −6.819 | −6.246 | −4.229 |
| Al₂O₃ − Ta₂O₅ | | | | | | | |
| Li₂O/R₂O | 0.990 | 0.935 | 0.999 | 0.986 | 0.828 | 0.895 | 0.989 |
| Li₂O/(Al₂O₃ + | 0.953 | 0.607 | 1.052 | 0.954 | 0.532 | 0.606 | 0.794 |
| Ta₂O₅) | | | | | | | |

TABLE 1I

| Sample/mol % | 57 | 58 | 59 | 60 | 61 | 62 | 63 |
|---|---|---|---|---|---|---|---|
| SiO₂ | 65.103 | 66.815 | 63.706 | 64.095 | 60.942 | 63.118 | 63.972 |
| Al₂O₃ | 18.533 | 11.304 | 20.444 | 18.978 | 16.762 | 19.733 | 19.849 |
| B₂O₃ | | 6.023 | | | 6.015 | | |
| P₂O₅ | | | 0.028 | 0.030 | | | |
| Li₂O | 11.266 | 15.724 | 15.447 | 13.813 | 16.165 | 15.619 | 15.739 |
| Na₂O | 0.735 | 0.027 | 0.145 | 2.858 | 0.003 | 0.121 | 0.153 |
| K₂O | 0.058 | | 0.041 | 0.049 | | 0.041 | 0.053 |
| MgO | 0.030 | 0.009 | 0.030 | 0.032 | 0.017 | 0.033 | 0.029 |
| CaO | 0.040 | 0.011 | 0.050 | 0.029 | 0.011 | 0.032 | 0.057 |
| SrO | | | | | | | |
| SnO₂ | 0.071 | 0.074 | 0.078 | 0.078 | 0.078 | 0.074 | 0.110 |
| ZrO₂ | | | | | | | |
| TiO₂ | | | | 0.005 | | 0.005 | |
| Fe₂O₃ | 0.029 | 0.001 | 0.024 | 0.027 | | 0.022 | 0.031 |
| ZnO | | | | | | | |
| Ta₂O₅ | | | | | | | |
| Y₂O₃ | 4.127 | | | | | 1.190 | 0.001 |
| La₂O₃ | | | | | | | |
| R₂O | 12.058 | 15.752 | 15.633 | 16.719 | 16.168 | 15.781 | 15.945 |
| RO | 0.070 | 0.020 | 0.080 | 0.061 | 0.028 | 0.064 | 0.086 |
| R₂O + R′O − | −0.214 | 4.468 | −4.731 | −2.203 | −0.566 | −2.107 | −3.816 |
| Al₂O₃ − Ta₂O₅ + | | | | | | | |
| 1.5*RE₂O₃ − | | | | | | | |
| ZrO₂ − TiO₂ | | | | | | | |
| R₂O − Al₂O₃ − | −6.475 | 4.448 | −4.811 | −2.259 | −0.594 | −3.952 | −3.904 |
| Ta₂O₅ | | | | | | | |
| R₂O + R′O − | −6.405 | 4.468 | −4.731 | −2.198 | −0.566 | −3.887 | −3.818 |
| Al₂O₃ − Ta₂O₅ | | | | | | | |
| Li₂O/R₂O | 0.934 | 0.998 | 0.988 | 0.826 | 1.000 | 0.990 | 0.987 |
| Li₂O/(Al₂O₃ + | 0.608 | 1.391 | 0.756 | 0.728 | 0.964 | 0.792 | 0.793 |
| Ta₂O₅) | | | | | | | |

TABLE 1J

| Sample/mol % | 64 | 65 | 66 | 67 | 68 | 69 | 70 |
|---|---|---|---|---|---|---|---|
| SiO₂ | 64.156 | 62.006 | 65.660 | 63.042 | 56.271 | 61.960 | 66.297 |
| Al₂O₃ | 17.989 | 19.847 | 13.563 | 18.844 | 23.630 | 19.771 | 17.837 |
| B₂O₃ | 1.972 | | | | | | |
| P₂O₅ | 0.030 | | 0.008 | | 0.030 | 1.942 | |
| Li₂O | 13.738 | 16.051 | 15.531 | 11.577 | 19.560 | 15.908 | 9.662 |
| Na₂O | 1.887 | 1.873 | 0.121 | 1.673 | 0.191 | 0.186 | 0.139 |
| K₂O | 0.047 | 0.038 | 0.037 | 0.056 | 0.045 | 0.039 | 0.043 |
| MgO | 0.037 | 0.030 | 0.034 | 2.486 | 0.035 | 0.028 | 0.026 |
| CaO | 0.029 | 0.045 | 0.055 | 0.048 | 0.058 | 0.050 | 0.035 |
| SrO | | | | | | | |
| SnO₂ | 0.079 | 0.079 | 0.074 | 0.074 | 0.104 | 0.079 | 0.067 |
| ZrO₂ | | | 0.001 | | | | |
| TiO₂ | 0.005 | | 0.005 | | 0.005 | | |
| Fe₂O₃ | 0.027 | 0.023 | 0.020 | 0.030 | 0.028 | 0.023 | 0.022 |
| ZnO | | | | | 0.001 | | |
| Ta₂O₅ | | | 4.882 | | | | |
| Y₂O₃ | | 0.001 | | 2.162 | | | 5.863 |
| La₂O₃ | | | | | | | |
| R₂O | 15.671 | 17.962 | 15.689 | 13.306 | 19.796 | 16.133 | 9.845 |
| RO | 0.065 | 0.075 | 0.089 | 2.534 | 0.093 | 0.078 | 0.060 |
| R₂O + R′O − | −2.257 | −1.810 | −2.672 | 0.239 | −3.746 | −3.559 | 0.862 |
| Al₂O₃ − Ta₂O₅ + | | | | | | | |
| 1.5*RE₂O₃ − | | | | | | | |
| ZrO₂ − TiO₂ | | | | | | | |
| R₂O − Al₂O₃ − | −2.317 | −1.885 | −2.756 | −5.538 | −3.834 | −3.637 | −7.992 |
| Ta₂O₅ | | | | | | | |
| R₂O + R′O − | −2.252 | −1.810 | −2.667 | −3.004 | −3.741 | −3.559 | −7.932 |
| Al₂O₃ − Ta₂O₅ | | | | | | | |
| Li₂O/R₂O | 0.877 | 0.894 | 0.990 | 0.870 | 0.988 | 0.986 | 0.981 |
| Li₂O/(Al₂O₃ + | 0.764 | 0.809 | 0.842 | 0.614 | 0.828 | 0.805 | 0.542 |
| Ta₂O₅) | | | | | | | |

TABLE 1K

| Sample/mol % | 71 | 72 | 73 | 74 | 75 | 76 | 77 |
|---|---|---|---|---|---|---|---|
| SiO₂ | 66.499 | 63.859 | 67.648 | 66.007 | 68.157 | 64.184 | 66.208 |
| Al₂O₃ | 18.417 | 19.309 | 12.056 | 18.533 | 16.003 | 18.962 | 17.902 |
| B₂O₃ | | | | | 0.004 | | |
| P₂O₅ | | 0.036 | 0.005 | | 0.027 | | 0.025 |
| Li₂O | 14.422 | 14.185 | 14.614 | 11.714 | 13.463 | 13.040 | 15.456 |
| Na₂O | 0.401 | 2.356 | 0.109 | 0.136 | 0.145 | 2.603 | 0.174 |
| K₂O | 0.051 | 0.051 | 0.032 | 0.039 | 0.047 | 0.048 | 0.040 |
| MgO | 0.029 | 0.028 | 0.032 | 0.024 | 1.999 | 0.056 | 0.022 |
| CaO | 0.047 | 0.055 | 0.051 | 0.034 | 0.041 | 0.987 | 0.049 |
| SrO | | | | | | | |
| SnO₂ | 0.100 | 0.076 | 0.074 | 0.067 | 0.076 | 0.082 | 0.077 |
| ZrO₂ | | | 0.001 | | | | |
| TiO₂ | | 0.008 | 0.003 | | 0.003 | 0.005 | |
| Fe₂O₃ | 0.029 | 0.030 | 0.018 | 0.021 | 0.026 | 0.027 | 0.023 |
| ZnO | | | | | 0.001 | | |
| Ta₂O₅ | | | 5.345 | | | | |
| Y₂O₃ | 0.001 | 0.001 | | 3.401 | | | |
| La₂O₃ | | | | | | | |
| R₂O | 14.873 | 16.591 | 14.754 | 11.889 | 13.655 | 15.691 | 15.671 |
| RO | 0.076 | 0.082 | 0.083 | 0.058 | 2.041 | 1.043 | 0.071 |
| R₂O + R′O − | −3.467 | −2.641 | −2.568 | −1.484 | −0.310 | −2.232 | −2.161 |
| Al₂O₃ − Ta₂O₅ + | | | | | | | |
| 1.5*RE₂O₃ − ZrO₂ − | | | | | | | |
| TiO₂ | | | | | | | |
| R₂O − Al₂O₃ − | −3.544 | −2.718 | −2.647 | −6.645 | −2.347 | −3.271 | −2.232 |
| Ta₂O₅ | | | | | | | |
| R₂O + R′O − | −3.468 | −2.635 | −2.564 | −6.586 | −0.307 | −2.227 | −2.161 |
| Al₂O₃ − Ta₂O₅ | | | | | | | |
| Li₂O/R₂O | 0.970 | 0.855 | 0.990 | 0.985 | 0.986 | 0.831 | 0.986 |
| Li₂O/(Al₂O₃ + | 0.783 | 0.735 | 0.840 | 0.632 | 0.841 | 0.688 | 0.863 |
| Ta₂O₅) | | | | | | | |

TABLE 1L

| Sample/mol % | 78 | 79 | 80 | 81 | 82 | 83 | 84 |
|---|---|---|---|---|---|---|---|
| SiO₂ | 56.465 | 64.057 | 58.297 | 68.178 | 62.436 | 62.204 | 63.150 |
| Al₂O₃ | 22.874 | 20.040 | 21.842 | 7.983 | 20.831 | 19.899 | 19.502 |
| B₂O₃ | | | | | | | |
| P₂O₅ | 0.027 | | 0.030 | | 0.029 | 0.030 | |
| Li₂O | 20.249 | 15.826 | 15.492 | 15.834 | 16.335 | 15.494 | 11.290 |
| Na₂O | 0.154 | | 0.140 | | 0.143 | 0.140 | 1.696 |
| K₂O | 0.039 | | 0.049 | | 0.042 | 0.049 | 0.057 |
| MgO | 0.027 | | 0.033 | | 0.027 | 0.032 | 0.030 |
| CaO | 0.052 | | 0.042 | | 0.050 | 0.035 | 0.042 |
| SrO | | | 3.961 | | | 2.000 | |
| SnO₂ | 0.078 | 0.077 | 0.073 | 0.071 | 0.077 | 0.077 | 0.070 |
| ZrO₂ | | | | | | | |
| TiO₂ | | | | | | | |
| Fe₂O₃ | 0.024 | | 0.026 | | 0.024 | 0.026 | 0.028 |
| ZnO | | | | | | | |
| Ta₂O₅ | | | | 7.934 | | | |
| Y₂O₃ | | | | | | | 4.125 |
| La₂O₃ | | | | | | | |
| R₂O | 20.443 | 15.826 | 15.680 | 15.834 | 16.519 | 15.683 | 13.043 |
| RO | 0.079 | | 4.036 | | 0.078 | 2.067 | 0.073 |
| R₂O + R′O − | −2.352 | −4.214 | −2.126 | −0.083 | −4.234 | −2.150 | −0.199 |
| Al₂O₃ − Ta₂O₅ + | | | | | | | |
| 1.5*RE₂O₃ − ZrO₂ − | | | | | | | |
| TiO₂ | | | | | | | |
| R₂O − Al₂O₃ − | −2.432 | −4.214 | −6.162 | −0.083 | −4.312 | −4.216 | −6.459 |
| Ta₂O₅ | | | | | | | |
| R₂O + R′O − | −2.352 | −4.214 | −2.126 | −0.083 | −4.234 | −2.150 | −6.387 |
| Al₂O₃ − Ta₂O₅ | | | | | | | |
| Li₂O/R₂O | 0.991 | 1.000 | 0.988 | 1.000 | 0.989 | 0.988 | 0.866 |
| Li₂O/(Al₂O₃ + | 0.885 | 0.790 | 0.709 | 0.995 | 0.784 | 0.779 | 0.579 |
| Ta₂O₅) | | | | | | | |

TABLE 1M

| Sample/mol % | 85 | 86 | 87 | 88 | 89 | 90 | 91 |
|---|---|---|---|---|---|---|---|
| SiO₂ | 64.277 | 50.487 | 62.455 | 65.248 | 60.398 | 71.690 | 61.221 |
| Al₂O₃ | 18.977 | 25.718 | 20.004 | 18.855 | 20.915 | 9.431 | 20.471 |
| B₂O₃ | | | | | | | |
| P₂O₅ | | 0.028 | | 0.026 | 0.028 | 0.004 | |
| Li₂O | 12.187 | 23.369 | 17.197 | 15.472 | 18.287 | 13.649 | 11.235 |
| Na₂O | 2.363 | 0.162 | 0.124 | 0.175 | 0.143 | 0.091 | 0.726 |
| K₂O | 0.049 | 0.040 | 0.039 | 0.041 | 0.040 | 0.028 | 0.056 |
| MgO | 0.069 | 0.035 | 0.030 | 0.025 | 0.030 | 0.023 | 1.998 |
| CaO | 1.959 | 0.054 | 0.031 | 0.050 | 0.051 | 0.048 | 0.053 |
| SrO | | | | | | | |
| SnO₂ | 0.080 | 0.077 | 0.080 | 0.076 | 0.077 | 0.074 | 0.069 |
| ZrO₂ | | | 0.001 | | | 0.004 | |
| TiO₂ | 0.005 | | 0.005 | | | 0.005 | |
| Fe₂O₃ | 0.028 | 0.024 | 0.022 | 0.023 | 0.024 | 0.016 | 0.029 |
| ZnO | | | | | | | |
| Ta₂O₅ | | | | | | 4.926 | |
| Y₂O₃ | | | 0.001 | | | | 4.132 |
| La₂O₃ | | | | | | | |
| R₂O | 14.598 | 23.571 | 17.361 | 15.688 | 18.470 | 13.767 | 12.017 |
| RO | 2.028 | 0.089 | 0.061 | 0.076 | 0.081 | 0.071 | 2.050 |
| R₂O + R′O − | −2.357 | −2.058 | −2.587 | −3.091 | −2.363 | −0.528 | −0.206 |
| Al₂O₃ − Ta₂O₅ + | | | | | | | |
| 1.5*RE₂O₃ − ZrO₂ − | | | | | | | |
| TiO₂ | | | | | | | |
| R₂O − Al₂O₃ − | −4.379 | −2.147 | −2.643 | −3.166 | −2.444 | −0.590 | −8.454 |
| Ta₂O₅ | | | | | | | |
| R₂O + R′O − | −2.351 | −2.058 | −2.582 | −3.091 | −2.363 | −0.519 | −6.404 |
| Al₂O₃ − Ta₂O₅ | | | | | | | |
| Li₂O/R₂O | 0.835 | 0.991 | 0.991 | 0.986 | 0.990 | 0.991 | 0.935 |
| Li₂O/(Al₂O₃ + | 0.642 | 0.909 | 0.860 | 0.821 | 0.874 | 0.951 | 0.549 |
| Ta₂O₅) | | | | | | | |

TABLE 1N

| Sample/mol % | 92 | 93 | 94 | 95 | 96 | 97 | 98 |
|---|---|---|---|---|---|---|---|
| SiO₂ | 58.314 | 66.391 | 64.306 | 58.210 | 69.720 | 63.884 | 62.240 |
| Al₂O₃ | 21.899 | 13.848 | 17.997 | 21.863 | 9.441 | 19.848 | 19.895 |
| B₂O₃ | | | | | 2.003 | | |
| P₂O₅ | | | | 0.030 | 0.003 | 0.026 | 1.985 |
| Li₂O | 15.437 | 15.725 | 13.638 | 15.515 | 13.659 | 11.944 | 15.491 |
| Na₂O | 0.140 | | 2.852 | 0.286 | 0.099 | 4.068 | 0.160 |
| K₂O | 0.048 | | 0.048 | 0.047 | 0.028 | 0.040 | 0.047 |
| MgO | 3.989 | | 0.051 | 0.033 | 0.025 | 0.028 | 0.029 |
| CaO | 0.058 | | 0.990 | 0.035 | 0.046 | 0.050 | 0.033 |
| SrO | | | | 0.001 | | | |
| SnO₂ | 0.078 | 0.072 | 0.078 | 0.076 | 0.074 | 0.077 | 0.078 |
| ZrO₂ | | | | | 0.001 | | 0.001 |
| TiO₂ | 0.003 | | 0.005 | | 0.005 | | |
| Fe₂O₃ | 0.028 | | 0.027 | 0.026 | 0.016 | 0.024 | 0.026 |
| ZnO | | | | 3.863 | | | |
| Ta₂O₅ | | 3.964 | | | 4.868 | | |
| Y₂O₃ | | | | | | | |
| La₂O₃ | | | | | | | |
| R₂O | 15.625 | 15.725 | 16.538 | 15.847 | 13.786 | 16.052 | 15.699 |
| RO | 4.047 | | 1.041 | 0.069 | 0.072 | 0.078 | 0.062 |
| R₂O + R′O − | −2.230 | −2.087 | −0.423 | −5.947 | −0.457 | −3.719 | −4.135 |
| Al₂O₃ − Ta₂O₅ + | | | | | | | |
| 1.5*RE₂O₃ − ZrO₂ − | | | | | | | |
| TiO₂ | | | | | | | |
| R₂O − Al₂O₃ − | −6.274 | −2.087 | −1.459 | −6.016 | −0.523 | −3.796 | −4.196 |
| Ta₂O₅ | | | | | | | |
| R₂O + R′O − | −2.227 | −2.087 | −0.418 | −5.947 | −0.451 | −3.719 | −4.134 |
| Al₂O₃ − Ta₂O₅ | | | | | | | |
| Li₂O/R₂O | 0.988 | 1.000 | 0.825 | 0.979 | 0.991 | 0.744 | 0.987 |
| Li₂O/(Al₂O₃ + | 0.705 | 0.883 | 0.758 | 0.710 | 0.955 | 0.602 | 0.779 |
| Ta₂O₅) | | | | | | | |

TABLE 1O

| Sample/mol % | 99 | 100 | 101 | 102 | 103 | 104 | 105 |
|---|---|---|---|---|---|---|---|
| SiO₂ | 68.763 | 64.172 | 62.137 | 62.235 | 58.341 | 72.009 | 65.152 |
| Al₂O₃ | 8.001 | 17.799 | 19.890 | 19.917 | 21.896 | 15.898 | 16.946 |
| B₂O₃ | | | | | | | |
| P₂O₅ | | 0.046 | 0.030 | | | 0.028 | 1.987 |
| Li₂O | 15.242 | 17.501 | 15.561 | 15.502 | 15.473 | 11.719 | 13.794 |
| Na₂O | 0.111 | 0.167 | 0.223 | 0.153 | 4.056 | 0.129 | 1.895 |
| K₂O | | 0.044 | 0.048 | 0.048 | 0.050 | 0.041 | 0.048 |
| MgO | 0.028 | 0.037 | 0.026 | 0.065 | 0.032 | 0.024 | 0.036 |
| CaO | | 0.069 | 0.033 | 1.962 | 0.035 | 0.045 | 0.028 |
| SrO | | | 0.001 | | | | |
| SnO₂ | 0.070 | 0.103 | 0.078 | 0.080 | 0.078 | 0.076 | 0.076 |
| ZrO₂ | | 0.001 | 0.001 | | | | |
| TiO₂ | | 0.004 | | 0.004 | 0.003 | | 0.005 |
| Fe₂O₃ | | 0.029 | 0.026 | 0.027 | 0.026 | 0.024 | 0.027 |
| ZnO | | | 1.935 | | | | |
| Ta₂O₅ | 7.785 | | | | | | |
| Y₂O₃ | | | | | | | |
| La₂O₃ | | | | | | | |
| R₂O | 15.353 | 17.712 | 15.832 | 15.703 | 19.579 | 11.889 | 15.737 |
| RO | 0.028 | 0.107 | 0.060 | 2.027 | 0.067 | 0.069 | 0.063 |
| R₂O + R′O − | −0.404 | 0.015 | −3.999 | −2.191 | −2.253 | −3.940 | −1.150 |
| Al₂O₃ − Ta₂O₅ + | | | | | | | |
| 1.5*RE₂O₃ − ZrO₂ − | | | | | | | |
| TiO₂ | | | | | | | |
| R₂O − Al₂O₃ − | −0.433 | −0.088 | −4.058 | −4.214 | −2.317 | −4.009 | −1.209 |
| Ta₂O₅ | | | | | | | |
| R₂O + R′O − | −0.404 | 0.019 | −3.999 | −2.186 | −2.250 | −3.940 | −1.145 |
| Al₂O₃ − Ta₂O₅ | | | | | | | |
| Li₂O/R₂O | 0.993 | 0.988 | 0.983 | 0.987 | 0.790 | 0.986 | 0.877 |
| Li₂O/(Al₂O₃ + | 0.966 | 0.983 | 0.782 | 0.778 | 0.707 | 0.737 | 0.814 |
| Ta₂O₅) | | | | | | | |

TABLE 1P

| Sample/mol % | 106 | 107 | 108 | 109 | 110 | 111 | 112 |
|---|---|---|---|---|---|---|---|
| SiO₂ | 56.302 | 69.841 | 58.452 | 66.063 | 56.435 | 64.262 | 64.517 |
| Al₂O₃ | 21.744 | 10.004 | 19.887 | 17.946 | 19.864 | 17.970 | 18.772 |
| B₂O₃ | | | 2.035 | 0.004 | | | |
| P₂O₅ | 0.031 | 0.006 | 3.864 | 0.027 | 0.031 | 0.031 | 1.989 |
| Li₂O | 19.530 | 14.640 | 15.349 | 13.799 | 19.347 | 15.520 | 14.342 |
| Na₂O | 0.184 | 0.107 | 0.187 | 1.933 | 0.176 | 0.158 | 0.149 |
| K₂O | 0.048 | 0.033 | 0.042 | 0.048 | 0.046 | 0.049 | 0.044 |
| MgO | 1.925 | 0.032 | 0.025 | 0.030 | 3.858 | 0.027 | 0.029 |
| CaO | 0.063 | 0.050 | 0.051 | 0.033 | 0.067 | 0.032 | 0.050 |
| SrO | | | | | | 0.002 | |
| SnO₂ | 0.104 | 0.073 | 0.077 | 0.078 | 0.105 | 0.073 | 0.077 |
| ZrO₂ | | 0.001 | | | | 1.822 | |
| TiO₂ | 0.006 | 0.004 | | 0.004 | 0.005 | | |
| Fe₂O₃ | 0.028 | 0.019 | 0.024 | 0.026 | 0.028 | 0.027 | 0.024 |
| ZnO | 0.002 | | | 0.001 | 0.002 | | |
| Ta₂O₅ | | 5.178 | | | | | |
| Y₂O₃ | | | | | | | |
| La₂O₃ | | | | | | | |
| R₂O | 19.762 | 14.780 | 15.578 | 15.780 | 19.569 | 15.727 | 14.535 |
| RO | 1.988 | 0.082 | 0.076 | 0.063 | 3.925 | 0.061 | 0.080 |
| R₂O + R′O − | 0.001 | −0.325 | −4.234 | −2.107 | 3.625 | −4.004 | −4.158 |
| Al₂O₃ − Ta₂O₅ + | | | | | | | |
| 1.5*RE₂O₃ − ZrO₂ − | | | | | | | |
| TiO₂ | | | | | | | |
| R₂O − Al₂O₃ − | −1.983 | −0.402 | −4.309 | −2.166 | −0.295 | −2.243 | −4.237 |
| Ta₂O₅ | | | | | | | |
| R₂O + R′O − | 0.006 | −0.320 | −4.234 | −2.103 | 3.630 | −2.181 | −4.158 |
| Al₂O₃ − Ta₂O₅ | | | | | | | |
| Li₂O/R₂O | 0.988 | 0.991 | 0.985 | 0.874 | 0.989 | 0.987 | 0.987 |
| Li₂O/(Al₂O₃ + | 0.898 | 0.964 | 0.772 | 0.769 | 0.974 | 0.864 | 0.764 |
| Ta₂O₅) | | | | | | | |

TABLE 1Q

| Sample/mol % | 113 | 114 | 115 | 116 | 117 | 118 | 119 |
|---|---|---|---|---|---|---|---|
| SiO₂ | 50.564 | 62.341 | 72.245 | 62.196 | 60.456 | 56.429 | 75.961 |
| Al₂O₃ | 24.785 | 19.973 | 13.946 | 17.905 | 17.970 | 21.792 | 11.963 |
| B₂O₃ | | | | | 3.989 | | |
| P₂O₅ | 0.029 | | 0.046 | 3.951 | 1.955 | 3.933 | 0.044 |
| Li₂O | 24.226 | 13.636 | 13.297 | 13.835 | 15.234 | 17.467 | 11.594 |
| Na₂O | 0.161 | 2.842 | 0.157 | 1.887 | 0.179 | 0.153 | 0.141 |
| K₂O | 0.040 | 0.049 | 0.044 | 0.048 | 0.040 | 0.039 | 0.042 |
| MgO | 0.033 | 0.053 | 0.031 | 0.035 | 0.023 | 0.030 | 0.029 |
| CaO | 0.054 | 0.988 | 0.068 | 0.028 | 0.049 | 0.049 | 0.063 |
| SrO | | | | | | | |
| SnO₂ | 0.077 | 0.080 | 0.103 | 0.077 | 0.076 | 0.077 | 0.102 |
| ZrO₂ | | | 0.001 | | | | 0.001 |
| TiO₂ | | 0.005 | 0.005 | 0.005 | | | 0.005 |
| Fe₂O₃ | 0.023 | 0.027 | 0.030 | 0.026 | 0.024 | 0.024 | 0.029 |
| ZnO | | | 0.001 | | | | |
| Ta₂O₅ | | | | | | | |
| Y₂O₃ | | | | | | | |
| La₂O₃ | | | | | | | |
| R₂O | 24.427 | 16.526 | 13.498 | 15.770 | 15.452 | 17.659 | 11.777 |
| RO | 0.087 | 1.041 | 0.099 | 0.062 | 0.072 | 0.079 | 0.092 |
| R₂O + R′O − | −0.270 | −2.411 | −0.354 | −2.078 | −2.445 | −4.053 | −0.100 |
| Al₂O₃ − Ta₂O₅ + | | | | | | | |
| 1.5*RE₂O₃ − ZrO₂ − | | | | | | | |
| TiO₂ | | | | | | | |
| R₂O − Al₂O₃ − | −0.358 | −3.446 | −0.447 | −2.135 | −2.517 | −4.132 | −0.186 |
| Ta₂O₅ | | | | | | | |
| R₂O + R′O − | −0.270 | −2.406 | −0.348 | −2.073 | −2.445 | −4.053 | −0.094 |
| Al₂O₃ − Ta₂O₅ | | | | | | | |
| Li₂O/R₂O | 0.992 | 0.825 | 0.985 | 0.877 | 0.986 | 0.989 | 0.984 |
| Li₂O/(Al₂O₃ + | 0.977 | 0.683 | 0.953 | 0.773 | 0.848 | 0.802 | 0.969 |
| Ta₂O₅) | | | | | | | |

TABLE 1R

| Sample/mol % | 120 | 121 | 122 | 123 | 124 | 125 | 126 |
|---|---|---|---|---|---|---|---|
| SiO₂ | 64.192 | 56.220 | 62.292 | 66.224 | 72.113 | 64.946 | 64.321 |
| Al₂O₃ | 16.965 | 21.717 | 18.961 | 14.044 | 14.932 | 16.873 | 17.778 |
| B₂O₃ | | | | 2.036 | | | |
| P₂O₅ | | 0.031 | | 0.026 | 0.028 | 1.950 | 3.945 |
| Li₂O | 13.793 | 21.536 | 13.701 | 15.284 | 12.592 | 14.083 | 13.579 |
| Na₂O | 2.854 | 0.187 | 2.851 | 0.184 | 0.121 | 1.898 | 0.149 |
| K₂O | 0.048 | 0.047 | 0.049 | 0.040 | 0.040 | 0.051 | 0.041 |
| MgO | 0.072 | 0.031 | 0.069 | 1.994 | 0.022 | 0.026 | 0.030 |
| CaO | 1.956 | 0.057 | 1.959 | 0.058 | 0.043 | 0.053 | 0.047 |
| SrO | | | | | | | |
| SnO₂ | 0.078 | 0.104 | 0.078 | 0.078 | 0.079 | 0.074 | 0.079 |
| ZrO₂ | | | | | | | |
| TiO₂ | 0.005 | 0.006 | 0.004 | | | 0.007 | |
| Fe₂O₃ | 0.027 | 0.028 | 0.028 | 0.024 | 0.024 | 0.030 | 0.024 |
| ZnO | | 0.002 | | | | | |
| Ta₂O₅ | | | | | | | |
| Y₂O₃ | | | | | | 0.001 | |
| La₂O₃ | | | | | | | |
| R₂O | 16.695 | 21.771 | 16.601 | 15.508 | 12.753 | 16.032 | 13.769 |
| RO | 2.028 | 0.089 | 2.027 | 2.052 | 0.064 | 0.079 | 0.076 |
| R₂O + R′O − | 1.754 | 0.137 | −0.337 | 3.516 | −2.114 | −0.768 | −3.933 |
| Al₂O₃ − Ta₂O₅ + | | | | | | | |
| 1.5*RE₂O₃ − ZrO₂ − | | | | | | | |
| TiO₂ | | | | | | | |
| R₂O − Al₂O₃ − | −0.269 | 0.054 | −2.360 | 1.463 | −2.179 | −0.841 | −4.009 |
| Ta₂O₅ | | | | | | | |
| R₂O + R′O − | 1.759 | 0.142 | −0.333 | 3.516 | −2.114 | −0.762 | −3.933 |
| Al₂O₃ − Ta₂O₅ | | | | | | | |
| Li₂O/R₂O | 0.826 | 0.989 | 0.825 | 0.986 | 0.987 | 0.878 | 0.986 |
| Li₂O/(Al₂O₃ + | 0.813 | 0.992 | 0.723 | 1.088 | 0.843 | 0.835 | 0.764 |
| Ta₂O₅) | | | | | | | |

TABLE 1SaA

| Sample/mol % | 127 | 128 | 129 | 130 | 131 | 132 | 133 |
|---|---|---|---|---|---|---|---|
| SiO₂ | 60.209 | 59.997 | 58.310 | 60.204 | 62.342 | 63.788 | 60.041 |
| Al₂O₃ | 15.916 | 19.736 | 21.881 | 19.782 | 18.920 | 19.764 | 19.786 |
| B₂O₃ | | | | | 0.004 | | |
| P₂O₅ | 0.032 | 3.860 | | 0.045 | 1.948 | | |
| Li₂O | 19.563 | 15.989 | 15.485 | 19.480 | 12.649 | 15.940 | 15.731 |
| Na₂O | 0.159 | 0.188 | 0.145 | 0.174 | 3.893 | 0.168 | 0.159 |
| K₂O | 0.047 | 0.039 | 0.051 | 0.042 | 0.051 | 0.067 | 0.061 |
| MgO | 3.839 | 0.032 | 0.109 | 0.037 | 0.030 | 0.030 | 3.960 |
| CaO | 0.065 | 0.049 | 3.898 | 0.071 | 0.035 | 0.050 | 0.074 |
| SrO | | | | | | | |
| SnO₂ | 0.104 | 0.079 | 0.079 | 0.103 | 0.076 | 0.100 | 0.100 |
| ZrO₂ | | | | 0.001 | 0.005 | | 0.001 |
| TiO₂ | 0.006 | | 0.004 | 0.003 | 0.003 | | |
| Fe₂O₃ | 0.027 | 0.024 | 0.029 | 0.029 | 0.026 | 0.029 | 0.028 |
| ZnO | 0.004 | | | 0.001 | 0.001 | | |
| Ta₂O₅ | | | | | | | |
| Y₂O₃ | | | | | | | |
| La₂O₃ | | | | | | | |
| R₂O | 19.769 | 16.217 | 15.681 | 19.696 | 16.593 | 16.174 | 15.950 |
| RO | 3.904 | 0.081 | 4.007 | 0.108 | 0.065 | 0.081 | 4.034 |
| R₂O + R′O − | 7.751 | −3.438 | −2.197 | 0.019 | −2.270 | −3.510 | 0.197 |
| Al₂O₃ − Ta₂O₅ + | | | | | | | |
| 1.5*RE₂O₃ − ZrO₂ − | | | | | | | |
| TiO₂ | | | | | | | |
| R₂O − Al₂O₃ − | 3.854 | −3.519 | −6.200 | −0.086 | −2.328 | −3.590 | −3.836 |
| Ta₂O₅ | | | | | | | |
| R₂O + R′O − | 7.758 | −3.438 | −2.193 | 0.022 | −2.262 | −3.510 | 0.198 |
| Al₂O₃ − Ta₂O₅ | | | | | | | |
| Li₂O/R₂O | 0.990 | 0.986 | 0.988 | 0.989 | 0.762 | 0.985 | 0.986 |
| Li₂O/(Al₂O₃ + | 1.229 | 0.810 | 0.708 | 0.985 | 0.669 | 0.806 | 0.795 |
| Ta₂O₅) | | | | | | | |

TABLE 1T

| Sample/mol % | 134 | 135 | 136 | 137 | 138 | 139 | 140 |
|---|---|---|---|---|---|---|---|
| SiO₂ | 70.126 | 65.218 | 67.175 | 64.304 | 68.207 | 58.322 | 64.204 |
| Al₂O₃ | 15.959 | 17.890 | 16.907 | 17.805 | 15.901 | 21.878 | 15.920 |
| B₂O₃ | | | | | | 0.004 | |
| P₂O₅ | 0.028 | 0.990 | 0.025 | 1.952 | 1.992 | 0.031 | 3.947 |
| Li₂O | 13.537 | 15.486 | 15.486 | 15.524 | 13.549 | 13.656 | 13.806 |
| Na₂O | 0.130 | 0.184 | 0.182 | 0.189 | 0.131 | 5.874 | 1.894 |
| K₂O | 0.040 | 0.040 | 0.040 | 0.043 | 0.040 | 0.049 | 0.048 |
| MgO | 0.027 | 0.019 | 0.025 | 0.024 | 0.026 | 0.031 | 0.036 |
| CaO | 0.045 | 0.048 | 0.047 | 0.050 | 0.046 | 0.039 | 0.027 |
| SrO | | | | | | | |
| SnO₂ | 0.078 | 0.077 | 0.078 | 0.078 | 0.078 | 0.077 | 0.079 |
| ZrO₂ | | | | | | | |
| TiO₂ | | | | | | 0.003 | 0.006 |
| Fe₂O₃ | 0.025 | 0.023 | 0.023 | 0.023 | 0.024 | 0.026 | 0.026 |
| ZnO | | | | | | 0.001 | |
| Ta₂O₅ | | | | | | | |
| Y₂O₃ | | | | | | | |
| La₂O₃ | | | | | | | |
| R₂O | 13.707 | 15.709 | 15.708 | 15.756 | 13.720 | 19.579 | 15.748 |
| RO | 0.072 | 0.067 | 0.072 | 0.074 | 0.072 | 0.070 | 0.063 |
| R₂O + R′O − | −2.180 | −2.113 | −1.126 | −1.975 | −2.109 | −2.232 | −0.114 |
| Al₂O₃ − Ta₂O₅ + | | | | | | | |
| 1.5*RE₂O₃ − ZrO₂ − | | | | | | | |
| TiO₂ | | | | | | | |
| R₂O − Al₂O₃ − | −2.252 | −2.180 | −1.198 | −2.049 | −2.180 | −2.299 | −0.172 |
| Ta₂O₅ | | | | | | | |
| R₂O + R′O − | −2.180 | −2.113 | −1.126 | −1.975 | −2.109 | −2.229 | −0.109 |
| Al₂O₃ − Ta₂O₅ | | | | | | | |
| Li₂O/R₂O | 0.988 | 0.986 | 0.986 | 0.985 | 0.988 | 0.697 | 0.877 |
| Li₂O/(Al₂O₃ + | 0.848 | 0.866 | 0.916 | 0.872 | 0.852 | 0.624 | 0.867 |
| Ta₂O₅) | | | | | | | |

TABLE 1U

| Sample/mol % | 141 | 142 | 143 | 144 | 145 |
|---|---|---|---|---|---|
| SiO₂ | 66.205 | 62.342 | 70.080 | 67.950 | 68.763 |
| Al₂O₃ | 16.930 | 19.924 | 14.904 | 15.833 | 8.001 |
| B₂O₃ | 0.004 | 0.004 | | | |
| P₂O₅ | 1.953 | 0.028 | 1.987 | | |
| Li₂O | 12.739 | 13.559 | 12.685 | 15.793 | 15.242 |
| Na₂O | 1.925 | 3.895 | 0.131 | 0.168 | 0.111 |
| K₂O | 0.050 | 0.051 | 0.039 | 0.066 | |
| MgO | 0.032 | 0.034 | 0.024 | 0.031 | 0.028 |
| CaO | 0.036 | 0.038 | 0.044 | 0.057 | |
| SrO | | | | | |
| SnO₂ | 0.078 | 0.077 | 0.076 | 0.065 | 0.070 |
| ZrO₂ | 0.005 | | | 0.001 | |
| TiO₂ | 0.003 | 0.002 | | | |
| Fe₂O₃ | 0.026 | 0.026 | 0.024 | 0.031 | |
| ZnO | 0.001 | 0.001 | | | |
| Ta₂O₅ | | | | | |
| Y₂O₃ | | | | | |
| La2O₃ | | | | | |
| R₂O | 14.714 | 17.505 | 12.855 | 16.028 | 15.353 |
| RO | 0.069 | 0.072 | 0.068 | 0.088 | 0.028 |
| R₂O + R′O − | −2.155 | −2.349 | −1.982 | 0.282 | 7.380 |
| Al₂O₃ − Ta₂O₅ + | | | | | |
| 1.5*RE₂O₃ − | | | | | |
| ZrO₂ − TiO₂ | | | | | |
| R₂O − Al₂O₃ − | −2.216 | −2.419 | −2.049 | 0.195 | 7.352 |
| Ta₂O₅ | | | | | |
| R₂O + R′O − | −2.147 | −2.347 | −1.982 | 0.283 | 7.380 |
| Al₂O₃ − Ta₂O₅ | | | | | |
| Li₂O/R₂O | 0.866 | 0.775 | 0.987 | 0.985 | 0.993 |
| Li₂O/(Al₂O₃ + | 0.752 | 0.681 | 0.851 | 0.998 | 1.905 |
| Ta₂O₅) | | | | | |

The properties of the compositions were investigated by methods discussed above, and the results are tabulated in Tables 2A-2U. The strain point, anneal point, softening temperature, and liquidus temperature are reported in° C. CTE is reported in values×10⁻⁷/° C. Density is reported in g/cm³. Liquidus viscosity is reported in kP. K₁c is reported in MPa√m. The shear modulus and Young's modulus are reported in GPa, while the specific modulus, as the ratio between Young's modulus and the density, is reported in GPa·cm·g⁻¹. Poisson's ratio is unitless. G_{1C} is reported in J/m². SOC is reported in nm/cm/MPa. Maximum CT values for both annealed and fictivated glasses are reported in MPa. Further, the ion exchange time required to attain these maximum CT values is reported in hours.

TABLE 2A

| Property | 1 | 2 | 3 | 4 | 5 | 6 | 7 |
|---|---|---|---|---|---|---|---|
| Avg. CTE (10⁻⁷/C.) | 58 | | 52 | 54.9 | | | 49 |
| (20-300° C.) | | | | | | | |
| Strain (° C.) | 574 | 594 | 614 | 627 | 633 | 634 | 694 |
| Anneal (° C.) | 620 | 640 | 660 | 672 | 678 | 680 | 742 |
| Softening (° C.) | 830 | 843 | | | | | |
| Density (g/cm³) | 2.377 | 2.907 | 2.593 | 2.564 | 2.601 | 2.678 | 2.571 |
| Liquidus | 1310 | 1240 | 1165 | 1270 | 1155 | 1200 | 1305 |
| temperature (° C.) | | | | | | | |
| Liquidus viscosity | 0.8 | 2.3 | 4.9 | 1.1 | 9.3 | 5.0 | 3.8 |
| (kP) | | | | | | | |
| K_{1C} (MPa√m) | 0.849 | 0.890 | 0.880 | 0.875 | 0.876 | 0.869 | 0.872 |
| Poisson's Ratio | 0.231 | 0.215 | 0.241 | 0.237 | 0.233 | 0.221 | 0.226 |
| Shear Modulus | 32.27 | 36.54 | 35.03 | 35.58 | 35.99 | 36.06 | 36.47 |
| (GPa) | | | | | | | |
| Young's Modulus | 79.36 | 88.74 | 86.94 | 87.98 | 88.67 | 88.05 | 89.36 |
| (GPa) | | | | | | | |
| Specific Modulus | 33.39 | 30.52 | 33.53 | 34.31 | 34.09 | 32.88 | 34.76 |
| (GPa · cm³/g) | | | | | | | |
| G_{1C} (J/m²) | 9.08 | 8.93 | 8.91 | 8.70 | 8.65 | 8.58 | 8.51 |
| SOC | 30.66 | 35.08 | 29.05 | 28.59 | 28.7 | 28.1 | 28.01 |
| (nm/cm/MPa) | | | | | | | |
| Maximum CT | 385 | 315 | 177 | 270 | 185 | 195 | 215 |
| (annealed; MPa) | | | | | | | |
| Time for | 64 | 32 | 24 | 24 | 64 | 64 | 20 |
| maximum CT | | | | | | | |
| (annealed, h) | | | | | | | |
| Maximum CT | | | 156 | | | | |
| (fictivated; MPa) | | | | | | | |
| Time for | | | 24 | | | | |
| maximum CT | | | | | | | |
| (fictivated, h) | | | | | | | |
| D 390° C. (um²/hr) | 455 | 827 | | 270 | | | |
| D 430° C. (um²/hr) | 1130 | 1803 | 423 | 770 | 361 | 308 | 1232 |
| D430*CT | 435050 | 567945 | 74871 | 207900 | 66785 | 60060 | 264880 |
| (MPa · μm²/hour) | | | | | | | |

TABLE 2B

| Property | 8 | 9 | 10 | 11 | 12 | 13 | 14 |
|---|---|---|---|---|---|---|---|
| Avg. CTE (10⁻⁷/C.) | 56.8 | 53.6 | 48.2 | 51.5 | 53.4 | | 49.6 |
| (20-300° C.) | | | | | | | |
| Strain (° C.) | 585 | 657 | 699 | 690 | 685 | 620 | 693 |
| Anneal (° C.) | 628 | 705 | 746 | 737 | 732 | 665 | 738 |
| Softening (° C.) | 824 | | | | | | |
| Density (g/cm³) | 2.409 | 2.573 | 2.558 | 2.586 | 2.583 | 2.652 | 2.585 |
| Liquidus | >1460 | 1245 | 1300 | 1285 | 1265 | 1165 | 1305 |
| temperature (° C.) | | | | | | | |
| Liquidus viscosity | | 5.0 | 5.5 | 4.5 | 5.8 | 6.1 | 3.1 |
| (kP) | | | | | | | |
| K_{1C} (MPa√m) | 0.839 | 0.864 | 0.864 | 0.870 | 0.866 | 0.856 | 0.866 |
| Poisson's Ratio | 0.235 | 0.229 | 0.220 | 0.227 | 0.227 | 0.238 | 0.227 |
| Shear Modulus | 33.51 | 35.78 | 36.34 | 36.61 | 36.40 | 35.58 | 36.75 |
| (GPa) | | | | | | | |
| Young's Modulus | 82.74 | 87.98 | 88.60 | 89.84 | 89.36 | 88.05 | 90.18 |
| (GPa) | | | | | | | |
| Specific Modulus | 34.34 | 34.19 | 34.64 | 34.74 | 34.59 | 33.20 | 34.89 |
| (GPa · cm³/g) | | | | | | | |
| G_{1C} (J/m²) | 8.51 | 8.49 | 8.43 | 8.43 | 8.39 | 8.32 | 8.32 |
| SOC | 29.44 | 28.39 | 28.48 | 27.98 | 28.07 | 28.51 | 27.81 |
| (nm/cm/MPa) | | | | | | | |
| Maximum CT | 340 | 189 | 200 | 192 | 184 | 178 | 220 |
| (annealed; MPa) | | | | | | | |
| Time for | 72 | 20 | 20 | 20 | 18 | 64 | 28 |
| maximum CT | | | | | | | |
| (annealed, h) | | | | | | | |
| Maximum CT | | | | | | | |
| (fictivated; MPa) | | | | | | | |
| Time for | | | | | | | |
| maximum CT | | | | | | | |
| (fictivated, h) | | | | | | | |
| D 390° C. (um²/hr) | 218 | | | | | | |
| D 430° C. (um²/hr) | | 1206 | 1356 | 1275 | 1465 | 292 | 1103 |
| D430*CT | 74120 | 227934 | 271200 | 244800 | 269560 | 51976 | 242660 |
| (MPa · μm²/hour) | | | | | | | |

TABLE 2C

| Property | 15 | 16 | 17 | 18 | 19 | 20 | 21 |
|---|---|---|---|---|---|---|---|
| Avg. CTE (10⁻⁷/C.) | 56.4 | 55.4 | 56.9 | 54.6 | | 60.8 | 55.7 |
| (20-300° C.) | | | | | | | |
| Strain (° C.) | 645 | 650 | 645 | 682 | 603 | 662 | 671 |
| Anneal (° C.) | 690 | 696 | 689 | 727 | 648 | 707 | 717 |
| Softening (° C.) | 901 | | 881 | | | 909 | |
| Density (g/cm³) | 2.453 | 2.573 | 2.638 | 2.582 | 2.397 | 2.513 | 2.611 |
| Liquidus | 1395 | 1315 | 1245 | 1315 | 1345 | 1350 | 1295 |
| temperature (° C.) | | | | | | | |
| Liquidus viscosity | 0.7 | 0.9 | 1.6 | 1.3 | 0.7 | 0.9 | 1.8 |
| (kP) | | | | | | | |
| K_{1C} (MPa√m) | 0.863 | 0.858 | 0.866 | 0.864 | 0.820 | 0.854 | 0.857 |
| Poisson's Ratio | 0.231 | 0.233 | 0.237 | 0.232 | 0.218 | 0.228 | 0.227 |
| Shear Modulus | 36.47 | 36.20 | 36.87 | 36.75 | 33.51 | 36.20 | 36.54 |
| (GPa) | | | | | | | |
| Young's Modulus | 89.77 | 89.22 | 91.01 | 90.60 | 81.63 | 88.87 | 89.63 |
| (GPa) | | | | | | | |
| Specific Modulus | 36.60 | 34.67 | 34.50 | 35.09 | 34.06 | 35.37 | 34.33 |
| (GPa · cm³/g) | | | | | | | |
| G_{1C} (J/m²) | 8.30 | 8.25 | 8.24 | 8.24 | 8.24 | 8.21 | 8.19 |
| SOC | 27.55 | 27.85 | 27.37 | 27.61 | 29.46 | 27.55 | 27.43 |
| (nm/cm/MPa) | | | | | | | |
| Maximum CT | 280 | 275 | 280 | 270 | 393 | 330 | 265 |
| (annealed; MPa) | | | | | | | |
| Time for | 48 | 32 | 25 | 24 | 48 | 36 | 24 |
| maximum CT | | | | | | | |
| (annealed, h) | | | | | | | |
| Maximum CT | | | 262 | | | 270 | |
| (fictivated; MPa) | | | | | | | |
| Time for | | | 20 | | | 24 | |
| maximum CT | | | | | | | |
| (fictivated, h) | | | | | | | |
| D 390° C. (um²/hr) | 435 | 324 | | 383 | 500 | 1078 | 383 |
| D 430° C. (um²/hr) | 1364 | 832 | 521 | 1000 | 1153 | 1952 | 938 |
| D430*CT | 381920 | 228800 | 145880 | 270000 | 453129 | 644160 | 248570 |
| (MPa · μm²/hour) | | | | | | | |

TABLE 2D

| Property | 22 | 23 | 24 | 25 | 26 | 27 | 28 |
|---|---|---|---|---|---|---|---|
| Avg. CTE (10⁻⁷/C.) | 56.5 | 46.4 | | 57.1 | 52.9 | 61.2 | 50 |
| (20-300° C.) | | | | | | | |
| Strain (° C.) | 679 | 717 | 656 | 650 | 660 | 644 | 693 |
| Anneal (° C.) | 724 | 762 | 699 | 694 | 705 | 688 | 738 |
| Softening (° C.) | | | 884 | | | 901 | 925 |
| Density (g/cm³) | 2.604 | 2.742 | | 2.432 | 2.633 | 2.437 | 2.646 |
| Liquidus | 1365 | 1305 | >1300 | 1385 | 1290 | 1355 | 1325 |
| temperature (° C.) | | | | | | | |
| Liquidus viscosity | 0.5 | 1.6 | | 0.7 | 1.2 | 1.1 | 1.1 |
| (kP) | | | | | | | |
| K_{1C} (MPa√m) | 0.868 | 0.881 | 0.875 | 0.841 | 0.862 | 0.843 | 0.865 |
| Poisson's Ratio | 0.231 | 0.233 | 0.207 | 0.223 | 0.246 | 0.223 | 0.229 |
| Shear Modulus | 37.37 | 38.61 | 38.89 | 35.58 | 36.75 | 35.85 | 37.58 |
| (GPa) | | | | | | | |
| Young's Modulus | 92.05 | 95.15 | 93.91 | 87.08 | 91.63 | 87.70 | 92.39 |
| (GPa) | | | | | | | |
| Specific Modulus | 35.35 | 34.70 | | 35.81 | 34.80 | 35.99 | 34.92 |
| (GPa · cm³/g) | | | | | | | |
| G_{1C} (J/m²) | 8.19 | 8.16 | 8.15 | 8.12 | 8.11 | 8.10 | 8.10 |
| SOC | 27.05 | 26.79 | 34.14 | 27.55 | 26.71 | 27.68 | 27.09 |
| (nm/cm/MPa) | | | | | | | |
| Maximum CT | 275 | 250 | 382 | 314 | 320 | 330 | 342 |
| (annealed; MPa) | | | | | | | |
| Time for | 72 | 96.5 | 24 | 20 | 48 | 36 | 56 |
| maximum CT | | | | | | | |
| (annealed, h) | | | | | | | |
| Maximum CT | | | | | | 280 | |
| (fictivated; MPa) | | | | | | | |
| Time for | | | | | | 24 | |
| maximum CT | | | | | | | |
| (fictivated, h) | | | | | | | |
| D 390° C. (um²/hr) | 378 | 100 | 900 | 587 | | 994 | 205 |
| D 430° C. (um²/hr) | 832 | 241 | 1725 | 1365 | 597 | 1855 | 546 |
| D430*CT | 228800 | 60250 | 658950 | 428610 | 191040 | 612150 | 186732 |
| (MPa · μm²/hour) | | | | | | | |

TABLE 2E

| Property | 29 | 30 | 31 | 32 | 33 | 34 | 35 |
|---|---|---|---|---|---|---|---|
| Avg. CTE (10⁻⁷/C.) | 59.7 | 48.7 | 56.3 | 55.9 | 54.4 | 55.1 | 61 |
| (20-300° C.) | | | | | | | |
| Strain (° C.) | 503 | 704 | 665 | 678 | 672 | 654 | 670 |
| Anneal (° C.) | 544 | 748 | 710 | 722 | 718 | 699 | 714 |
| Softening (° C.) | 740 | | | | | 906 | |
| Density (g/cm³) | 2.354 | 2.678 | 2.64 | 2.65 | 2.425 | 2.557 | 2.558 |
| Liquidus | 1285 | 1305 | 1315 | 1275 | 1445 | 1300 | 1350 |
| temperature (° C.) | | | | | | | |
| Liquidus viscosity | | 1.6 | 1.2 | 1.8 | 0.4 | 2.0 | 0.8 |
| (kP) | | | | | | | |
| K_{1C} (MPa√m) | 0.797 | 0.868 | 0.846 | 0.863 | 0.834 | 0.851 | 0.851 |
| Poisson's Ratio | 0.212 | 0.232 | 0.224 | 0.234 | 0.222 | 0.226 | 0.231 |
| Shear Modulus | 32.41 | 37.85 | 36.20 | 37.44 | 35.37 | 36.82 | 36.68 |
| (GPa) | | | | | | | |
| Young's Modulus | 78.53 | 93.29 | 88.67 | 92.46 | 86.53 | 90.25 | 90.32 |
| (GPa) | | | | | | | |
| Specific Modulus | 33.36 | 34.83 | 33.59 | 34.89 | 35.68 | 35.30 | 35.31 |
| (GPa · cm³/g) | | | | | | | |
| G_{1C} (J/m²) | 8.09 | 8.08 | 8.07 | 8.06 | 8.04 | 8.02 | 8.02 |
| SOC | 30.25 | 27.02 | 27.2 | 27.02 | 28.01 | 27.35 | 27.2 |
| (nm/cm/MPa) | | | | | | | |
| Maximum CT | 242 | 312 | 275 | 294 | 390 | 283 | 300 |
| (annealed; MPa) | | | | | | | |
| Time for | 48 | 72 | 24 | 21.5 | 32 | 34 | 56 |
| maximum CT | | | | | | | |
| (annealed, h) | | | | | | | |
| Maximum CT | | | | 266 | | 261 | |
| (fictivated; MPa) | | | | | | | |
| Time for | | | | 21 | | 30 | |
| maximum CT | | | | | | | |
| (fictivated, h) | | | | | | | |
| D 390° C. (um²/hr) | 340 | 160 | 372 | | 760 | | 452 |
| D 430° C. (um²/hr) | | 410 | 870 | 505 | 1885 | 834 | 1358 |
| D430*CT | 82280 | 127920 | 239250 | 148470 | 735150 | 236022 | 407400 |
| (MPa · μm²/hour) | | | | | | | |

TABLE 2F

| Property | 36 | 37 | 38 | 39 | 40 | 41 | 42 |
|---|---|---|---|---|---|---|---|
| Avg. CTE (10⁻⁷/C.) | 58.4 | 51.2 | | 65.9 | 59.6 | 50.8 | |
| (20-300° C.) | | | | | | | |
| Strain (° C.) | 612 | 695 | 625 | 655 | 612 | 690 | 652 |
| Anneal (° C.) | 660 | 742 | 668 | 701 | 661 | 735 | 696 |
| Softening (° C.) | 882 | 941 | | | 880 | | 884 |
| Density (g/cm³) | 2.379 | 2.586 | 2.448 | 2.421 | 2.374 | 2.614 | |
| Liquidus | 1325 | 1325 | 1355 | 1335 | 1365 | 1325 | 1285 |
| temperature (° C.) | | | | | | | |
| Liquidus viscosity | 1.9 | 1.9 | 0.6 | 1.7 | 1.5 | 1.2 | |
| (kP) | | | | | | | |
| K_{1C} (MPa√m) | 0.799 | 0.848 | 0.843 | 0.827 | 0.801 | 0.854 | 0.854 |
| Poisson's Ratio | 0.218 | 0.226 | 0.224 | 0.218 | 0.219 | 0.234 | 0.202 |
| Shear Modulus | 32.68 | 36.61 | 36.27 | 35.09 | 33.03 | 37.09 | 38.13 |
| (GPa) | | | | | | | |
| Young's Modulus | 79.63 | 89.77 | 88.74 | 85.49 | 80.46 | 91.49 | 91.56 |
| (GPa) | | | | | | | |
| Specific Modulus | 33.47 | 34.71 | 36.25 | 35.31 | 33.89 | 35.00 | |
| (GPa · cm³/g) | | | | | | | |
| G_{1C} (J/m²) | 8.02 | 8.01 | 8.01 | 8.00 | 7.97 | 7.97 | 7.97 |
| SOC | 29.91 | 27.71 | 27 | 27.99 | 29.78 | 27.16 | 33.32 |
| (nm/cm/MPa) | | | | | | | |
| Maximum CT | 330 | 316 | 470 | 374 | 340 | 370 | 380 |
| (annealed; MPa) | | | | | | | |
| Time for | 24 | 40 | 64 | 16 | 16 | 48 | 20 |
| maximum CT | | | | | | | |
| (annealed, h) | | | | | | | |
| Maximum CT | | | | | | | |
| (fictivated; MPa) | | | | | | | |
| Time for | | | | | | | |
| maximum CT | | | | | | | |
| (fictivated, h) | | | | | | | |
| D 390° C. (um²/hr) | 1005 | 343 | 340 | 1121 | 1478 | 250 | 1135 |
| D 430° C. (um²/hr) | 2318 | 916 | 810 | 2576 | 2505 | 690 | 2195 |
| D430*CT | 764940 | 289456 | 380700 | 963424 | 851700 | 255300 | 834100 |
| (MPa · μm²/hour) | | | | | | | |

TABLE 2G

| Property | 43 | 44 | 45 | 46 | 47 | 48 | 49 |
|---|---|---|---|---|---|---|---|
| Avg. CTE (10⁻⁷/C.) | 61.1 | 54.6 | 59.9 | 62.7 | | | 53 |
| (20-300° C.) | | | | | | | |
| Strain (° C.) | 639 | 676 | 541 | 626 | 667 | 661 | 671 |
| Anneal (° C.) | 688 | 720 | 587 | 667 | 713 | 708 | 717 |
| Softening (° C.) | | | | | 919 | | |
| Density (g/cm³) | 2.393 | 2.548 | 2.353 | 2.463 | 2.862 | 2.42 | 2.42 |
| Liquidus | 1330 | 1355 | 1305 | 1345 | >1290 | 1375 | 1410 |
| temperature (° C.) | | | | | | | |
| Liquidus viscosity | 3.4 | 0.8 | | 0.4 | | 1.5 | 0.7 |
| (kP) | | | | | | | |
| K_{1C} (MPa√m) | 0.804 | 0.842 | 0.781 | 0.843 | 0.829 | 0.825 | 0.823 |
| Poisson's Ratio | 0.208 | 0.230 | 0.214 | 0.231 | 0.189 | 0.222 | 0.219 |
| Shear Modulus | 33.58 | 36.27 | 31.72 | 36.61 | 36.61 | 35.30 | 35.23 |
| (GPa) | | | | | | | |
| Young's Modulus | 81.22 | 89.29 | 76.95 | 90.05 | 87.08 | 86.25 | 85.84 |
| (GPa) | | | | | | | |
| Specific Modulus | 33.94 | 35.04 | 32.70 | 36.56 | 30.43 | 35.64 | 35.47 |
| (GPa · cm³/g) | | | | | | | |
| G_{1C} (J/m²) | 7.96 | 7.94 | 7.93 | 7.89 | 7.89 | 7.89 | 7.89 |
| SOC | 28.81 | 27.51 | 30.88 | 26.4 | 33.64 | 28.3 | 28.17 |
| (nm/cm/MPa) | | | | | | | |
| Maximum CT | 250 | 405 | 305 | 450 | 275 | 315 | 380 |
| (annealed; MPa) | | | | | | | |
| Time for | 11 | 32 | 48 | 72 | 16 | 4 | 30 |
| maximum CT | | | | | | | |
| (annealed, h) | | | | | | | |
| Maximum CT | | | | | | | |
| (fictivated; MPa) | | | | | | | |
| Time for | | | | | | | |
| maximum CT | | | | | | | |
| (fictivated, h) | | | | | | | |
| D 390° C. (um²/hr) | 1768 | 360 | 531 | 261 | 1520 | 1020 | 830 |
| D 430° C. (um²/hr) | 3764 | 1045 | | 747 | 3306 | 2306 | 2134 |
| D430*CT | 941000 | 423225 | 161955 | 336150 | 909150 | 726390 | 810920 |
| (MPa · μm²/hour) | | | | | | | |

TABLE 2H

| Property | 50 | 51 | 52 | 53 | 54 | 55 | 56 |
|---|---|---|---|---|---|---|---|
| Avg. CTE (10⁻⁷/C.) | | 52.8 | 61.2 | 59.5 | 54 | 56.8 | 61 |
| (20-300° C.) | | | | | | | |
| Strain (° C.) | 649 | 637 | 537 | 583 | 686 | 660 | 665 |
| Anneal (° C.) | 693 | 683 | 582 | 631 | 732 | 705 | 709 |
| Softening (° C.) | 885 | | 794 | 840 | 927 | | 906 |
| Density (g/cm³) | | 2.623 | 2.353 | 2.365 | 2.615 | 2.667 | 2.432 |
| Liquidus | >1310 | 1245 | 1290 | 1315 | 1320 | 1315 | 1420 |
| temperature (° C.) | | | | | | | |
| Liquidus viscosity | | 1.5 | 1.3 | 1.8 | 1.5 | 1.2 | 0.4 |
| (kP) | | | | | | | |
| K_{1C} (MPa√m) | 0.842 | 0.842 | 0.778 | 0.788 | 0.846 | 0.833 | 0.826 |
| Poisson's Ratio | 0.203 | 0.242 | 0.221 | 0.219 | 0.230 | 0.230 | 0.228 |
| Shear Modulus | 37.37 | 36.27 | 31.58 | 32.41 | 37.09 | 35.92 | 35.44 |
| (GPa) | | | | | | | |
| Young's Modulus | 89.98 | 90.11 | 77.01 | 79.01 | 91.15 | 88.39 | 87.08 |
| (GPa) | | | | | | | |
| Specific Modulus | | 34.36 | 32.73 | 33.41 | 34.86 | 33.14 | 35.81 |
| (GPa · cm³/g) | | | | | | | |
| G_{1C} (J/m²) | 7.88 | 7.87 | 7.86 | 7.86 | 7.85 | 7.85 | 7.83 |
| SOC | 32.56 | 27.89 | 30.92 | 30.44 | 27.31 | 27.15 | 27.33 |
| (nm/cm/MPa) | | | | | | | |
| Maximum CT | 375 | 310 | 335 | 360 | 250 | 272 | 485 |
| (annealed; MPa) | | | | | | | |
| Time for | 20 | 56 | 40 | 32 | 24 | 32 | 32 |
| maximum CT | | | | | | | |
| (annealed, h) | | | | | | | |
| Maximum CT | | | | | | | |
| (fictivated; MPa) | | | | | | | |
| Time for | | | | | | | |
| maximum CT | | | | | | | |
| (fictivated, h) | | | | | | | |
| D 390° C. (um²/hr) | 1125 | | 478 | 883 | 353 | 343 | 580 |
| D 430° C. (um²/hr) | 2235 | 493 | 1270 | 1966 | 930 | 833 | 1410 |
| D430*CT | 838125 | 152830 | 425450 | 707760 | 232500 | 226576 | 683850 |
| (MPa · μm²/hour) | | | | | | | |

TABLE 2I

| Property | 57 | 58 | 59 | 60 | 61 | 62 | 63 |
|---|---|---|---|---|---|---|---|
| Avg. CTE (10⁻⁷/C.) | 52.2 | 58.8 | 54.7 | 64.6 | 60.7 | 57.9 | 57.5 |
| (20-300° C.) | | | | | | | |
| Strain (° C.) | 686 | 491 | 672 | 653 | 559 | 663 | 664 |
| Anneal (° C.) | 730 | 529 | 717 | 701 | 604 | 708 | 710 |
| Softening (° C.) | | | | | 817 | | 927 |
| Density (g/cm³) | 2.643 | 2.353 | 2.419 | 2.415 | 2.359 | 2.482 | 2.416 |
| Liquidus | 1320 | 1210 | 1390 | 1325 | 1285 | 1375 | 1390 |
| temperature (° C.) | | | | | | | |
| Liquidus viscosity | 1.2 | 1.8 | 0.9 | 3.0 | | 0.7 | 1.0 |
| (kP) | | | | | | | |
| K_{1C} (MPa√m) | 0.849 | 0.791 | 0.820 | 0.815 | 0.779 | 0.826 | 0.816 |
| Poisson's Ratio | 0.231 | 0.216 | 0.220 | 0.215 | 0.225 | 0.232 | 0.216 |
| Shear Modulus | 37.37 | 32.89 | 35.23 | 34.96 | 31.65 | 35.44 | 35.03 |
| (GPa) | | | | | | | |
| Young's Modulus | 92.05 | 79.91 | 85.91 | 84.87 | 77.57 | 87.22 | 85.15 |
| (GPa) | | | | | | | |
| Specific Modulus | 34.83 | 33.96 | 35.51 | 35.14 | 32.88 | 35.14 | 35.24 |
| (GPa · cm³/g) | | | | | | | |
| G_{1C} (J/m²) | 7.83 | 7.83 | 7.83 | 7.83 | 7.82 | 7.82 | 7.82 |
| SOC | 26.14 | 30.11 | 28.03 | 28.44 | 30.86 | 27.67 | 28.06 |
| (nm/cm/MPa) | | | | | | | |
| Maximum CT | 330 | 214 | 390 | 295 | 340 | 448 | 430 |
| (annealed; MPa) | | | | | | | |
| Time for | 48 | 50 | 32 | 13 | 48 | 20 | 18 |
| maximum CT | | | | | | | |
| (annealed, h) | | | | | | | |
| Maximum CT | | | | | | | 384 |
| (fictivated; MPa) | | | | | | | |
| Time for | | | | | | | 16 |
| maximum CT | | | | | | | |
| (fictivated, h) | | | | | | | |
| D 390° C. (um²/hr) | | 282 | 930 | 1513 | 556 | 555 | |
| D 430° C. (um²/hr) | 697 | 740 | 2400 | 3350 | | 1463 | 2084 |
| D430*CT | 230010 | 158360 | 936000 | 988250 | 189040 | 655424 | 896120 |
| (MPa · μm²/hour) | | | | | | | |

TABLE 2J

| Property | 64 | 65 | 66 | 67 | 68 | 69 | 70 |
|---|---|---|---|---|---|---|---|
| Avg. CTE (10⁻⁷/C.) | 61.3 | 66.8 | | 55.3 | 65.6 | | 50.3 |
| (20-300° C.) | | | | | | | |
| Strain (° C.) | 616 | 653 | 660 | 650 | 658 | 648 | 708 |
| Anneal (° C.) | 664 | 698 | 703 | 695 | 699 | 695 | 753 |
| Softening (° C.) | | 911 | 891 | 897 | 887 | | 940 |
| Density (g/cm³) | 2.395 | 2.42 | | 2.557 | 2.446 | 2.404 | 2.737 |
| Liquidus | 1330 | 1345 | >1320 | 1285 | 1445 | 1340 | 1340 |
| temperature (° C.) | | | | | | | |
| Liquidus viscosity | 2.2 | 1.6 | | 2.0 | 0.2 | 1.8 | 0.8 |
| (kP) | | | | | | | |
| K_{1C} (MPa√m) | 0.802 | 0.818 | 0.837 | 0.843 | 0.829 | 0.801 | 0.859 |
| Poisson's Ratio | 0.214 | 0.219 | 0.208 | 0.232 | 0.228 | 0.213 | 0.235 |
| Shear Modulus | 33.85 | 35.16 | 37.16 | 36.96 | 35.85 | 33.92 | 38.33 |
| (GPa) | | | | | | | |
| Young's Modulus | 82.25 | 85.70 | 89.77 | 91.08 | 88.11 | 82.32 | 94.73 |
| (GPa) | | | | | | | |
| Specific Modulus | 34.34 | 35.41 | | 35.62 | 36.02 | 34.24 | 34.61 |
| (GPa · cm³/g) | | | | | | | |
| G_{1C} (J/m²) | 7.82 | 7.81 | 7.80 | 7.80 | 7.80 | 7.79 | 7.79 |
| SOC | 29.33 | 27.86 | 32.58 | 27.25 | 26.78 | 28.34 | 26.69 |
| (nm/cm/MPa) | | | | | | | |
| Maximum CT | 290 | 355 | 400 | 290 | 530 | 370 | 290 |
| (annealed; MPa) | | | | | | | |
| Time for | 18 | 16 | 24 | 18 | 40 | 24 | 88 |
| maximum CT | | | | | | | |
| (annealed, h) | | | | | | | |
| Maximum CT | | 31 | | 279 | | | |
| (fictivated; MPa) | | | | | | | |
| Time for | | 14 | | 17 | | | |
| maximum CT | | | | | | | |
| (fictivated, h) | | | | | | | |
| D 390° C. (um²/hr) | 1170 | 1300 | 1130 | | 509 | 1025 | 134 |
| D 430° C. (um²/hr) | 2601 | 2874 | 2305 | 751 | 1350 | 2290 | 346 |
| D430*CT | 754290 | 1020270 | 922000 | 217790 | 715500 | 847300 | 100340 |
| (MPa · μm²/hour) | | | | | | | |

TABLE 2K

| Property | 71 | 72 | 73 | 74 | 75 | 76 | 77 |
|---|---|---|---|---|---|---|---|
| Avg. CTE (10⁻⁷/C.) | 55.4 | 61.7 | | 52 | 54.2 | 61.1 | 58.7 |
| (20-300° C.) | | | | | | | |
| Strain (° C.) | 669 | 665 | 664 | 693 | 650 | 654 | 669 |
| Anneal (° C.) | 718 | 712 | 708 | 739 | 697 | 701 | 717 |
| Softening (° C.) | 943 | | | 932 | | 920 | |
| Density (g/cm³) | 2.404 | 2.418 | 2.992 | 2.599 | 2.397 | 2.425 | 2.397 |
| Liquidus | 1380 | 1355 | >1320 | 1330 | 1395 | 1325 | 1405 |
| temperature (° C.) | | | | | | | |
| Liquidus viscosity | 1.8 | 2.1 | <1.3 | 1.4 | 1.6 | 2.8 | 1.2 |
| (kP) | | | | | | | |
| K_{1C} (MPa√m) | 0.812 | 0.816 | 0.836 | 0.838 | 0.806 | 0.813 | 0.804 |
| Poisson's Ratio | 0.216 | 0.221 | 0.210 | 0.229 | 0.212 | 0.217 | 0.214 |
| Shear Modulus | 34.82 | 35.03 | 37.16 | 36.82 | 34.61 | 35.09 | 34.40 |
| (GPa) | | | | | | | |
| Young's Modulus | 84.67 | 85.56 | 89.98 | 90.53 | 83.84 | 85.36 | 83.50 |
| (GPa) | | | | | | | |
| Specific Modulus | 35.22 | 35.39 | 30.07 | 34.83 | 34.98 | 35.20 | 34.83 |
| (GPa · cm³/g) | | | | | | | |
| G_{1C} (J/m²) | 7.79 | 7.78 | 7.77 | 7.76 | 7.75 | 7.74 | 7.74 |
| SOC | 28.54 | 28.34 | 33.61 | 27.41 | 28.67 | 28.13 | 28.73 |
| (nm/cm/MPa) | | | | | | | |
| Maximum CT | 368 | 307 | 350 | 335 | 335 | 275 | 375 |
| (annealed; MPa) | | | | | | | |
| Time for | 14 | 10 | 20 | 40 | 24 | 8 | 16 |
| maximum CT | | | | | | | |
| (annealed, h) | | | | | | | |
| Maximum CT | 317 | 281 | | | | | |
| (fictivated; MPa) | | | | | | | |
| Time for | 10 | 8.5 | | | | | |
| maximum CT | | | | | | | |
| (fictivated, h) | | | | | | | |
| D 390° C. (um²/hr) | | 1080 | 1255 | 317 | 1010 | 1048 | 1375 |
| D 430° C. (um²/hr) | 2488 | | 2622 | 818 | 2405 | 2575 | 2343 |
| D430*CT | 915584 | 331560 | 917700 | 274030 | 805675 | 708125 | 878625 |
| (MPa · μm²/hour) | | | | | | | |

TABLE 2L

| Property | 78 | 79 | 80 | 81 | 82 | 83 | 84 |
|---|---|---|---|---|---|---|---|
| Avg. CTE (10⁻⁷/C.) | 68.2 | 58.6 | 61.9 | 53.5 | 58 | 59.6 | 55.6 |
| (20-300° C.) | | | | | | | |
| Strain (° C.) | 647 | 667 | 656 | 661 | 670 | 658 | 676 |
| Anneal (° C.) | 688 | 713 | 697 | 704 | 715 | 702 | 721 |
| Softening (° C.) | 897 | 930 | | 888 | | | |
| Density (g/cm³) | 2.436 | 2.415 | 2.529 | 3.272 | 2.423 | 2.465 | 2.651 |
| Liquidus | 1375 | 1375 | 1370 | 1315 | 1405 | 1370 | 1285 |
| temperature (° C.) | | | | | | | |
| Liquidus viscosity | 0.3 | 1.3 | 0.5 | 0.7 | 0.6 | 0.9 | 1.5 |
| (kP) | | | | | | | |
| K_{1C} (MPa√m) | 0.823 | 0.813 | 0.824 | 0.858 | 0.816 | 0.814 | 0.847 |
| Poisson's Ratio | 0.231 | 0.220 | 0.228 | 0.208 | 0.224 | 0.222 | 0.241 |
| Shear Modulus | 35.58 | 35.03 | 35.78 | 39.51 | 35.23 | 35.09 | 37.44 |
| (GPa) | | | | | | | |
| Young's Modulus | 87.56 | 85.49 | 87.84 | 95.35 | 86.25 | 85.84 | 92.94 |
| (GPa) | | | | | | | |
| Specific Modulus | 35.95 | 35.40 | 34.73 | 29.14 | 35.60 | 34.82 | 35.06 |
| (GPa · cm³/g) | | | | | | | |
| G_{1C} (J/m²) | 7.74 | 7.73 | 7.73 | 7.72 | 7.72 | 7.72 | 7.72 |
| SOC | 26.84 | 28.36 | 26.55 | 34.53 | 27.92 | 27.51 | 26.88 |
| (nm/cm/MPa) | | | | | | | |
| Maximum CT | 525 | 430 | 423 | 390 | 403 | 440 | 290 |
| (annealed; MPa) | | | | | | | |
| Time for | 36 | 32 | 72 | 27 | 32 | 48 | 39 |
| maximum CT | | | | | | | |
| (annealed, h) | | | | | | | |
| Maximum CT | | | | | | | |
| (fictivated; MPa) | | | | | | | |
| Time for | | | | | | | |
| maximum CT | | | | | | | |
| (fictivated, h) | | | | | | | |
| D 390° C. (um²/hr) | 590 | 887 | 240 | 900 | 844 | 564 | |
| D 430° C. (um²/hr) | 1320 | | 654 | | 2167 | 1510 | 690 |
| D430*CT | 693000 | 381410 | 276642 | 351000 | 873301 | 664400 | 200100 |
| (MPa · μm²/hour) | | | | | | | |

TABLE 2M

| Property | 85 | 86 | 87 | 88 | 89 | 90 | 91 |
|---|---|---|---|---|---|---|---|
| Avg. CTE (10⁻⁷/C.) | 60.6 | 73.1 | 62.7 | 57.4 | 65.1 | | 52.4 |
| (20-300° C.) | | | | | | | |
| Strain (° C.) | 657 | 629 | 662 | 671 | 655 | 663 | 673 |
| Anneal (° C.) | 703 | 668 | 706 | 717 | 698 | 709 | 717 |
| Softening (° C.) | 923 | 841 | | | 869 | 907 | |
| Density (g/cm³) | 2.434 | 2.453 | 2.415 | 2.406 | 2.423 | 2.929 | 2.677 |
| Liquidus | 1315 | 1435 | 1405 | 1385 | 1390 | >1265 | 1345 |
| temperature (° C.) | | | | | | | |
| Liquidus viscosity | 3.3 | 0.1 | 0.6 | 1.3 | 0.5 | | 0.4 |
| (kP) | | | | | | | |
| K_{1C} (MPa√m) | 0.816 | 0.830 | 0.807 | 0.805 | 0.811 | 0.828 | 0.858 |
| Poisson's Ratio | 0.226 | 0.230 | 0.215 | 0.214 | 0.219 | 0.203 | 0.245 |
| Shear Modulus | 35.23 | 36.47 | 34.89 | 34.75 | 35.09 | 37.09 | 38.54 |
| (GPa) | | | | | | | |
| Young's Modulus | 86.46 | 89.63 | 84.74 | 84.32 | 85.63 | 89.29 | 95.91 |
| (GPa) | | | | | | | |
| Specific Modulus | 35.52 | 36.54 | 35.09 | 35.05 | 35.34 | 30.48 | 35.83 |
| (GPa · cm³/g) | | | | | | | |
| G_{1C} (J/m²) | 7.70 | 7.69 | 7.69 | 7.69 | 7.68 | 7.68 | 7.68 |
| SOC | 27.99 | 25.81 | 27.82 | 28.47 | 28 | 33.59 | 27.13 |
| (nm/cm/MPa) | | | | | | | |
| Maximum CT | 271 | 525 | 475 | 395 | 460 | 305 | 325 |
| (annealed; MPa) | | | | | | | |
| Time for | 10 | 26 | 11 | 24 | 26 | 16 | 72 |
| maximum CT | | | | | | | |
| (annealed, h) | | | | | | | |
| Maximum CT | | | | | | | |
| (fictivated; MPa) | | | | | | | |
| Time for | | | | | | | |
| maximum CT | | | | | | | |
| (fictivated, h) | | | | | | | |
| D 390° C. (um²/hr) | 875 | 388 | 935 | 1212 | 750 | 1390 | |
| D 430° C. (um²/hr) | 2073 | 820 | 2575 | 2325 | 1800 | 3110 | 295 |
| D430*CT | 561783 | 430500 | 1223125 | 918375 | 828000 | 948550 | 95875 |
| (MPa · μm²/hour) | | | | | | | |

TABLE 2N

| Property | 92 | 93 | 94 | 95 | 96 | 97 | 98 |
|---|---|---|---|---|---|---|---|
| Avg. CTE (10⁻⁷/C.) | 57.3 | 55.9 | 67.2 | 56.2 | | | 55.9 |
| (20-300° C.) | | | | | | | |
| Strain (° C.) | 642 | 653 | 631 | 624 | 623 | 659 | 653 |
| Anneal (° C.) | 684 | 697 | 678 | 666 | 671 | 707 | 699 |
| Softening (° C.) | | | | | 872 | | |
| Density (g/cm³) | 2.464 | 2.838 | 2.418 | 2.52 | 2.918 | 2.426 | 2.404 |
| Liquidus | 1425 | 1340 | 1320 | >1445 | 1230 | >1340 | 1345 |
| temperature (° C.) | | | | | | | |
| Liquidus viscosity | 0.2 | 1.0 | 2.7 | <.17 | 4.3 | | 1.8 |
| (kP) | | | | | | | |
| K_{1C} (MPa√m) | 0.832 | 0.822 | 0.803 | 0.828 | 0.820 | 0.808 | 0.794 |
| Poisson's Ratio | 0.230 | 0.211 | 0.212 | 0.233 | 0.211 | 0.219 | 0.216 |
| Shear Modulus | 36.75 | 36.47 | 34.75 | 36.40 | 36.40 | 35.09 | 34.06 |
| (GPa) | | | | | | | |
| Young's Modulus | 90.32 | 88.25 | 84.25 | 89.84 | 88.11 | 85.56 | 82.87 |
| (GPa) | | | | | | | |
| Specific Modulus | 36.66 | 31.10 | 34.84 | 35.65 | 30.20 | 35.27 | 34.47 |
| (GPa · cm³/g) | | | | | | | |
| G_{1C} (J/m²) | 7.66 | 7.66 | 7.65 | 7.63 | 7.63 | 7.63 | 7.61 |
| SOC | 26.78 | 32 | 28.2 | 27.75 | 34.2 | 28.48 | 28.38 |
| (nm/cm/MPa) | | | | | | | |
| Maximum CT | 431 | 405 | 285 | 433 | 310 | 234 | 368 |
| (annealed; MPa) | | | | | | | |
| Time for | 88 | 24 | 16 | 72 | 24 | 4 | 24 |
| maximum CT | | | | | | | |
| (annealed, h) | | | | | | | |
| Maximum CT | | | | | | | |
| (fictivated; MPa) | | | | | | | |
| Time for | | | | | | | |
| maximum CT | | | | | | | |
| (fictivated, h) | | | | | | | |
| D 390° C. (um²/hr) | 264 | 1066 | 1209 | 280 | 1090 | 1226 | 1100 |
| D 430° C. (um²/hr) | 662 | | 3112 | 740 | 2200 | 2735 | 2423 |
| D430*CT | 285322 | 431730 | 886920 | 320420 | 682000 | 639990 | 891664 |
| (MPa · μm²/hour) | | | | | | | |

TABLE 2O

| Property | 99 | 100 | 101 | 102 | 103 | 104 | 105 |
|---|---|---|---|---|---|---|---|
| Avg. CTE (10⁻⁷/C.) | 53.4 | 64.5 | 56.5 | 58.7 | 71 | 47.1 | 62.7 |
| (20-300° C.) | | | | | | | |
| Strain (° C.) | 650 | 645 | 637 | 660 | 640 | 687 | 636 |
| Anneal (° C.) | 694 | 690 | 682 | 704 | 684 | 738 | 686 |
| Softening (° C.) | 883 | | | | | 995 | |
| Density (g/cm³) | 3.266 | 2.4 | 2.46 | 2.436 | 2.441 | 2.377 | 2.385 |
| Liquidus | 1300 | 1380 | 1365 | 1370 | 1370 | 1370 | 1330 |
| temperature (° C.) | | | | | | | |
| Liquidus viscosity | 0.8 | 1.0 | 0.9 | 0.9 | 0.6 | 7.1 | 4.1 |
| (kP) | | | | | | | |
| K_{1C} (MPa√m) | 0.851 | 0.796 | 0.812 | 0.809 | 0.811 | 0.790 | 0.781 |
| Poisson's Ratio | 0.212 | 0.217 | 0.226 | 0.221 | 0.227 | 0.203 | 0.209 |
| Shear Modulus | 39.30 | 34.27 | 35.44 | 35.37 | 35.44 | 34.40 | 33.44 |
| (GPa) | | | | | | | |
| Young's Modulus | 95.22 | 83.43 | 86.94 | 86.32 | 87.01 | 82.74 | 80.88 |
| (GPa) | | | | | | | |
| Specific Modulus | 29.15 | 34.76 | 35.34 | 35.44 | 35.65 | 34.81 | 33.91 |
| (GPa · cm³/g) | | | | | | | |
| G_{1C} (J/m²) | 7.61 | 7.59 | 7.58 | 7.58 | 7.56 | 7.54 | 7.54 |
| SOC | 34.82 | 28.16 | 27.99 | 27.59 | 27.37 | 29.95 | 29.15 |
| (nm/cm/MPa) | | | | | | | |
| Maximum CT | 372 | 400 | 442 | 442 | 340 | 240 | 240 |
| (annealed; MPa) | | | | | | | |
| Time for | | 20.4 | 48 | 40 | 14 | 16 | 10 |
| maximum CT | | | | | | | |
| (annealed, h) | | | | | | | |
| Maximum CT | 315 | | | | | | |
| (fictivated; MPa) | | | | | | | |
| Time for | | | | | | | |
| maximum CT | | | | | | | |
| (fictivated, h) | | | | | | | |
| D 390° C. (um²/hr) | 945 | 1218 | 595 | 600 | 997 | 1260 | 1947 |
| D 430° C. (um²/hr) | | 2410 | 1675 | 1460 | 2363 | 2888 | 4300 |
| D430*CT | 351540 | 964000 | 740350 | 645320 | 803420 | 693120 | 1032000 |
| (MPa · μm²/hour) | | | | | | | |

TABLE 2P

| Property | 106 | 107 | 108 | 109 | 110 | 111 | 112 |
|---|---|---|---|---|---|---|---|
| Avg. CTE (10⁻⁷/C.) | 67.6 | | 57.4 | 60.5 | 68.1 | 57 | 55.3 |
| (20-300° C.) | | | | | | | |
| Strain (° C.) | 621 | 657 | 604 | 665 | 586 | 663 | 662 |
| Anneal (° C.) | 664 | 701 | 652 | 713 | 627 | 710 | 711 |
| Softening (° C.) | | 894 | 868 | | | | |
| Density (g/cm³) | 2.447 | 2.993 | 2.383 | 2.404 | 2.452 | 2.456 | 2.393 |
| Liquidus | 1365 | 1285 | 1270 | 1350 | >1375 | >1445 | 1350 |
| temperature (° C.) | | | | | | | |
| Liquidus viscosity | 0.3 | | 2.9 | 2.9 | <0.23 | <.45 | 2.4 |
| (kP) | | | | | | | |
| K_{1C} (MPa√m) | 0.815 | 0.828 | 0.771 | 0.794 | 0.816 | 0.803 | 0.785 |
| Poisson's Ratio | 0.223 | 0.211 | 0.222 | 0.213 | 0.220 | 0.218 | 0.217 |
| Shear Modulus | 36.06 | 37.58 | 32.27 | 34.54 | 36.27 | 35.23 | 33.72 |
| (GPa) | | | | | | | |
| Young's Modulus | 88.11 | 91.01 | 78.94 | 83.77 | 88.53 | 85.77 | 82.05 |
| (GPa) | | | | | | | |
| Specific Modulus | 36.01 | 30.41 | 33.13 | 34.85 | 36.10 | 34.92 | 34.29 |
| (GPa · cm³/g) | | | | | | | |
| G_{1C} (J/m²) | 7.54 | 7.53 | 7.53 | 7.53 | 7.52 | 7.52 | 7.51 |
| SOC | 26.53 | 33.61 | 29.62 | 28.5 | 26.19 | 28.94 | 28.89 |
| (nm/cm/MPa) | | | | | | | |
| Maximum CT | 536 | 335 | 320 | 311 | 530 | 401 | 333 |
| (annealed; MPa) | | | | | | | |
| Time for | 48 | 20 | 24 | 16 | 64 | 24 | 16 |
| maximum CT | | | | | | | |
| (annealed, h) | | | | | | | |
| Maximum CT | | | | | | | |
| (fictivated; MPa) | | | | | | | |
| Time for | | | | | | | |
| maximum CT | | | | | | | |
| (fictivated, h) | | | | | | | |
| D 390° C. (um²/hr) | 404 | 1210 | 920 | 1480 | 280 | 840 | 1240 |
| D 430° C. (um²/hr) | 1110 | 2700 | 1910 | 3214 | 733 | 2011 | 3340 |
| D430*CT | 594960 | 904500 | 611200 | 999554 | 388490 | 806411 | 1112220 |
| (MPa · μm²/hour) | | | | | | | |

TABLE 2Q

| Property | 113 | 114 | 115 | 116 | 117 | 118 | 119 |
|---|---|---|---|---|---|---|---|
| Avg. CTE (10⁻⁷/C.) | 75.7 | 64.9 | 55.6 | 62.6 | 58.6 | 62.1 | 47.4 |
| (20-300° C.) | | | | | | | |
| Strain (° C.) | 614 | 647 | 663 | 616 | 586 | 631 | 674 |
| Anneal (° C.) | 652 | 693 | 714 | 666 | 633 | 675 | 728 |
| Softening (° C.) | | 905 | 960 | | 855 | 877 | |
| Density (g/cm³) | 2.446 | 2.433 | 2.362 | 2.382 | 2.371 | 2.411 | 2.336 |
| Liquidus | 1375 | 1325 | 1410 | 1290 | 1290 | 1365 | 1365 |
| temperature (° C.) | | | | | | | |
| Liquidus viscosity | 0.1 | 1.9 | 3.3 | 5.9 | 2.1 | 0.6 | 14.4 |
| (kP) | | | | | | | |
| K_{1C} (MPa√m) | 0.815 | 0.805 | 0.775 | 0.769 | 0.762 | 0.779 | 0.764 |
| Poisson's Ratio | 0.224 | 0.223 | 0.196 | 0.214 | 0.222 | 0.220 | 0.196 |
| Shear Modulus | 36.13 | 35.30 | 33.51 | 32.68 | 31.92 | 33.58 | 32.96 |
| (GPa) | | | | | | | |
| Young's Modulus | 88.46 | 86.39 | 80.19 | 79.29 | 77.98 | 81.91 | 78.88 |
| (GPa) | | | | | | | |
| Specific Modulus | 36.17 | 35.51 | 33.95 | 33.29 | 32.89 | 33.97 | 33.77 |
| (GPa · cm³/g) | | | | | | | |
| G_{1C} (J/m²) | 7.51 | 7.50 | 7.49 | 7.46 | 7.45 | 7.41 | 7.40 |
| SOC | 25.54 | 27.75 | 29.86 | 29.2 | 30.33 | 27.29 | 30.64 |
| (nm/cm/MPa) | | | | | | | |
| Maximum CT | 550 | 300 | 272 | 225 | 335 | 430 | 200 |
| (annealed; MPa) | | | | | | | |
| Time for | 36 | 10 | 11.25 | 12 | 24 | 24 | 10 |
| maximum CT | | | | | | | |
| (annealed, h) | | | | | | | |
| Maximum CT | | | | | | | |
| (fictivated; MPa) | | | | | | | |
| Time for | | | | | | | |
| maximum CT | | | | | | | |
| (fictivated, h) | | | | | | | |
| D 390° C. (um²/hr) | 358 | 954 | 2004 | 1791 | 737 | 800 | 2612 |
| D 430° C. (um²/hr) | 934 | 2567 | 4252 | 3964 | 2035 | 1955 | 4757 |
| D430*CT | 513700 | 770100 | 1156544 | 891900 | 681725 | 840650 | 951400 |
| (MPa · μm²/hour) | | | | | | | |

TABLE 2R

| Property | 120 | 121 | 122 | 123 | 124 | 125 | 126 |
|---|---|---|---|---|---|---|---|
| Avg. CTE (10⁻⁷/C.) | 68.1 | 71 | 67.3 | 60.3 | 51 | 63.6 | 52.6 |
| (20-300° C.) | | | | | | | |
| Strain (° C.) | 588 | 653 | 629 | 549 | 688 | 642 | 650 |
| Anneal (° C.) | 634 | 697 | 674 | 594 | 739 | 691 | 700 |
| Softening (° C.) | | | 891 | | 990 | | |
| Density (g/cm³) | 2.428 | 2.43 | 2.437 | 2.385 | 2.369 | 2.385 | 2.369 |
| Liquidus | 1300 | 1375 | 1320 | 1335 | 1410 | 1335 | 1315 |
| temperature (° C.) | | | | | | | |
| Liquidus viscosity | 2.4 | 0.3 | 1.9 | 1.2 | 4.3 | 3.5 | 5.3 |
| (kP) | | | | | | | |
| K_{1C} (MPa√m) | 0.795 | 0.798 | 0.797 | 0.778 | 0.775 | 0.772 | 0.760 |
| Poisson's Ratio | 0.224 | 0.221 | 0.220 | 0.213 | 0.205 | 0.212 | 0.210 |
| Shear Modulus | 34.96 | 35.37 | 35.30 | 33.85 | 33.85 | 33.44 | 32.47 |
| (GPa) | | | | | | | |
| Young's Modulus | 85.49 | 86.32 | 86.12 | 82.12 | 81.63 | 81.01 | 78.60 |
| (GPa) | | | | | | | |
| Specific Modulus | 35.21 | 35.52 | 35.34 | 34.43 | 34.46 | 33.97 | 33.18 |
| (GPa · cm³/g) | | | | | | | |
| G_{1C} (J/m²) | 7.39 | 7.38 | 7.38 | 7.37 | 7.36 | 7.36 | 7.35 |
| SOC | 27.68 | 26.71 | 27.56 | 29.11 | 29.84 | 29.19 | 29.52 |
| (nm/cm/MPa) | | | | | | | |
| Maximum CT | 285 | 530 | 300 | 350 | 270 | 259 | 250 |
| (annealed; MPa) | | | | | | | |
| Time for | 24 | 32 | 24 | 24 | 15 | 7.3 | 16 |
| maximum CT | | | | | | | |
| (annealed, h) | | | | | | | |
| Maximum CT | | | | | | 226 | |
| (fictivated; MPa) | | | | | | | |
| Time for | | | | | | 6 | |
| maximum CT | | | | | | | |
| (fictivated, h) | | | | | | | |
| D 390° C. (um²/hr) | 750 | 577 | 825 | 635 | 1637 | 1590 | 1636 |
| D 430° C. (um²/hr) | 2053 | 1385 | 2038 | 1315 | 3676 | | 3917 |
| D430*CT | 585105 | 734050 | 611400 | 460250 | 992520 | 411810 | 979250 |
| (MPa · μm²/hour) | | | | | | | |

TABLE 2S

| Property | 127 | 128 | 129 | 130 | 131 | 132 | 133 |
|---|---|---|---|---|---|---|---|
| Avg. CTE (10⁻⁷/C.) | 70.1 | | 59.8 | 68.4 | 66.8 | 57.7 | 60.3 |
| (20-300° C.) | | | | | | | |
| Strain (° C.) | 541 | 632 | 654 | 635 | 635 | 664 | 622 |
| Anneal (° C.) | 583 | 679 | 695 | 679 | 684 | 709 | 665 |
| Softening (° C.) | | | | | | | |
| Density (g/cm³) | 2.437 | 2.392 | 2.472 | 2.416 | 2.407 | 2.416 | 2.449 |
| Liquidus | 1340 | 1350 | 1390 | 1400 | 1280 | 1325 | 1335 |
| temperature (° C.) | | | | | | | |
| Liquidus viscosity | 0.4 | 1.4 | 0.4 | 0.4 | 5.8 | 2.2 | 0.7 |
| (kP) | | | | | | | |
| K_{1C} (MPa√m) | 0.801 | 0.769 | 0.808 | 0.789 | 0.773 | 0.787 | 0.802 |
| Poisson's Ratio | 0.225 | 0.215 | 0.230 | 0.222 | 0.216 | 0.219 | 0.229 |
| Shear Modulus | 35.71 | 33.16 | 36.20 | 34.82 | 33.78 | 35.03 | 36.20 |
| (GPa) | | | | | | | |
| Young's Modulus | 87.43 | 80.60 | 89.15 | 85.08 | 82.19 | 85.36 | 88.94 |
| (GPa) | | | | | | | |
| Specific Modulus | 35.87 | 33.70 | 36.06 | 35.22 | 34.14 | 35.33 | 36.32 |
| (GPa · cm³/g) | | | | | | | |
| G_{1C} (J/m²) | 7.34 | 7.34 | 7.32 | 7.32 | 7.27 | 7.26 | 7.23 |
| SOC | 26.44 | 28.62 | 26.73 | 27.51 | 28.78 | 28.28 | 27.13 |
| (nm/cm/MPa) | | | | | | | |
| Maximum CT | 450 | 325 | 410 | 450 | 216 | 400 | 400 |
| (annealed; MPa) | | | | | | | |
| Time for | 64 | 4 | 37 | 20 | 12 | | |
| maximum CT | | | | | | | |
| (annealed, h) | | | | | | | |
| Maximum CT | | | | | | 350 | 360 |
| (fictivated; MPa) | | | | | | | |
| Time for | | | | | | | |
| maximum CT | | | | | | | |
| (fictivated, h) | | | | | | | |
| D 390° C. (um²/hr) | 248 | 1150 | 253 | 833 | 1660 | 945 | 400 |
| D 430° C. (um²/hr) | 676 | 2515 | 652 | | 3840 | | |
| D430*CT | 304200 | 817375 | 267320 | 374850 | 829440 | 378000 | 160000 |
| (MPa · μm²/hour) | | | | | | | |

TABLE 2T

| Property | 134 | 135 | 136 | 137 | 138 | 139 | 140 |
|---|---|---|---|---|---|---|---|
| Avg. CTE (10⁻⁷/C.) | 53.8 | 60.2 | 59.7 | 59.3 | 54.4 | 74.7 | 63.5 |
| (20-300° C.) | | | | | | | |
| Strain (° C.) | 681 | 660 | 668 | 649 | 659 | 638 | 603 |
| Anneal (° C.) | 730 | 707 | 715 | 698 | 709 | 683 | 652 |
| Softening (° C.) | 970 | | | | 960 | | |
| Density (g/cm³) | 2.379 | 2.392 | 2.388 | 2.387 | 2.366 | 2.445 | 2.371 |
| Liquidus | 1400 | 1390 | 1405 | 1370 | 1365 | 1345 | 1290 |
| temperature (° C.) | | | | | | | |
| Liquidus viscosity | 2.9 | 1.4 | 1.6 | 1.8 | 4.4 | 1.1 | 6.7 |
| (kP) | | | | | | | |
| K_{1C} (MPa√m) | 0.772 | 0.769 | 0.770 | 0.764 | 0.757 | 0.780 | 0.746 |
| Poisson's Ratio | 0.210 | 0.208 | 0.207 | 0.208 | 0.208 | 0.216 | 0.200 |
| Shear Modulus | 34.06 | 33.92 | 34.06 | 33.51 | 32.96 | 34.89 | 32.41 |
| (GPa) | | | | | | | |
| Young's Modulus | 82.53 | 81.91 | 82.19 | 80.94 | 79.70 | 84.87 | 77.77 |
| (GPa) | | | | | | | |
| Specific Modulus | 34.69 | 34.24 | 34.42 | 33.91 | 33.69 | 34.71 | 32.80 |
| (GPa · cm³/g) | | | | | | | |
| G_{1C} (J/m²) | 7.22 | 7.22 | 7.21 | 7.21 | 7.19 | 7.17 | 7.16 |
| SOC | 29.58 | 28.88 | 29.18 | 29.06 | 29.8 | 27.7 | 29.4 |
| (nm/cm/MPa) | | | | | | | |
| Maximum CT | 250 | 365 | 375 | 340 | 260 | 270 | 225 |
| (annealed; MPa) | | | | | | | |
| Time for | 15 | 16 | 16 | 16 | 15 | 13 | 10 |
| maximum CT | | | | | | | |
| (annealed, h) | | | | | | | |
| Maximum CT | | | | | | | |
| (fictivated; MPa) | | | | | | | |
| Time for | | | | | | | |
| maximum CT | | | | | | | |
| (fictivated, h) | | | | | | | |
| D 390° C. (um²/hr) | 950 | 1403 | 1530 | 1466 | 1723 | 1175 | 2025 |
| D 430° C. (um²/hr) | 3480 | | 2800 | 2965 | | 2675 | 4254 |
| D430*CT | 870000 | 512095 | 1050000 | 1008100 | 447980 | 722250 | 957150 |
| (MPa · μm²/hour) | | | | | | | |

TABLE 2U

| Property | 141 | 142 | 143 | 144 | 145 |
|---|---|---|---|---|---|
| Avg. CTE (10⁻⁷/C.) | 59.5 | 67.9 | 52.1 | 60.9 | 88.6 |
| (20-300° C.) | | | | | |
| Strain (° C.) | 648 | 647 | 667 | 643 | 650 |
| Anneal (° C.) | 698 | 694 | 719 | 692 | 694 |
| Softening (° C.) | | | 972 | | 883 |
| Density (g/cm³) | 2.381 | 2.426 | 2.356 | 2.38 | 3.266 |
| Liquidus | 1330 | 1325 | 1360 | 1390 | |
| temperature (° C.) | | | | | |
| Liquidus viscosity | 5.4 | 2.3 | 7.5 | 1.7 | |
| (kP) | | | | | |
| K_{1C} (MPa√m) | 0.760 | 0.781 | 0.745 | 0.761 | 0.851 |
| Poisson's Ratio | 0.212 | 0.223 | 0.195 | 0.211 | 0.212 |
| Shear Modulus | 33.37 | 35.09 | 32.75 | 33.85 | 39.30 |
| (GPa) | | | | | |
| Young's Modulus | 80.81 | 85.91 | 78.26 | 81.98 | 95.22 |
| (GPa) | | | | | |
| Specific Modulus | 33.94 | 35.41 | 33.22 | 34.44 | 29.15 |
| (GPa · cm³/g) | | | | | |
| G_{1C} (J/m²) | 7.15 | 7.10 | 7.09 | 7.06 | 7.61 |
| SOC | 29.16 | 28.15 | 30.09 | 28.9 | 34.82 |
| (nm/cm/MPa) | | | | | |
| Maximum CT | 235 | 290 | 230 | 348 | 372 |
| (annealed; MPa) | | | | | |
| Time for | 12 | 14 | 15 | | |
| maximum CT | | | | | |
| (annealed, h) | | | | | |
| Maximum CT | | | | 277 | 315 |
| (fictivated; MPa) | | | | | |
| Time for | | | | | |
| maximum CT | | | | | |
| (fictivated, h) | | | | | |
| D 390° C. (um²/hr) | 1840 | 1437 | 1925 | 1380 | |
| D 430° C. (um²/hr) | 4182 | 3165 | 4300 | | |
| D430 * CT | 982770 | 917850 | 989000 | 480240 | |
| (MPa · μm²/hour) | | | | | |

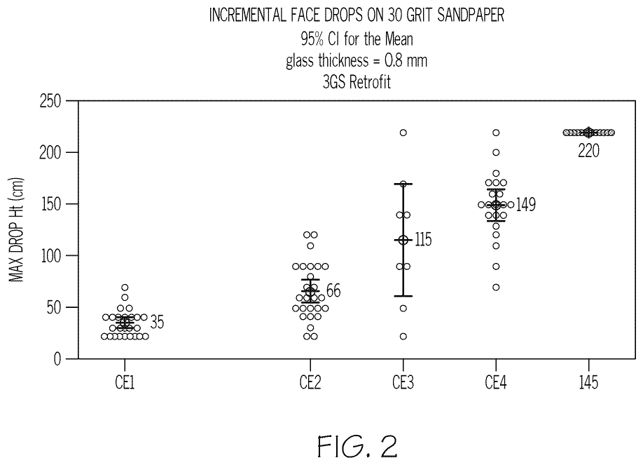

The glass-based articles prepared as above were investigated for the ability to survive repeated drops on damaging surfaces. Glasses were double melted for homogeneity and then cut into phone-size glass-based substrates and polished to dimensions of 110 mm×56 mm×0.8 mm. The glass-based substrates were ion exchanged for various times to find the maximum CT, providing glass-based articles. The glass-based articles were then mounted in a drop device (e.g., identical mobile phone devices, such as an IPHONE® 3GS, or a puck simulating the size and weight of a mobile phone device, wherein the puck had a weight of 135 g) and dropped onto 180 grit sandpaper from incremental heights starting at 20 cm. If a glass-based article survived the drop from one height (e.g., 20 cm), the glass-based article was dropped again from a 10 cm greater height (e.g., 30 cm, 40 cm, 50 cm, etc.) up to a maximum height of 220 cm. A glass-based article is said to have survived if there are no cracks visible to the naked eye. Survivors then went on to be dropped on 30 grit sandpaper. FIG. 2 compares the drop performance of a glass-based article made from composition 145 versus previous technologies. CE1 is a glass article made from a glass composition comprising 57.43 mol. % SiO₂, 16.1 mol. % Al₂O₃, 17.05 mol. % Na₂O, 2.81 mol. % MgO, 0.003 mol. % TiO₂, 0.07 mol. % SnO₂, and 6.54 mol. % P₂O₅. CE2 is a glass article made from a glass composition comprising 63.60 mol. % SiO₂, 15.67 mol. % Al₂O₃, 10.81 mol. % Na₂O, 6.24 mol. % Li₂O, 1.16 mol. % ZnO, 0.04 mol. % SnO₂, and 2.48 mol. % P₂O₅. CE3 is a glass article made from a glass composition comprising 70.94 mol. % SiO₂, 1.86 mol. % B₂O₃, 12.83 mol. % Al₂O₃, 2.36 mol. % Na₂O, 8.22 mol. % Li₂O, 2.87 mol. % MgO, 0.83 mol. % ZnO, 0.022 mol. % Fe₂O₃, and 0.06 mol. % SnO₂. CE4 is a glass article made from a glass composition comprising 69.26 mol. % SiO₂, 1.83 mol. % B₂O₃, 12.58 mol. % Al₂O₃, 0.41 mol. % Na₂O, 7.69 mol. % Li₂O, 2.85 mol. % MgO, 1.73 mol. % ZnO, 3.52 mol. % TiO₂, and 0.13 mol. % SnO₂. While CE1 fails at an average drop height of 35 cm, other glasses, CE2, CE3, and CE4, can increase the average drop height to failure to 66, 115 cm, and 149 cm, respectively. By increasing the CT, modulus and fracture toughness, the glass-based article made from composition 145 showed no failures and maxed out the test at 220 cm drop height.

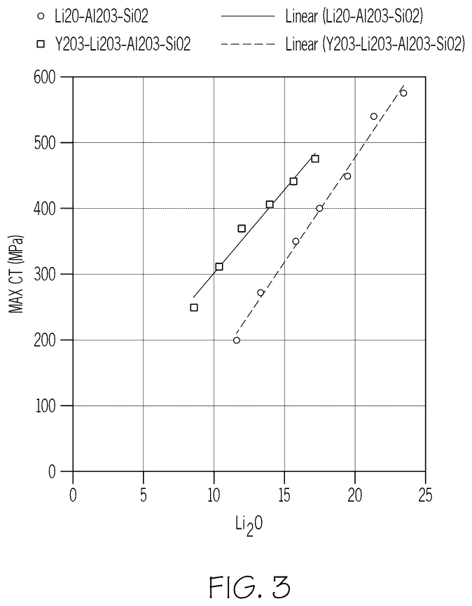

Without intending to be bound by any particular theory, it is believed that to maximize CT, a large number of alkali ions should be available for exchange. Because the alkalis associated with Al₂O₃ in the glass structure are the most mobile, the glass should have a high alkali aluminate (R₂O·Al₂O₃) content of 8 mol. % or greater (where R is Li or Na) for sufficient stress and ion exchange rates. FIG. 3 shows the maximum central tension CT for near charge balanced lithium alumino silicates (shown as diamonds). To achieve greater than 175 MPa CT, the glass should have at least 10 mol. % Li₂O·Al₂O₃ for simple ternary glasses.

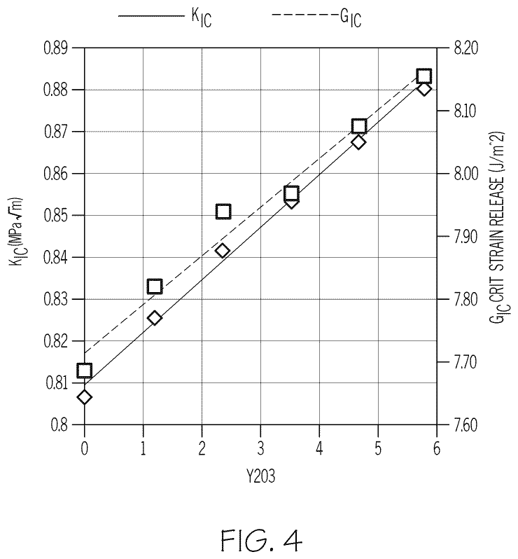

However by increasing the elastic modulus of the glass, the amount of stress per ion can be increased and lower amounts of Li₂O·Al₂O₃ can be used to achieve the same maximum CT. Small cations with high field strength, such as MgO and Y₂O₃, may be used for this purpose. The data points shown as squares in FIG. 3 represent data using Y₂O₃—Li₂O₃—Al₂O₃—SiO₂ based glass articles. From FIG. 3, it is possible to see that higher maximum CT values may be obtained with Y₂O₃-containing lithium alumino silicates. In fact, only about 5 mol. % of Li₂O (or 5 mol. % Li₂O. Al₂O₃) is needed for attaining a maximum CT of 175 MPa. Y₂O₃ may also increase K_{1C} and G_{1C}, as illustrated in FIG. 4. It is also believed that Y₂O₃ may also help improve the liquidus viscosity until one of yttrium disilicate or Keivyite becomes the liquidus phase. Ta₂O₅ has similar effects (not shown).

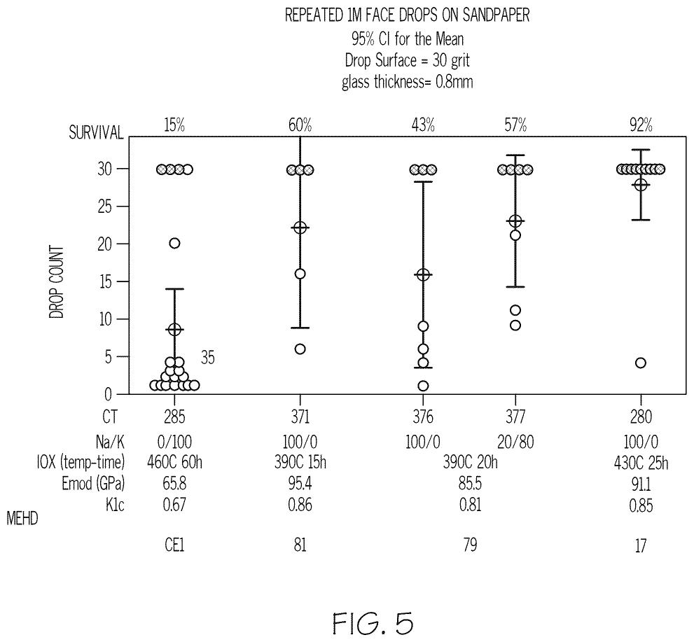

As shown in FIG. 5, a glass-based article made from composition 17 has a 92% survival rate after thirty 1 m drops onto 30 grit sandpaper, while CE1 ion exchanged to a slightly higher CT (285 MPa for CE1 versus 280 MPa for the composition 17 article) only has a 15% survival rate. Without intending to bound to any particular theory, it is believed that the difference is due to the higher fracture toughness K_{1C}, and more specifically, the higher critical strain energy release rate G_{1C} of the glass-based article made from composition 17. While CE1 only has a G_{1C} of 6.82 J/m², the composition 17 article has a 20% higher G_{1C} of 8.24 J/m². Similarly, a glass-based article made from composition 81 had a 60% survival rate, and glass-based articles made from composition 79 had about a 50% survival rate. Both of these glass-based articles had higher K_{1C} (and thus higher G_{1C}) than CE1.

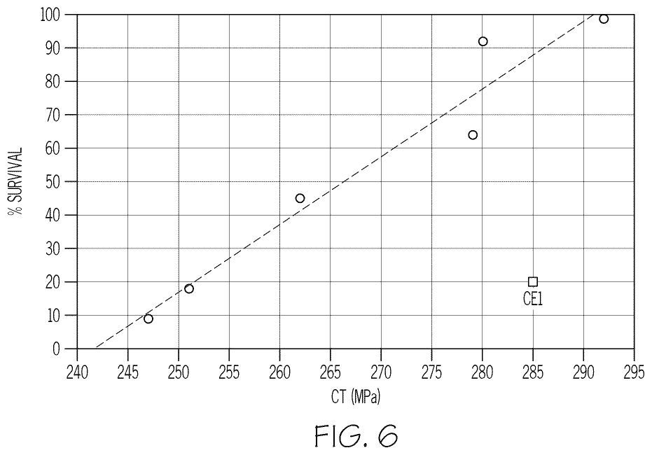

FIG. 6 shows repeated drop to failure survival as a function of central tension for 0.8 mm thick specimens. Without intending to be bound to any particular theory, it is believed that although CT has a profound effect on survivability, the inventive glasses (represented as dots) have superior survival rates to CE1 (shown as the square at a CT of 285 MPa and 20% survival) because they have greater fracture toughness, elastic modulus, and critical strain energy release rates. That CE1 has a survivability that is significantly below the trend line at CT=285 MPa suggests that properties beyond just CT are involved in the survivability values obtained from the inventive compositions.

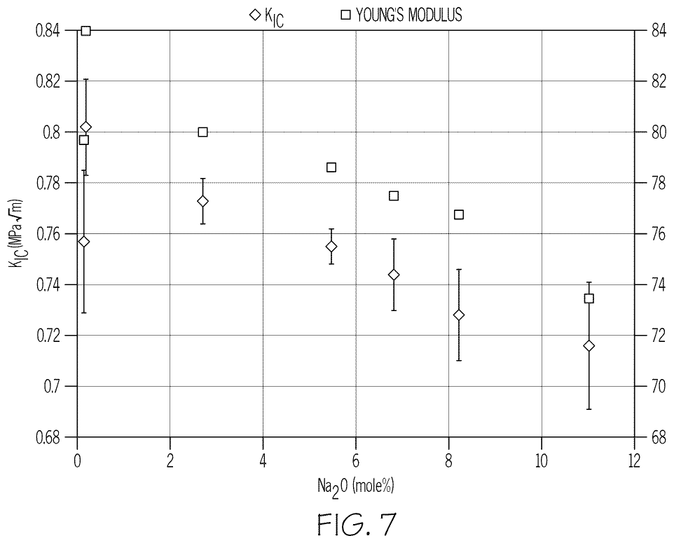

FIG. 7 shows the effect on K_{1C} and Young's modulus of replacing Li₂O and Na₂O through ion exchange. As the amount of Na₂O is increased, the Young's modulus and fracture toughness decrease, and as a result, the high Na₂O content glass-based articles do not exhibit favorable drop performance.

FIG. 8 shows the stress profile for a 1 mm-thick glass-based article made from composition 62. It should be noted that the stress values above the local minima ranging from 0.85 mm to 1 mm and below the local minima ranging from 0.05 mm to 0.15 mm are measurement artifacts. The glass-based article was ion exchanged in a 100% NaNO₃ bath at 430° C. for 16 hours. The maximum CT was 442.7 MPa, and the stored strain energy was 459.6 J/m². In contrast, the highest maximum CT attained in CE1 is 285 MPa, and this is only after four days of ion exchange. Without intending to be bound by any particular theory, it is believed that the high content of Li₂O·Al₂O₃ enables the achievement of such high stresses while the higher mutual diffusivity of Na⁺ for Li⁺ enables this to be achieved in hours as opposed to days. It is believed that the much higher mutual diffusivity of Na⁺ for Li⁺ compared with the mutual diffusivity of K⁺ for Na⁺ is a contributing factor in this behaviour.

Referring back to Tables 2A-2U, the mutual diffusivity D increased with the temperature increase from 390° C. to 430° C., indicating that higher diffusivity may be achieved at higher ion exchange temperatures. However, stress relaxation occurs as the temperature increases. Accordingly, the high diffusivity could potentially be associated with lower CT. Therefore, the arithmetic product of the maximum CT and the diffusivity may provide an indication of merit for cost and performance.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

What is claimed is:

1. A glass-based article strengthened by ion exchange comprising a composition comprising SiO₂, Li₂O, Ta₂O₅, and Al₂O₃, the Al₂O₃ content being greater than or equal to 12 mole %, a stress region extending from the first surface to a depth of compression, and a tensile stress region extending from the depth of compression toward a second surface opposite the first surface, the tensile stress region having a maximum central tension greater than or equal to 160 MPa.

2. The glass-based article of claim 1, wherein the Al₂O₃ content is greater than or equal to 14 mole % of the composition.

3. The glass-based article of claim 1, wherein the Al₂O₃ content is greater than or equal to 16 mole % of the composition.
